(19) United States
(12) Patent Application Publication
(10) Pub. No.: US 2019/0219026 A1
(43) Pub. Date: Jul. 18, 2019

(54) SELF-POWERED, SELF-PROPELLED COMPUTER GRID WITH LOOP TOPOLOGY

(71) Applicant: LONE GULL HOLDINGS, LTD., Moorpark, CA (US)

(72) Inventors: Garth Alexander Sheldon-Coulson, Moorpark, CA (US); Brian Lee Moffat, Simi Valley, CA (US); Daniel William Place, Los Angeles, CA (US)

(21) Appl. No.: 16/248,410

(22) Filed: Jan. 15, 2019

Related U.S. Application Data
(60) Provisional application No. 62/618,086, filed on Jan. 17, 2018.
(60) Provisional application No. 62/622,879, filed on Jan. 27, 2018.
(60) Provisional application No. 62/693,373, filed on Jul. 2, 2018.
(60) Provisional application No. 62/774,115, filed on Nov. 30, 2018.

(51) Int. Cl. F03B 13/14; G05D 1/02; G05D 1/00; G01C 21/20; B63B 35/44; B63G 8/00; G06F 9/48

(52) U.S. Cl. CPC F03B 13/14; G05D 1/0206; G05D 1/0055; H02K 7/183; B63B 35/44; B63G 8/001; G06F 9/4881; G01C 21/20

(57) ABSTRACT

An energy-harvesting compute grid includes computing assemblies that cooperate with mobile energy harvesters configured to be deployed on a body of water. The plurality of energy harvesters are positioned on and move adjacent to an upper surface of a body of water, and the locations of the energy harvesters can be monitored and controlled. The wide-spread gathering by the harvesters of environmental data within that geospatial area permits the forecasting of environmental factors, the discovery of advantageous energy-harvesting opportunities, the observation and tracking of hazardous objects and conditions, the efficient distribution of data and/or tasks to and between the harvesters included in the compute grid, the efficient execution of logistical operations to support, upgrade, maintain, and repair the cluster, and the opportunity to execute data-gathering across an area much larger than that afforded by an individual harvester (e.g., radio astronomy, 3D tracking of and recording of the communication patterns of marine mammals, etc.). The computational tasks can be shared and distributed among a compute grid implemented in part by a collection of individual floating self-propelled energy harvesters thereby providing many benefits related to cost and efficiency that are unavailable to relatively isolated energy harvesters, and likewise unavailable to terrestrial compute grids of the prior art.

### CROSS-REFERENCES TO RELATED APPLICATIONS

This application claims priority to U.S. Ser. No. 62/618,086, Jan. 17, 2018; U.S. Ser. No. 62/622,879, Jan. 27, 2018; U.S. Ser. No. 62/693,373, Jul. 2, 2018; and U.S. Ser. No. 62/774,115, Nov. 30, 2018, the contents of each of which are incorporated by reference herein in their entireties.

### BACKGROUND

As computing consumes a larger fraction of the world's electricity supply, providers of computing services are becoming some of the largest buyers of energy and the largest funders of energy projects. The question therefore arises how the mammoth parallel computers and compute grids of the future will be powered.

Furthermore, as computing becomes so energy-intensive that new energy infrastructure must be built in order to accommodate it, the lead time of energy infrastructure becomes the limiting factor on the development of computing. The question therefore arises how energy infrastructure, particularly renewable energy infrastructure, can be built in ways that keep up with the computing infrastructure that it is intended to power.

The present disclosure teaches a solution to these problems by integrating computing and energy-harvesting hardware in mobile ocean energy “harvesters” that form elements of a compute grid deployed, located, and moving on an area of the ocean. In some embodiments, the harvesters of the cluster form (and are navigationally controlled to maintain) a loop topology, i.e. they individually move over the surface of the ocean in circuits or orbits that enclose and/or revolve around a common region of the earth's surface (including land and/or ocean). This provides several advantages including reducing the probability of collisions, reducing energy expenditures for thrust, and being able to benefit from conformal ocean currents and winds.

Furthermore, this disclosure provides a particularly efficient way to use distant marine energy resources. Many of the locations, i.e., “high-energy areas,” where ocean waves are most vigorous and consistent, and/or where winds blow most strongly and consistently, are found adjacent to the surfaces of deep ocean waters that are far from shore. Devices for collecting energy from these resources, and deployment configurations thereof, included in the prior art do not permit the cost-effective harvesting of energy from these high-energy areas of the sea.

### SUMMARY OF THE INVENTION

Disclosed are mechanisms, apparatuses, systems, and methods which permit rich, and currently under-utilized, natural and renewable marine energy resources to be efficiently harvested and put to good purpose, offsetting and potentially supplanting a portion of the electrical power generated on land.

The mechanisms, apparatuses, systems, and methods permit the cost-effective harvesting of energy from the winds and waves at remote, deep-water, high-energy areas of the sea in a cost-effective manner.

The mechanisms, apparatuses, systems, and methods permit the efficient harvesting of energy from areas adjacent to the surface of the ocean at locations that are very far from shore and/or that are characterized by very deep water. An embodiment includes a plurality of energy harvesting devices that are free-floating and self-propelled, and which incorporate means and/or mechanisms permitting at least a portion of the energy harvested to be utilized for beneficial purposes that tend to reduce the need for equivalent amounts of electrical energy to be generated on land (i.e., for the same or similar purpose).

An EHCG, in some embodiments, consists of some or all of the following elements:

1. A plurality of buoyant energy harvesters, each being configured to convert ocean wave energy into electricity and being equipped with a means of producing thrust to propel itself across a body of water.

The buoyant energy harvesters can be floating wave energy converters, floating wind turbines, floating ocean thermal energy conversion platforms, and/or any other buoyant devices or machines that use the kinetic energy of ocean wind or water, or differences in the temperature of ocean air or water, to generate electricity.

The buoyant energy harvesters are mobile, in that they are unanchored and have a means of producing thrust (such as a sail, a propeller, a pipe from which water flows outward into the body of water, a nozzle or port from which air is ejected, a nozzle or port from which water is ejected, etc.).

2. A plurality of navigation control systems, each being mounted upon one of the buoyant energy harvesters and being configured to control a thrust vector of said buoyant energy harvester.

The navigation control systems are typically configured to either alter the position of a rudder or change the amount of thrust produced by one of the thrust-producing elements. For example, the navigation control system can be configured to turn a sail, increase or decrease the speed of a propeller, open or close a valve or nozzle controlling water outflow from a pipe, etc.

The navigation control system can be configured to merely implement navigational/steering/thrust commands sent to the harvester over a wireless data transfer bus, or else can be configured to perform “offline” and/or “autonomous” navigational calculations using real-time information collected by the harvester regarding its own geospatial position (e.g. to reduce deviations from a stored navigational course); or (preferably) some combination of the two.

3. A plurality of computation assemblies, each being mounted upon one of the buoyant energy harvesters and being configured to use electricity from an electrical generator of said buoyant energy harvester to execute computational tasks.

The computation assemblies typically each include a plurality of individual computers, each containing at least one CPU, GPU, and/or ASIC.

At least some of the computers can be networked together to form a cluster or LAN using technologies such as Ethernet or InfiniBand.

The computation assembly is able to send and/or receive data to/from the below mentioned wireless data transfer bus using a data transfer antenna of the harvester.

4. A wireless data transfer bus configured to relay computational tasks from a computer on shore to various ones of the computation assemblies and configured to relay computational results from variou ones of the computation assemblies to a computer on shore.

The wireless data transfer bus can be a radio network that includes satellites and/or balloon-mounted ratio relays.

The wireless data transfer bus typically enables a data stream to be sent from a terrestrial ground station to various ones of the harvesters.

The wireless data transfer bus typically also enables data streams, messages, commands, navigational/location data, and/or environmental data to be exchanged among and between the harvesters.

A computational task scheduler configured to schedule computational tasks to various ones of the computation assemblies.

5. The computational task scheduler can include, or be implemented by, or consist of software running on, one or more computers located on a terrestrial ground station or a floating marine platform (or in any other location, such as a satellite).

The computational task scheduler can receive data about, and base its scheduling calculations on, the current and/or past energy production of the harvesters of the cluster.

The computational task scheduler can receive data about, and base its scheduling calculations on, the predicted future energy production of the harvesters of the cluster, predicted, for instance, on the basis of predicted future weather patterns e.g. wind speeds and/or wave heights.

A computational task dispatcher configured to transmit encoded computational tasks to the data transfer bus for delivery to various ones of the computation assemblies.

6. The computational task dispatcher can include, or be implemented by, or consist of software running on, one or more computers located on a terrestrial ground station or a floating marine platform (or in any other location, such as a satellite).

7. A plurality of data transfer antennas, each being mounted upon one of the buoyant energy harvesters and being configured to transmit a data stream from the respective computation assembly to the wireless data transfer bus.

The data transfer antennas can include phased array antennas mounted to upper surfaces of the respective energy harvesters.

Embodiments of the present disclosure:

include a plurality of buoyant, free-floating and self-propelled platforms, devices, or nodes, which are not moored to the seafloor;

include a plurality of relatively small buoyant, free-floating and self-propelled platforms, devices, or nodes, rather than one or a few relatively large devices, because extracting a relatively small percentage (e.g., 1%) of the energy available across a relatively large area is easier, more efficient, and more cost-effective, than attempting to extract a relatively large percentage (e.g., 50%) of the energy available within a relatively small area (e.g., within the vicinity of a single large device); thus harvesting relatively small amounts of energy with a plurality of relatively small devices dispersed over a relatively great area is preferred;

include a plurality of free-floating platforms, devices, or nodes, that are able to at least partially control their positions in the midst of the vigorous surface currents and winds which tend to characterize deep-ocean, high-energy areas, by providing those devices with propulsive capabilities;

utilize at least a portion of the energy harvested by their constituent free-floating harvesters, platforms, devices, or nodes, to generate and/or control propulsive forces that allow each respective harvester, platform, device, or node, to propel itself along a direction, along a course, at a speed, and/or toward or to a destination specified by an autonomous device-specific control system, by an embodiment-specific control system (e.g., positioned on, and/or incorporated within, one of the embodiment's devices), by an external control system (e.g., by a shore-based extension of the embodiment), and/or by another source of navigational instructions, commands, directions, recommendations, and/or advice (e.g. some combination of the above methods);

control and/or guide the movement of their buoyant, free-floating, and self-propelled harvesters, platforms, devices, or nodes, so as to steer them along a course that largely conforms to ambient currents, winds, and/or waves, by which they are pushed along the specified course (i.e., rather than steering them along a course that would require them to oppose, to any significant degree, those currents, winds, and/or waves), thereby minimizing the portion of the energy that they extract from winds and/or waves that is expended in order to generate propulsive forces to overcome the typically substantial forces of currents, winds, and/or waves;

control and/or guide the “drifting” movements of their respective plurality of buoyant, free-floating, self-propelled harvesters, platforms, devices, or nodes, so as to cause them to move in loops and/or to otherwise keep those devices moving within the bounds of a high-energy area within which their harvesting of energy is relatively optimal (as opposed to directing those devices to move outside a high-energy area and to thereby leave them with only access to less-energetic waves and/or winds) so that they may continue their harvesting with minimal interruption and/or loss of power;

control and/or guide the “drifting” movements of the buoyant, free-floating, self-propelled harvesters, platforms, devices, or nodes, so as to keep them relatively dispersed and/or separated from one another thereby facilitating their access to wind and/or wave resources that have not been diminished and/or reduced by the prior extractions and/or harvesting of other devices within the embodiment's plurality of devices;

facilitate the dispersive movements, and/or nominal separations, of the “drifting” buoyant, free-floating, self-propelled harvesters, platforms, devices, or nodes, by controlling and/or guiding them to move at differing speeds, and/or along varying routes within, in, and/or along, the same (at least to an approximate degree) looping, circular, orbital, and/or cyclic, paths and/or courses, characteristic of the movements of the embodiment's plurality of devices; in other words, along routes and/or circuits that circle around and/or enclose a common geospatial region of the earth's surface, and/or that have a topology approximating a loop or recurrent orbit;

facilitate the dispersive movements, and/or nominal separations, of the “drifting” buoyant, free-floating, self-propelled platforms, devices, or nodes, by controlling and/or guiding them to move along different segments and/or portions of the orbital path such that the devices are separated from one another, with respect to their positions along the nominal orbital path, and such that most, or all, of the devices are consistently at separated positions along that path, thereby reducing the likelihood that they will “cross paths” with another device (e.g., and collide, or compete for available energy resources), thereby increasing the likelihood that they will have access to undiminished winds and waves, and increasing the likelihood that at least a portion of an embodiment's respective devices will be positioned at points along the path where there are high-energy winds and/or waves (e.g., while other devices may be positioned within areas of relative calm) and the likelihood that at least a portion of the devices will be fully energized at any particular time;

utilize at least a portion of their harvested energy to perform some useful work and/or to create some useful product locally (e.g., in the absence of a subsea power cable through which electrical power may be transmitted to shore) and then export the result of the work and/or the product to another location (e.g., to shore) where it can be used and/or provide a benefit;

are comprised of a plurality of buoyant, free-floating and self-propelled harvesters, platforms, devices, or nodes, that incorporate computing devices, computational circuits, memory devices, energy storage and/or buffering devices, routers, wireless data transmission and reception devices (e.g., Wi-Fi), radio transceivers (e.g., for communication with satellites), and/or other electronic circuits and devices;

utilize at least a portion of their harvested energy to perform computational tasks that they cause to be executed on, within, and/or across, the computational circuits and/or devices incorporated within their constituent buoyant, free-floating, self-propelled constituent energy harvesting devices.

Access to More Abundant Resources

Because embodiments of the present disclosure do not utilize mooring cables, or anchors to fix their respective energy harvesting to a single, static position in the sea, and instead utilize energy harvesting devices that are free-floating and self-propelled (i.e. have at least some degree of control over their position, e.g. by driving a propeller to create a thrust or by increasing or decreasing the device's susceptibility to environmental forces like wind, e.g. by raising flaps or sails), embodiments of the present disclosure may harvest energy from areas significantly larger than would be practical with deployments of equal numbers of devices moored to the seafloor and connected to a common subsea power cable.

And, the freedom of such a collection of harvesters to be widely dispersed (e.g., since they don't have to connect to a shared subsea power cable) permits a cluster to harvest energy from locations separated by significant distances, thereby improving the efficiency of each individual harvester.

Wind and wave harvesting devices that are not anchored to the seafloor must be self-propelled if they are to avoid being hazards to shipping and avoid being destroyed in collisions with rocks, ships, icebergs and other obstructions. Self-propelled wind and wave energy devices can seek out and travel to areas of the sea where wind and/or wave resources are greatest, thereby increasing the amounts of energy that they are able to harvest (and also reducing their levelized costs of energy (LCOEs) by harvesting on average a relatively greater amount of energy with the same device).

Efficiency

Through the coordinated positioning, distribution, and/or directed movement, of the energy harvesting devices of which it is comprised, the efficiency with which the energy harvesting cluster harvests energy is enhanced. The efficiency of the operation, cost-effectiveness, and amortization of the capital costs associated with, the logistical components and functions on which the system depends are also enhanced.

The need for devices in such a cluster to propel themselves or otherwise control (at least in part) their position, while preferably minimizing the amount of energy expended doing so, is best satisfied by controlling those devices to acquiesce to the forces of ambient currents and winds to the greatest reasonable extent, while utilizing their intrinsic propulsive or location-control capabilities to select and/or change which winds or currents they will drift with. And, as discussed above, the maximization of the harvesting efficiency of individual devices, and of the capacity factor of the entire cluster, is facilitated by the dispersion of devices across the area of the sea being harvested, and the movement of those devices (by drift and propulsive adjustments to that drift) around a shared, common, and/or consistent, orbital path and/or circuit.

Navigation

Through the provision and utilization of a virtual data communication network through which many, if not all, of the energy harvesting devices of which the disclosed energy harvesting system is composed are able to share data and messages with one another, and/or through the use of a centralized coordination and/or control system, devices are able to share data regarding site-specific winds, waves, shipping, floating debris, etc., which can be used to adjust and/or optimize the courses and/or harvesting parameters (i.e., “tuning”) of other energy harvesting devices, and to receive course corrections and/or better-tuned harvesting parameters for their own benefit based on data reported by other devices.

Resistance is Futile (or at Least Inefficient)

Deep water precludes the positional stabilization of floating energy harvesting devices through the use of moorings to a seafloor. So, such devices must either move with the ambient environmental forces imparted to them (by winds, waves, currents, etc.) or they must expend copious amounts of energy opposing those ambient environmental with opposing thrusts. Since the efficiency and practicality of energy harvesting devices in such locations will depend upon the amount of extracted energy that they can use to execute useful work and/or to produce useful products, their efficiency and practicality will therefore also depend upon their ability to minimize the amount of the energy that they must consume generating those opposing thrusts.

However, if they move with, instead of resist, ambient environmental forces, then it can be useful if their movement is constrained to the area in which the winds and waves are sufficiently vigorous to afford the energy harvesting devices the opportunity to extract useful amounts of energy. It can also be useful if they are constrained to a common, shared area so that execution of useful work and/or their production of useful products can be coordinated and/or otherwise processed with a shared and cost-effective logistical infrastructure. For example, computational tasks might be downloaded to devices, divided across devices, and the results of those tasks might be uploaded from devices. Chemicals might be generated, stored on devices, and eventually offloaded from devices.

Because of these and other advantages, embodiments of the present disclosure are comprised of pluralities of free-floating, self-propelled energy harvesting devices that minimize their propulsive energy consumption by drifting, to the extent possible, with local currents so as to execute looping courses that keep them within an area over which their respective embodiment(s), and its/their constituent self-propelled energy harvesting devices, operate. In some embodiments, self-propulsion is minimized by reserving it for those points on each self-propelled energy harvesting device's course where a course adjustment, e.g., between advantageous currents or to counteract an inauspicious wind, is required.

Drifting in Gyres

The system of the present disclosure is comprised of a plurality of wind and/or wave energy harvesting devices that typically and/or nominally drift within gyres, and/or within or along looping courses substantially parallel to ocean winds and currents. In some embodiments, the individual wind and/or wave energy harvesting devices of the present disclosure are controlled to utilize a minimal amount of self-propulsion in order to make course corrections primarily for the purpose of remaining within a looping course conformal to the currents and/or winds characteristic of, and/or defining, the course.

Propulsion Tends to be Normal to the Nominal Direction of Drift

An embodiment of the present disclosure is comprised of self-propelled energy harvesting devices that utilize self-propulsion, but which also tend to minimize the amount of energy expended on their propulsion (whether provided by rigid sails and wind, or by propulsive methods, devices, and/or mechanisms that consume a portion of the energy harvested by the devices) by generating device-specific propulsive forces that tend to be applied in directions normal to the respective device-specific nominal, dominant, default, and/or unopposed, direction of drift, direction of current, direction of wind, and/or direction conformal to a combination of current and wind forces.

In other words, an embodiment of the present disclosure is comprised of self-propelled energy harvesting devices that tend to generate propulsive forces approximately normal to their direction of travel and/or drift, thereby using those propulsive forces primarily for the purpose of altering the current and/or wind pattern with which they will thereafter continue to drift. In some embodiments, even though the devices orbit in a circular pattern, movement in directions parallel to this circular pattern is predominantly imparted or driven by ambient environmental forces, and thrust is predominantly used to stay on the circular course. Therefore, with respect to a majority of individual energy harvesters of the cluster, most of individual harvesters' self-generated thrust (as measured in, for instance, pounds-force) will be expended along vectors more perpendicular to the direction of the circular orbiting course than parallel to it. The embodiment's propulsive forces are used primarily, if not exclusively, for the purpose of making relatively small course corrections (typically substantially normal to the average heading of drift), and not primarily, if at all, for the purpose of getting somewhere faster and/or for the purpose of directly opposing a current or wind.

One or more of the self-propelled energy harvesting devices of an embodiment of the present disclosure may occasionally generate propulsive forces approximately parallel to its direction of travel so as to travel in the same direction either more quickly or more slowly when such an expenditure of energy (to generate and/or to control propulsive forces) is made for the purpose of reaching an advantageous and/or energy-rich location and/or area more quickly, lingering within an advantageous and/or energy-rich location longer (i.e., leaving it more slowly), and/or to better avoid a potential obstacle or hazard by traveling more quickly or slowly.

Advantages of a Wind and Current Compliant Looping Course

By promoting, establishing, and/or specifying a looping course about which its respective energy harvesting devices drift, an embodiment of the present disclosure minimizes the amount of the energy that it harvests that is expended on propulsion, while still keeping its devices localized within an area of advantageous wind and/or waves, and while minimizing, through the localization of its energy harvesting devices, the costs expended on required and/or desirable tracking, maintenance, repair, upgrading, provisioning, and/or, navigational support.

Uses of Harvested Energy

Disclosed is an improved energy harvesting system and cluster, that includes a plurality of energy harvesting devices, positioned and propelled so as to increase the harvesting efficiency of each device, and of the system as a whole. The energy harvesting devices of which the system is comprised are free floating, and most if not all of the devices are capable of utilizing at least a portion of the energy which it generates in order to perform an energy-intensive task. The scope of the present disclosure includes embodiments in which some of energy harvested by the respective individual harvesters is utilized by any device-specific, and/or embodiment-specific, application, process, transformation, mechanism, device, synthesis, conversion, activity, harvesting (e.g., of an element, a chemical, a substance), and/or any other task that results in the production, creation, collection, and/or accumulation, of any material, substance, solid, liquid, gas, information, and/or product that has a value, benefit, and/or utility with respect to any consumer, person, animal, environment, and/or place.

Computation

Through the provision and utilization of a virtual data communication network, or wireless data transfer bus, through which many, if not all, of the energy harvesting devices of which an energy harvesting cluster is comprised are able to share data and messages with one another, and/or with a centralized coordination and/or control system, embodiments of energy harvesting systems of the present disclosure which utilize at least a portion of the energy they generate in order to execute arbitrary computational tasks for third parties, are able to execute and/or complete the processing of computational tasks that are too large and/or complex, and/or require the consumption of too much energy, to permit their completion and/or execution by an individual energy harvesting device, to be divided, shared, sharded, and/or otherwise cooperatively processed, across many (or all) of the system's energy harvesting devices.

Other Uses of Harvested Energy

The lack of access to a subsea power cable through which to export generated electrical power requires that the power be consumed and/or utilized locally, e.g., on each device. While there are many options and/or applications which permit the utilization of device-generated electrical power to be used for a useful purpose, preferred applications include (but are not limited to): the powering of computational nodes, and therethrough the performance of computational tasks; and, the generation and/or synthesis of chemicals and chemical fuels (e.g., hydrogen gas, and ammonia). And, since each device moves with relative independence, and substantial separation from its fellows, it is preferred that such energy-consuming applications be performed and/or executed on each respective device by appropriate equipment, mechanisms, modules, and/or capabilities, incorporated within each respective device.

Radio Telescope

An embodiment of the present disclosure incorporates within each of a plurality of its free-floating, self-propelled, energy harvesting devices, at least one antenna, at least one timekeeping device capable of providing each respective device with a source of calibrated, contemporaneous, and/or synchronized time data, and at least one sensor and/or device capable of determining and specifying the geospatial position and orientation of each respective energy harvesting device. Each respective energy harvesting device gathers and records electromagnetic signals received at its antenna, timestamps such signals, records the position and orientation of the respective energy harvesting device at the time that each signal was detected, as well as any other types of data useful and/or required for the analysis of the recorded signals.

A signal processing and/or integrating system on at least one harvester, on an ocean platform, on a shore-based station constituting a terrestrial component and/or extension of the embodiment, and/or on or at another location (whether within or without the embodiment, e.g., at a university laboratory), utilizes the timestamped, and positionally-characterized, signals gathered from the embodiment's antenna-equipped energy harvesting devices so as to construct images of radio sources in space, to conduct radio astronomical research, and/or to characterize non-terrestrial sources of radio transmissions. A similar embodiment utilizes at least one phased-array antenna on at least one of its energy harvesting devices to receive said transmissions.

An embodiment's geographically dispersed antennas, incorporated within its respective geographically dispersed energy harvesting devices, constitute a composite phased array antenna. However, unlike shore-based phased-array antennas, each individual antenna (or phased array antenna) of the phased-array antenna of an embodiment of the present disclosure is not anchored to the earth at an invariant geospatial location, therefore the signals detected by each individual antenna must be characterized by the geospatial position of the antenna (e.g., longitude, latitude, and elevation) as well as the orientation of the antenna (e.g., which, among other things, may influence the strength of a detected signal). An embodiment transmits electromagnetic signals received by individual harvesters (along with associated timestamps and geospatial position information) via the data transfer bus via satellite to a terrestrial ground station for processing.

A radio-telescope embodiment of the current disclosure utilizes at least one phased array antenna to track the relative positions of a plurality of satellites of known position and/or orbit. It then associates with each signal detected on the same phased array antenna, a separate antenna, and/or a separate phased array antenna, the relative positions of each of the plurality of reference satellites, and a timestamp allowing the earth-centric absolute positions of the reference satellites to be calculated. Considering and/or utilizing this data during analysis allows the signal contributed by each respective energy harvesting device to be combined so as to produce an image of one or more radio sources.

Advantages Over Individual Free-Floating Energy Harvesting Devices

Embodiments of the present disclosure enjoy advantages over individual free-floating energy harvesting devices, even those that are self-propelled, because many aspects of the practical extraction and utilization of environmental energies from locations characterized by deep waters and significant distances from a shoreline are impractical in the absence of large numbers of cooperating self-propelled energy harvesting devices drifting along common looping pathways and/or courses.

An advantage of an energy harvesting and processing embodiment comprising a plurality of self-propelled energy harvesting devices (as opposed to an individual self-propelled energy harvesting device) all of which are operating within an embodiment-specific and embodiment-consistent area, e.g., by drifting and/or moving along a common current- and/or wind-defined course, includes an increase in the efficiency, and a minimization of the costs, associated with the provision, implementation, and/or operation of the logistical support and infrastructure required by one or more self-propelled energy harvesting devices, including, but not limited to: supporting ships, platforms, communications, loading of any precursors (e.g., computational tasks, initialization data, precursor chemicals, electrolyzers, etc.), offloading of any products (e.g., computational results, synthesized chemicals, etc.), monitoring of other ships and floating debris, monitoring of winds, waves, and currents, the generation of weather forecasts and optimal harvesting parameters. All such logistical and/or support requirements, devices, activities, and/or operations, are better amortized and supported by a large collection of self-propelled energy harvesting devices all operating within the same geospatial area, and traveling along the same, or similar, course(s) through that area.

Furthermore, with respect to the execution of remotely-defined computational tasks (e.g., tasks unrelated to the operation or navigation of the respective energy harvesting devices, such as the simulation of the folding of a protein, the cryptographic analysis of an encrypted signal, the training of a statistical or neural network model, etc.), the execution of computational tasks too large to be executed by, on, and/or within, the computational resources of an individual energy harvesting device can be divided and executed in parallel across many energy harvesting devices, and the sharing of data and the coordination of task execution can be enhanced and made more efficient when the respective energy harvesting devices are close enough to one another (or at least close enough to at least one other energy harvesting device in the group of cooperating devices) to operate within a common wireless and/or virtual network.

Navigational Control

This disclosure, as well as the discussion regarding same, is primarily made in reference to an apparatus, mechanism, or system, comprising, at least in part, a plurality of self-propelled energy harvesting devices, which includes, but is not limited to: self-propelled wave energy converters; and self-propelled wind turbines; in which the positioning, distribution, movements, and/or behaviors, of those energy harvesting devices are coordinated, controlled, guided, and/or specified, by an embodiment-specific (i.e. centralized) control system. An embodiment's control system may be centralized and located on one of its respective energy harvesting devices, on shore, on a ship, on a floating, anchored, or pylon-supported platform, on a satellite, on a balloon orbiting above the embodiment's energy harvesting devices, and/or at or on any other location. An embodiment's control system may be decentralized and implemented and/or executed as a peer-to-peer system shared, distributed, and/or sharded, across some or all of an embodiment's energy harvesting devices.

### Computational Embodiments

Disclosed is a method of harnessing energy and performing compute tasks in which a plurality of free-floating self-powered energy harvesting devices are deployed into a sea; and therein convert wind and/or wave energy into electrical power; wherein at least one energy harvesting device reports its location to a first external navigational computing node; wherein the first external navigational computing node transmits to the at least one energy harvesting device signals and/or instructions that guide the direction of its self-propulsion; such that the at least one energy harvesting device moves in an orbital direction and/or fashion; wherein the at least one energy harvesting device receives a first executable program, via a wireless data transfer bus, from a first external transmitting computing node; and executes said first executable program on a computational node energized, at least in part, by at least a portion, of the electrical power generated by the at least one energy harvesting device; wherein at least a portion of the data generated through the execution of the first executable program is returned and/or transmitted by the at least one energy harvesting device, via a wireless data transfer bus, to a first external receiving computing node.

Scope of the Disclosure

The scope of the present disclosure includes embodiments comprising any number of energy harvesting devices, including, but not limited to those that include at least 10, 100, 1 thousand, 10 thousand, 100 thousand, and 1 million, energy harvesting devices.

The current disclosure includes many different embodiments, and variations of embodiments, of a novel energy harvesting apparatus, mechanism, and/or system, that extracts energy from the marine environment and uses at least a portion of that energy to perform useful work (e.g., computations) and/or to create a useful product (e.g., hydrogen). Each of the following features, structures, behaviors, and/or attributes, is represented by, incorporated within, and/or associated with, at least one embodiment of the current disclosure:

### 1. Self-Propelled Wave Energy Converters

An embodiment of the current disclosure incorporates, includes, and/or utilizes, a self-propelled wave energy converter.

Embodiments of the present disclosure include, but are not limited to, those which incorporate, include, and/or utilize, self-propelled “point-absorbing” wave energy converters that are sufficiently buoyant, and/or include a sufficiently buoyant portion (e.g., a buoy), so as to cause a portion of each device to typically and/or nominally be adjacent to a surface of the body of water on which the device floats.

Embodiments of the present disclosure include, but are not limited to, those which incorporate, include, and/or utilize, self-propelled point-absorbing wave energy converters that extract energy from waves, at least in part, through the utilization of:

an inertial mass suspended beneath a buoy by a flexible connector connecting the inertial mass to a pulley rotatably connected to the buoy and a power take-off therein wherein the pulley is rotated when the buoy and inertial mass accelerate away from one another;

an oscillating or inertial water column;

an attenuator;

a constricted (e.g., Venturi) tube suspended beneath a buoy by a flexible connector wherein a turbine is positioned within the throat of the constricted tube and is connected to a generator attached to the tube;

a wave-powered water pump that pumps or otherwise moves seawater through a closed circuit that includes a turbine connected to a generator;

a wave-powered water pump that pumps or otherwise moves seawater into a reservoir out of which it subsequently flows back into the body of water through a turbine connected to a generator;

any other point-absorbing wave energy converter; and/or

any other wave energy converter.

Embodiments of the present disclosure include, but are not limited to, those which incorporate, include, and/or utilize, self-propelled point-absorbing wave energy converters that incorporate, include, and/or utilize, propulsive mechanisms, that incorporate, include, and/or utilize, motor-driven propellers, ducted fans, rigid sails (e.g., with associated keels and rudders), flaps that may be raised and/or lowered to increase or decrease a windage area of the device, water jets, Flettner rotors, sea anchors, drogues, and/or water nozzles or pipes for exhausting water, as well as other types, means, and/or mechanisms that are capable of generating thrust.

### 2. Self-Propelled Wind Turbines

An embodiment of the current disclosure incorporates, includes, and/or utilizes, a self-propelled wind turbine.

Embodiments of the present disclosure include, but are not limited to, those which incorporate, include, and/or utilize, self-propelled wind turbines that incorporate, include, and/or utilize, one or more “spar buoys” which typically and/or nominally float adjacent to a surface of the body of water on which the self-propelled wind turbine floats, and typically and/or nominally position an attached wind turbine above the surface of that body of water.

Embodiments of the present disclosure include, but are not limited to, those which incorporate, include, and/or utilize, self-propelled floating horizontal-axis wind turbines, as well as those which incorporate, include, and/or utilize, self-propelled floating vertical-axis wind turbines.

Embodiments of the present disclosure include, but are not limited to, those which incorporate, include, and/or utilize, self-propelled floating wind turbines that incorporate, include, and/or utilize, propulsive mechanisms that incorporate, include, and/or utilize, motor-driven propellers, ducted fans, rigid sails (e.g., with associated keels and rudders), water jets, Flettner rotors, sea anchors, and/or drogues, as well as other types, means, and/or mechanisms that are capable of generating thrust.

### 3. Swarm

An embodiment of the current disclosure incorporates, includes, and/or utilizes, a plurality of self-propelled energy harvesting devices positioned in a spatial geometry in which those self-propelled energy harvesting devices are in relatively close proximity to one another, i.e., positioned within a “swarm” geometry and/or configuration. For example, an embodiment has a plurality of its self-propelled energy harvesting devices positioned within, and/or distributed across, an area corresponding to a spatial density of approximately 10,000 square meters per self-propelled energy harvesting device.

An embodiment's swarm of self-propelled energy harvesting devices nominally propel themselves (and are navigationally controlled by their own control systems or a distant control system) so as to remain within relatively close proximity to one another even as they travel from one location to another.

### 4. Dispersed

An embodiment of the current disclosure incorporates, includes, and/or utilizes, a plurality of self-propelled energy harvesting devices positioned in a spatial geometry in which those self-propelled energy harvesting devices are relatively widely dispersed and separated by relatively great distances, e.g., by more than 1 km.

### 5. Wiggle

An embodiment of the current disclosure incorporates, includes, and/or utilizes a plurality of self-propelled energy harvesting devices which move and/or drift in response to, and/or under the influence of, ambient surface currents and/or surface winds. Even relatively stable prevailing currents and winds can manifest variations in direction and speed, e.g., the relatively small eddies that arise when converging currents and winds collide creating turbulence. And, in order to conserve energy, a self-propelled energy harvesting device of an embodiment may drift with such relatively small eddies rather than expending energy propelling itself along a more consistent and/or direct course.

### 6. Orbit

An embodiment of the current disclosure incorporates, includes, and/or utilizes a plurality of self-propelled energy harvesting devices which move along looping courses, i.e., “orbits,” which take them away from, bring them back to, and carry them through and/or over, a “gateway,” “line,” “band,” “area,” “channel,” “pass,” and/or other range or region of the surface of the body of water on which the embodiment's self-propelled energy harvesting devices float and across which they move.

The orbit of an embodiment is distinct from any wiggles that might characterize the movements of any of its individual self-propelled energy harvesting devices. An embodiment's self-propelled energy harvesting devices may wiggle, traveling relatively short distances along relatively small looping courses, or even backtrack for some distance, even as they generally orbit along relatively large looping courses.

An orbit can be defined by one or more gateways, radial lines, and/or lines normal to a nominal direction of self-propelled energy harvesting device travel, drift, motion, and/or movement, through which at least a plurality of an embodiment's self-propelled energy harvesting devices pass repeatedly and/or with an approximately regular and consistent periodicity.

An orbit can be defined by a central region of the earth's surface around which (i.e. circling which) a majority of an embodiment's self-propelled energy harvesters repeatedly move.

### 7. Cyclical

An embodiment of the current disclosure incorporates, includes, and/or utilizes a plurality of self-propelled energy harvesting devices in which those self-propelled energy harvesting devices travel along, and/or execute, the same orbit. The embodiment's individual self-propelled energy harvesting devices will not travel identical paths and/or courses as they execute the embodiment-specific orbit. However, they will move around the embodiment-specific orbit in the same direction and at approximately the same speed, and they will tend to pass through the same gateway or series of gateways, and the fraction of self-propelled energy harvesting devices passing through said gateway or gateways in a first direction will tend to be significantly greater than the fraction of self-propelled energy harvesting devices passing through said gateway or gateways in the opposite direction. For instance, in some embodiments, over 80% of the passages of self-propelled energy harvesting devices through a single gateway will be in an easterly or clockwise direction (clockwise, that is, when observed from above), while less than 20% of the passages of devices through that same gateway will be in a westerly or counterclockwise direction (counterclockwise, that is, when observed from above). In some embodiments, over 90% of the passages of self-propelled energy harvesting devices through a single gateway will be in an easterly or clockwise direction, while less than 10% of the passages of devices through that same gateway will be in a westerly or counterclockwise direction.

An embodiment of the current disclosure incorporates, includes, and/or utilizes, a plurality of self-propelled energy harvesting devices that move in a swarm about an embodiment-specific orbit. Another embodiment of the current disclosure incorporates, includes, and/or utilizes, a plurality of self-propelled energy harvesting devices that are approximately evenly distributed around the course of the embodiment-specific orbit, and that tend to move around the orbit at approximately the same speed, such that its self-propelled energy harvesting devices tend to pass through each orbit-specific gateway at approximately regular intervals, and at a frequency approximately equal to the number of self-propelled energy harvesting devices divided by the average time it takes an individual self-propelled energy harvesting device to complete an orbit.

Yet another embodiment of the current disclosure incorporates, includes, and/or utilizes, a plurality of self-propelled energy harvesting devices some of which move in a swarm about an embodiment-specific orbit, and others of which are approximately evenly distributed around the course of the embodiment-specific orbit and travel over the orbit separated from one another.

### 8. Computational Energy Harvesting Devices

An embodiment of the current disclosure incorporates, includes, and/or utilizes a plurality of self-propelled energy harvesting devices (or “harvesters”) which include, energize, and/or incorporate, electronic computational nodes, computers, mechanisms, modules, systems, assemblages, circuits, processors, and/or machines, of types and/or categories including, but not limited to, the following:

1. computational components such as:

CPUs, CPU-cores, inter-connected logic gates, ASICs, RAM, flash drives, SSDs, hard disks, GPUs, quantum chips, optoelectronic circuits, analog computing circuits, encryption circuits, and/or decryption circuits

2. computational circuits capable of processing tasks, including, but not limited to:

machine learning, neural networks, cryptocurrency mining, graphics processing, image object recognition and/or classification, image rendering, quantum computing, financial analysis and/or prediction, and/or artificial intelligence.

3. computational circuits characterized by architectures typical of:

“blade servers,” “rack-mounted computers and/or servers,” and/or supercomputers.

### 9. Computational Tasks

An embodiment of the current disclosure incorporates, includes, and/or utilizes a plurality of self-propelled energy harvesting devices which include, incorporate, and/or utilize, computational nodes which obtain the energy they require to operate, at least in part, from electrical energy generated by each respective self-propelled energy harvesting device, within which they are integrated, in response to, and/or as a consequence of, waves that travel across the surface of the body of water on which the self-propelled energy harvesting device floats.

Additionally, each such self-propelled energy harvesting device can utilize its close proximity to the body of water on which the device floats in order to significantly lower the cost and complexity of cooling its respective computational nodes.

Computing tasks of an arbitrary nature are supported, as is the incorporation and/or utilization of computational nodes specialized for the execution of specific types of computing tasks. And, each self-propelled energy harvesting device's receipt of a computational task, and its return of a computational result, may be accomplished through the transmission of data across satellite links, fiber optic cables, LAN cables, radio (e.g., device-to-shore, device-to-device, device-to-drone-to-device, etc.), modulated light, microwaves, and/or any other channel, link, connection, and/or network.

An embodiment of the present disclosure incorporates and/or comprises a plurality of computational nodes, and extracts power from waves moving across and/or through that body of water, thereby converting wave energy into electrical energy. A majority of the electrical power extracted by the self-propelled energy harvesting device is used to energize the device's cluster(s) of computers, and/or to propel the device. The heat generated by the computational nodes is transmitted (e.g. passively and/or conductively) to the water on which the device floats, and/or to the air around it.

### 10. Generation of a Chemical

An embodiment of the current disclosure incorporates, includes, and/or utilizes a plurality of self-propelled energy harvesting devices which include, incorporate, and/or utilize, machines, systems, modules, apparati, processors, and/or nodes, that are energized, at least in part, by power generated by each respective self-propelled energy harvesting device in response to, and/or as a consequence of, waves moving across and/or through that body of water on which it floats, and which use at least a portion of that energy to generate, synthesize, extract, capture, and/or accumulate, a chemical (e.g., hydrogen gas, salt brine, sodium hydroxide, ammonia).

An embodiment of the current disclosure comprises a plurality of self-propelled energy harvesting devices each of which utilizes some of the power that it extracts from ambient waves to electrolyze seawater and generate hydrogen gas, which it then compresses, and/or liquefies, and stores within a compartment and/or chamber.

### 11. Self-Propulsion

Embodiments of the present disclosure include self-propelled energy-harvesting devices that utilize a variety of methods, systems, nodes, techniques, mechanisms, machines, modules, and/or technologies, in order to generate the thrust to propel themselves across the surface of the body of water on which they operate. These mechanisms may include, but are not limited to:

rigid sails

flexible sails

electrically-powered motor-driven propellers

chemically-powered engine-driven propellers

electrically- and/or chemically-powered ducted fans

directed exhausts from oscillating water columns

directed exhausts from a pressurized water reservoir

directed exhausts from an elevated water reservoir

Flettner rotors

sea anchors and/or drogues deployed to relatively shallow depths (e.g., 30 meters)

sea anchors and/or drogues deployed to relatively great depths (e.g., 1,000 meters), and

structural appendages, columns, etc., that extend down into the water column

### 12. Combinations and Derivative Variations

The current disclosure includes many novel embodiments, embodiment-specific constituent energy harvesting devices, embodiments and/or constituent energy harvesting devices that are hybrid combinations of those novel embodiments and/or energy harvesting devices, and variations, modifications, and/or alterations, of those novel embodiments and/or constituent energy harvesting devices, all of which are included within the scope of this disclosure. All derivative embodiments and/or constituent energy harvesting devices, combinations of embodiments and/or constituent energy harvesting devices, and variations thereof, are also included within the scope of this disclosure.

This disclosure, as well as the discussion regarding same, is made in reference to wave and/or wind energy converters on, at, or adjacent to, the surface of an ocean. However, the scope of this disclosure applies with equal force and equal benefit to wave and/or wind energy converters and/or other devices on, at, or adjacent to, the surface of an inland sea, a lake, and/or any other body of water or fluid.

All potential variations in sizes, shapes, thicknesses, materials, orientations, and/or other embodiment-specific variations of the general inventive designs, structures, systems, and/or methods disclosed herein are included within the scope of the present disclosure, and will be obvious to those skilled in the art.

While much of this disclosure is discussed in terms of free-floating, self-propelled, wave energy converters and/or wind turbines, it will be clear that most, if not all, of the disclosure is applicable to, and of benefit with regard to, other types of floating energy-harvesting devices, and all such applications, uses, and embodiments, are included within the scope of the present disclosure.

### 13. Alternate Embodiments

The scope of the present disclosure includes embodiments with any and all:

orbital (i.e., looping course) shapes, sizes (e.g., lengths), and/or complexities;

numbers of energy harvesting devices;

annual average rates of energy extraction per energy harvesting device;

annual average rates of energy extraction per embodiment;

maximal rates of energy extraction per energy harvesting device;

maximal rates of energy extraction per embodiment;

types, manners, and/or mechanisms by which energy is extracted from winds or waves;

types of energies extracted by energy harvesting devices

(e.g., solar, wind, waves, and/or currents);

types of energy consuming processes;

types of computational tasks executed by energy harvesting devices;

nodes, circuits, and/or technologies,

by which data is stored on energy harvesting devices;

amounts of data that can be stored on energy harvesting devices;

types of chemicals generated and/or synthesized by energy harvesting devices;

structures, systems, and/or techniques,

by which chemicals are stored on energy harvesting devices;

amounts of chemical products and/or precursors

that can be stored on energy harvesting devices;

types, mechanisms, and/or nodes, by which devices communicate with other devices;

types, mechanisms, and/or nodes, by which devices communicate with ships;

types, mechanisms, and/or nodes, by which devices communicate with planes;

types, mechanisms, and/or nodes, by which devices communicate with shore stations;

types, mechanisms, and/or nodes, by which devices communicate with satellites;

types, mechanisms, and/or nodes, by which devices communicate with networks;

types of device communication modalities

(e.g., radios, lasers, quantum-encoded channels);

types of electronic devices, mechanisms, circuits, modules, and/or machines,

incorporated within energy harvesting devices;

types of thrust-generating devices, mechanisms, and/or machines

incorporated within energy harvesting devices;

types of navigational equipment, nodes, technologies (e.g., radars, sonars, LIDARS);

types of sensors (e.g., cameras, radars, sonars, LIDARS, echo locators, magnetic);

types of sensors to measure, characterize, and/or evaluate:

winds, waves, currents, atmospheric pressures, relative humidities, and/or other environmental factors;

potential hazards, e.g., ships, ice bergs, floating debris, oil slicks, water depths, subsurface topographies, shore lines, reefs, etc.;

ecological objects of interest, e.g., whales, turtles, fish, birds, plankton, etc.; and/or,

environmental and/or ecological degradations, e.g., pollutants, illegal fishing, illegal dumping, etc.

Embodiments of the present disclosure can be defined and/or characterized by all sizes, shapes, and complexities of orbits (i.e., courses). Orbits comprised of any closed loop and/or repeated pattern of movement (i.e., movement which tends to pass an arbitrary point, line, and/or area, with approximately regular periodicity) is included within the scope of the present disclosure.

An embodiment of the present disclosure includes an energy harvesting device that is propelled by means of a flexibly connected autonomous surface vessel (ASV), e.g., an automated boat or tug. The energy harvesting devices of which embodiments of the present disclosure are comprised need not be propelled by means of modules, systems, mechanisms, and/or machines, incorporated within them, nor fixedly attached to them. Propulsion may be provided by any means, devices, vessels, and/or other external energy-consuming machines, regardless of the manner, method, and/or type of connection by which and/or through which their propulsive forces are transmitted to their respective energy harvesting device(s).

### BRIEF DESCRIPTION OF THE DRAWINGS

For a fuller understanding of the nature and objects of the disclosure, reference should be made to the following detailed description, taken in connection with the accompanying drawings, in which:

FIG. 1 is top view of a schematic diagram of a first embodiment of the present invention;

FIG. 2 is another top view of a schematic diagram of another embodiment of the present invention;

FIG. 3 is another top view of a schematic diagram of another embodiment of the present invention;

FIG. 4 is another top view of a schematic diagram of another embodiment of the present invention;

FIG. 5 is another top view of a schematic diagram of another embodiment of the present invention;

FIG. 6 is a partial flow chart of a first preferred process of the present invention;

FIG. 7 is a continuation of the flow chart of FIG. 6;

FIG. 8 is another top view of a schematic diagram of another embodiment of the present invention;

FIG. 9 is an elevated, perspective view of a first preferred embodiment of the present invention;

FIG. 10 is an elevated, perspective view of a second preferred embodiment of the present invention;

FIG. 11 is an elevated, perspective view of another preferred embodiment of the present invention;

FIG. 12 is a side view of the embodiment of FIG. 11;

FIG. 13 is a sectional view of the embodiment of FIG. 11;

FIG. 14 is an enlarged, sectional view of the embodiment of FIG. 11;

FIG. 15 is an enlarged, perspective sectional view of the embodiment of FIG. 11;

FIG. 16 is an elevated, perspective view of another preferred embodiment of the present invention;

FIG. 17 is a side view of the embodiment of FIG. 16;

FIG. 18 is a sectional view of the embodiment of FIG. 16;

FIG. 19 is an enlarged, sectional view of the embodiment of FIG. 16;

FIG. 20 is an elevated, perspective view of another preferred embodiment of the present invention;

FIG. 21 is a side view of the embodiment of FIG. 20;

FIG. 22 is an elevated, perspective view of another preferred embodiment of the present invention;

FIG. 23 is a side view of the embodiment of FIG. 22;

FIG. 24 is a top sectional view of the embodiment of FIG. 22;

FIG. 25 is an elevated, perspective view of another preferred embodiment of the present invention;

FIG. 26 is a front view of the embodiment of FIG. 25;

FIG. 27 is an enlarged, sectional perspective view of the embodiment of FIG. 25;

FIG. 28 is an elevated, perspective view of another preferred embodiment of the present invention;

FIG. 29 is a side view of the embodiment of FIG. 28;

FIG. 30 is a rear view of the embodiment of FIG. 28;

FIG. 31 is another rear view of the embodiment of FIG. 28;

FIG. 32 is a side view of another embodiment of the present invention;

FIG. 33 is an elevated, perspective view of the embodiment of FIG. 32;

FIG. 34 is an enlarged, sectional perspective view of the embodiment of FIG. 32;

FIG. 35 is a side view of another embodiment of the present invention;

FIG. 36 is a front view of the embodiment of FIG. 35;

FIG. 37 is an elevated, perspective view of the embodiment of FIG. 35;

FIG. 38 is an elevated, perspective view of another embodiment of the present invention;

FIG. 39 is an elevated, perspective view of another embodiment of the present invention;

FIG. 40 is an elevated, perspective view of another embodiment of the present invention;

FIG. 41 is an elevated, perspective view of another embodiment of the present invention;

FIG. 42 is an elevated, perspective view of another embodiment of the present invention;

FIG. 43 is an enlarged, perspective view of the docking port of the embodiment of FIG. 42;

FIG. 44 is a side view of another embodiment of the present invention;

FIG. 45 is a side view of another embodiment of the present invention;

FIG. 46 is a side view of another embodiment of the present invention; and

FIG. 47 is a side view of another embodiment of the present invention.

### DETAILED DESCRIPTION OF THE PREFERRED EMBODIMENTS

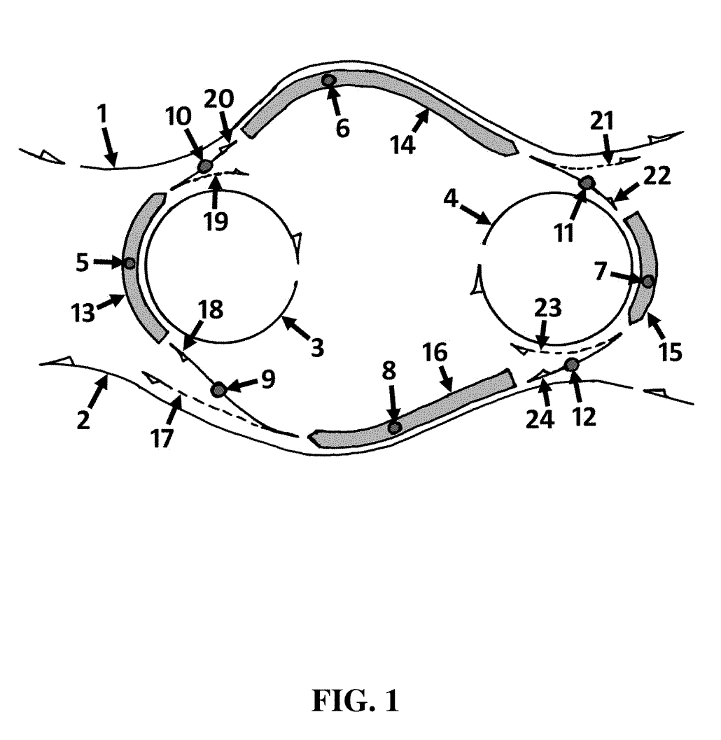

FIG. 1 shows a top-down view of an embodiment of the present disclosure. The embodiment is a compute cluster comprising eight 5-12 self-propelled energy harvesting devices (SPEHDs) that are orbiting about a same, shared, and/or common, approximate course positioned proximate to a plurality of currents by means of which the SPEHDs of the embodiment can orbit or circle within a resource-rich area of the sea. The SPEHDs use their propulsive capabilities to make course corrections and stay on the embodiment-specific orbit as well as to space themselves approximately equidistantly about that orbit, thereby enhancing their exposure to waves and winds undiminished by the energy harvesting and/or extractions of other SPEHDs, and thereby enhancing their collective ability to monitor their shared orbital path and/or course with respect to winds, waves, currents, and nearby shipping and/or floating obstacles, thereby enhancing their collective ability to increase not only the efficiency of their energy extraction, but also to lower their risks of collisions. The SPEHDs each have a computing assembly configured to communicate with a wireless data transfer bus common to all the SPEHDs.

The illustrated embodiment's plurality of SPEHDs are traveling (i.e., orbiting) a shared and/or common course adjacent to the surface of a body of water that is characterized by currents, as well as wind or waves. The orbit can be characterized, for instance, as around the centermost part of the figure.

SPEHDs 5-12 are free floating, and therefore lack moorings to the seafloor that would tend to hold them in fixed positions despite the translocating lateral forces imparted to them by ambient currents, winds, and waves. Physical moorings have utility in that they tend to keep floating energy harvesting devices (EHDs) within a particular area of the sea so that they can extract energy without drifting out to sea and being lost there.

Physical moorings tend to keep floating EHDs adjacent to subsea power cables so that their extracted energy can be sent to electrical grids on shore. And, in the absence of a physical mooring, an EHD of the prior art would tend to drift out to sea, and become a hazard to navigation and/or to itself, e.g., it would tend to collide with ships, run aground on shore, etc. Furthermore, in the absence of a physical mooring, an EHD of the prior art would not be sufficiently stationary to permit it to be connected to a subsea power cable, or, if it was so connected, it would tend to break that connection as it drifted away. In the absence of a physical mooring, any energy extracted by an EHD of the prior art would tend to be stranded on the EHD, and, as soon as any storage capacity, e.g., batteries, on that EHD was full, all new extracted energy would be wasted.

However, the embodiment of the current disclosure presented in FIG. 1 illustrates an alternative to physical moorings. The SPEHDs of the embodiment of the current disclosure illustrated in FIG. 1 remain within a specific portion of the sea by moving across, over, and/or within an approximately regular, repeating, closed loop, course, and/or pathway. The distributed apparatus illustrated in FIG. 1 includes a plurality of such SPEHDs coordinated by a common navigation system (e.g. one with which the SPEHDs communicate by satellite) is one example of an embodiment of the current disclosure. The cyclic and repeating nature of the typical and/or nominal courses of such SPEHDs keeps them within a favorable, resource-rich portion of the sea, as well as keeping them from wandering into shipping lanes, and/or into land, while also minimizing the energy that they expend opposing ambient currents, winds, and waves.

The SPEHDs utilize mechanisms, machines, features, and/or nodes, so as to extract energy from wind and/or waves, at least a portion of which they then consume with, through, and/or to energize, additional mechanisms, machines, features, and/or nodes, that use that extracted energy to perform some useful work or to produce some useful product, namely (in this embodiment) performing computations in accordance.

However, the efficiency of these SPEHDs is diminished to the degree to which a portion of the energy that they harvest must be consumed, “wasted,” lost, and/or diverted in order to generate thrust, by means of their self-propulsion mechanisms, modules, and/or nodes, in order to counter ambient currents, winds, or waves, and hold a fixed geospatial position, and/or propel themselves along a favorable course.

An embodiment of the current disclosure illustrated in FIG. 1, illustrates the utility of a group of SPEHDs operating in a region of the sea where wind and/or wave resources are favorable, and in which one or more ambient currents of water and/or wind, e.g., prevailing currents and/or winds, permit those SPEHDs to travel in a cyclical course primarily by drifting and therefore with a minimal expenditure of energy generating propulsive thrusts.

In FIG. 1, illustrated is a top-down view of a region in the sea (or another body of water) in which an upper current 1 flows from left to right, and a lower current 2 flows from right to left. In between the upper 1 and lower 2 currents are a pair of circular currents (i.e., gyres), one 3 on the left and another 4 on the right, both of which are flowing in clockwise directions.

Floating adjacent to the surface of the body of water are four SPEHDs 5-8 that are passively drifting with currents 3, 1, 4, and 2, respectively. Another four SPEHDs 9-12 are transitioning between currents by generating thrust approximately normal to their direction of drift.

SPEHD 5 is drifting along a course segment 13 over which it does not expend energy generating propulsive thrusts. Similarly, SPEHDs 6-8 are drifting along course segments 14-16.

SPEHDs 5-8 are drifting passively, being carried along with the currents beneath them, and all without the need to expend any energy generating thrust in order to modify their trajectories. However, SPEHDs 9-12 are using a portion of the energy they have extracted to generate thrusts so as to transition from one current to another.

In the absence of any generated thrust, SPEHD 9 would have tended to continue to drift with current 2, along an approximately parallel course 17, potentially leaving the energy-rich area of the cyclical course, entering a shipping lane, colliding with land, or experiencing some other unfortunate mishap. At the very least, had SPEHD 9 continued to drift with current 2 instead of generating thrust in order to join gyre current 3, it would have left the area in which its fellow SPEHDs were operating, thereby reducing its ability to engage in cooperative activities (e.g., like joining them within a virtual computing network created by peer-to-peer radio communications, or reporting data about common environmental conditions) and increasing the cost of providing that SPEHD with logistical and maintenance support. Through its generation of a thrust, SPEHD 9 instead follows course 18 and transitions from drifting with current 2 to drifting with gyre current 3, and continuing around the shared cyclical course being transited and/or following by the other SPEHDs in the embodiment.

In the absence of any generated thrust, SPEHD 10 would have tended to continue to drift with gyre current 3 along an approximately tangential course 19. However, through its generation of a thrust, SPEHD 10 instead follows course 20 and transitions from drifting with gyre current 3 to drifting with current 1. Similarly, using thrusts, SPEHDs 11 and 12 follow current-transitioning courses 22 and 24, respectively, instead of the courses 21 and 23, respectively. SPEHDs that failed to generate thrust so as to escape either of the gyre currents 3 or 4 would remain in the energy-rich area, and would remain proximate to their fellow SPEHDs. However, the spacing and/or separation between them would be reduced potentially causing SPEHDs to compete for the same energy resources and thereby reducing the efficiency with which they could and would extract energy. It is to be understood that “thrusts” means any use of propulsion, including the changing of the position of a sail in order to move in a certain direction under the influence of wind.

Many SPEHDs might have continued drifting around one or the other gyre currents 3 and 4. Doing so would have reduced the amount of energy they needed to expend as thrust, potentially improving their efficiencies. However, the smaller area over which each gyre current flowed might have required a similar number of SPEHDs to have significantly less separation between them, i.e., to be more densely packed. This would potentially have at least two significantly negative impacts on such an embodiment's efficiency and cost-effectiveness. First, it would cause the SPEHDs to extract energy from a much smaller area and to therefore begin competing with one another for a more limited supply of energy. Secondly, it would increase the risk of collisions, e.g., by SPEHDs drifting into, and damaging, one another.

An embodiment similar to the one illustrated and discussed in relation to FIG. 1 has SPEHDs that extract energy from waves traveling across the surface of the body of water on which they float. An embodiment similar to the one illustrated and discussed in relation to FIG. 1 has SPEHDs that extract energy from winds blowing and/or flowing across the surface of the body of water on which they float. An embodiment similar to the one illustrated and discussed in relation to FIG. 1 has SPEHDs that extract energy from both winds and waves moving across the surface of the body of water on they float.

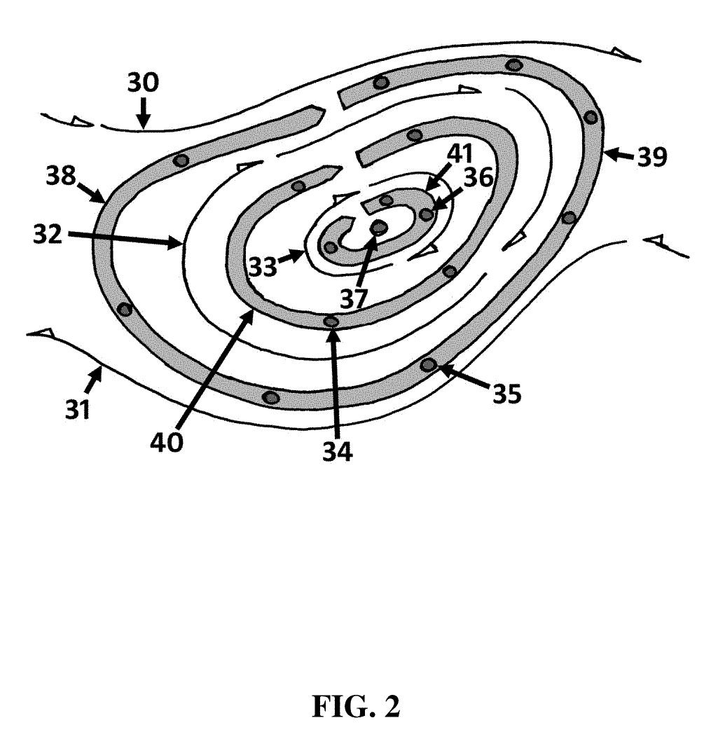

FIG. 2 shows a top-down view of an embodiment of the present disclosure. A plurality of self-propelled energy harvesting devices (SPEHDs) constitute a compute cluster and are traveling (i.e., orbiting) about a shared and/or common cyclical course adjacent to the surface of a body of water that is characterized by currents, as well as wind or waves.

Upper 30 and lower 31 currents are associated with a gyrating current 32-33 within which a plurality of SPEHDs, e.g., 34-37, travel in approximately concentric orbital paths, e.g., 38-41, and/or courses. The individual SPEHDs may move toward and/or away from the center of the orbit while remaining within the outer bounds of the orbital region (i.e., bounded, at least in part, by currents 30 and 31) and while remaining on circuits that encircle a common central region of the earth's surface (e.g. the region near 37). With respect to this embodiment, and the currents being exploited by the embodiment for positional stability, very little of the energy that the SPEHDs extract from winds and/or waves must be expended generating thrusts. The revolving orbital currents of the gyre, e.g., 32-33, permit many, if not all, of the embodiment's SPEHDs to remain within the area they orbit by simply and/or exclusively drifting with and/or within the revolving currents.

An embodiment similar to the one illustrated and discussed in relation to FIG. 2 has SPEHDs that extract energy from waves traveling across the surface of the body of water on which they float. An embodiment similar to the one illustrated and discussed in relation to FIG. 2 has SPEHDs that extract energy from winds blowing and/or flowing across the surface of the body of water on which they float. An embodiment similar to the one illustrated and discussed in relation to FIG. 2 has SPEHDs that extract energy from both winds and waves moving across the surface of the body of water on which they float.

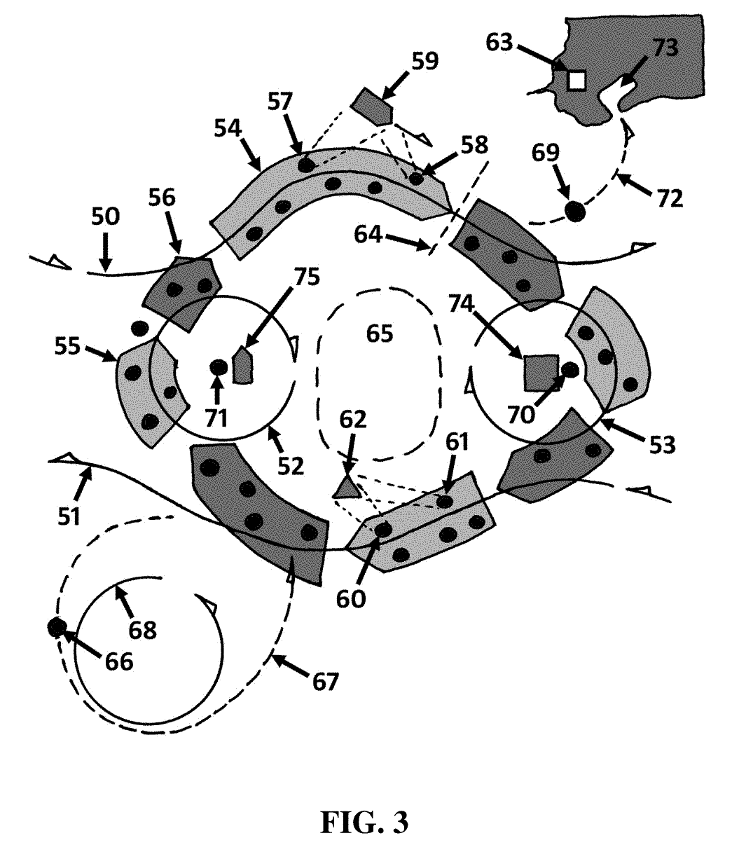

FIG. 3 shows a top-down view of an embodiment of the present disclosure which is similar to the embodiment illustrated and discussed with respect to FIG. 1. A plurality of self-propelled energy harvesting devices (SPEHDs) are traveling (i.e., orbiting) about a shared and/or common cyclical course adjacent to the surface of a body of water that is characterized by a pair 50 and 51 of opposing currents, and revolving gyres 52 and 53 positioned between them.

This embodiment's SPEHDs are orbiting a course that takes advantage of the cyclical current- and gyre-specific regions of seawater flow that are available at the illustrated location in the sea. The embodiment's SPEHDs drift across portions of each current, e.g., 54, and each gyre, e.g., 55. And, the embodiment's SPEHDs generate thrust of sufficient force and direction over portions, e.g., 56, of their courses so as to transition from one current or gyre to another, and/or to move in and out of a single common current.

As they orbit, those SPEHDs equipped with cameras and/or other detection sensors identify nearby ships (e.g., SPEHDs 57 and 58 have identified a ship 59 moving approximately parallel to the embodiment's orbital path) nearby obstructions and/or other floating debris (e.g., SPEHDs 60 and 61 have identified a piece of floating debris 62), and other potential hazards the positions, directions, speeds, approximate sizes, shapes, and/or other identifying and/or intrinsic information of which they share with the other, especially with other proximate, SPEHDs (e.g., by peer-to-peer radio communications) and/or with a central command and/or coordinating facility 63 (e.g. via satellite) which can then integrate such information and inform the SPEHDs of predictive information and/or use such information to direct the courses and speeds of the SPEHDs. A centralized shore-based (and/or any other centralized) command and control facility, e.g., 63, center, and/or module, system, and/or device is a constituent element, component, and/or part of the embodiment that it controls. An embodiment's command and control facility might be located on shore, on a ship, on a platform, on one or more of an embodiment's SPEHDs, or at or on any other location. A similar embodiment to the one illustrated in FIG. 3 uses a distributed peer-to-peer command and control system, architecture, and/or structure.

At least a plurality of the SPEHDs in the embodiment, if not a majority of them, travel around the embodiment's nominal orbit repeatedly. For example, one SPEHD in the embodiment travels around the illustrated orbital path, crossing an arbitrary virtual line 64 approximately once per year. A plurality of SPEHDs complete full orbits with an approximately regular, common, constant, and/or predictable, frequency. Over the course of a given period of time, most, if not all, of the embodiment's SPEHDs will complete multiple orbits, and/or full revolutions around the embodiment's nominal orbital path. The fact that an embodiment's SPEHDs may sometimes “backtrack” for some period of time relative to the nominal orbital direction (e.g. because of an environmental force such as wind or because of a thrust applied in a backtracking direction) is typical and does not remove the embodiment from the scope of this disclosure.

An embodiment's nominal orbital path and/or course may change, alter, morph, and/or evolve, over time as the paths of the individual currents which it exploits change their courses and/or speeds, and/or as the cumulative pattern of environmental forces directing the drifting motion of floating objects changes in response to variations in one or more of the forces (e.g., wind, wave, and/or current) contributing to that cumulative pattern. For example, its radius may grow, and the center of its orbit may shift. An embodiment's nominal orbital path may change as the availability of wind and/or wave resources around one orbital path decrease, and the availability of those resources around an alternate and/or modified orbital path increase. However, the prevailing orbital direction (e.g. clockwise or counterclockwise when viewed from above) of an embodiment will typically not change, nor will the fact that it forms a closed looping topology defined by the paths of a plurality of the individual SPEHDs of the embodiment.

In the illustrated embodiment, none of the embodiment's SPEHDs travel to, through, around, and/or across, a region 65 proximate to the center of the orbital path. In some embodiments, an “off limits” zone near the center of the orbital path contains no operational SPEHDs. In some embodiments, an “off limits” zone near the center of the orbital path contains a land mass such as an island or continent.

Occasionally, one or more of an embodiment's SPEHDs, e.g., 66, may be unable to remain within, or near the midline of, the embodiment's nominal orbital path, e.g., due to an inability to generate sufficient thrust, and/or an encounter with unexpectedly forceful winds, waves, and/or currents, and may deviate from that orbital path, and travel along a path, e.g., 67, that diverges from the nominal path. In such a case, an “off-course” SPEHD may use a substantial portion of its available energy to follow a course that leads it back toward the nominal course. When possible, such an off-course SPEHD may take advantage of other currents and/or gyres, e.g., 68, to assist and/or speed its return to the nominal course. In some embodiments, a ship or remote-operated vehicle may be dispatched to tow an off-course SPEHD back to a nominal orbital path.

Occasionally, one or more of an embodiment's SPEHDs, e.g., 69-71, may generate thrust and deliberately leave the embodiment's nominal orbital course, and follow a deviant course, e.g., 70, in order to travel to a port, e.g., 71, a platform, e.g., 74, a ship, e.g., 75, and/or another location, at which it may be inspected, maintained, repaired, upgraded, decommissioned, and/or replaced, and/or at which precursors to a process (e.g., a chemical process) may be onloaded to an SPEHD, and/or at which products of a process (e.g., a chemical process) may be offloaded from an SPEHD.

An embodiment similar to the one illustrated and discussed in relation to FIG. 3 does not have a region in the center of the embodiment-specific orbital path within which the embodiment's SPEHDs never travel and are never found.

An embodiment similar to the one illustrated and discussed in relation to FIG. 3 has SPEHDs that extract energy from waves traveling across the surface of the body of water on which they float. An embodiment similar to the one illustrated and discussed in relation to FIG. 3 has SPEHDs that extract energy from winds blowing and/or flowing across the surface of the body of water on which they float. An embodiment similar to the one illustrated and discussed in relation to FIG. 3 has SPEHDs that extract energy from both winds and waves moving across the surface of the body of water on which they float.

An embodiment similar to the one illustrated and discussed in relation to FIG. 3 uses at least a portion of the energy that its SPEHDs extract from its environment to generate hydrogen and/or sodium hydroxide by electrolyzing seawater or a brine thereof. An embodiment similar to the one illustrated and discussed in relation to FIG. 3 uses at least a portion of the energy that its SPEHDs extract from its environment to produce concentrated salt brine, brackish water, or fresh water. The SPEHDs of this embodiment offload at least a portion of the hydrogen (or other products) that they have generated over a period of time to ships, e.g., SPEHD 71 offloading hydrogen to ship 75 which stores it in tanks, to platforms, e.g., SPEHD 70 offloading hydrogen to a platform 74 where it is stored in tanks, and/or to port facilities, e.g., SPEHD 72 traveling to a port 73 where at least a portion of its hydrogen will be offloaded and stored in tanks.

An embodiment similar to the one illustrated and discussed in relation to FIG. 3 uses at least a portion of the energy that its SPEHDs extract from its environment to generate ammonia. The embodiment's SPEHDs periodically offload their ammonia to ships, e.g., 75, platforms, e.g., 74, and/or within ports, e.g., 73.

An embodiment similar to the one illustrated and discussed in relation to FIG. 3 is a computing cluster or compute cluster, and uses at least a portion of the energy that its SPEHDs extract from its environment to energize computational equipment and perform computational tasks. Some of the tasks and supporting input data may be, or have been, downloaded to each SPEHD's respective computational equipment from satellites (via radio transmissions), shore-based data centers (e.g., via radio transmissions), from other SPEHDs (e.g., by peer-to-peer daisy-chained radio communications, etc.) Some of the computational results may be exported from each SPEHD's respective computation equipment by similar means. Some of the programs and data processed by the embodiment's SPEHDs, as well as some of the results of the ensuing computations, may have been transferred to and from each respective SPEHD through the physical transfers to and from the SPEHD of “data banks” (e.g., collections of hard drives). Such transfers might occur and/or be executed at ships, e.g., 75, platforms, e.g., 74, and/or port facilities, e.g., 73, and/or through the mating of the SPEHD with an unmanned submersible or airborne drone carrying said data bank(s).

The SPEHDs of an embodiment similar to the one illustrated and discussed in relation to FIG. 3 travel around the embodiment-specific orbital path, and complete full revolutions (e.g., crossing a line 64 normal to the axis of the path) with an approximately regular, common, constant, and/or predictable, frequency of approximately one revolution per month. The SPEHDs of an embodiment similar to the one illustrated and discussed in relation to FIG. 3 travel around the embodiment-specific orbital path, and complete full revolutions with a frequency of approximately one revolution every 3 months. And, the SPEHDs of an embodiment similar to the one illustrated and discussed in relation to FIG. 3 travel around the embodiment-specific orbital path, and complete full revolutions with a frequency of approximately one revolution every year. Other embodiments have other embodiment-specific SPEHD orbital frequencies. The SPEHD orbital frequencies of an embodiment vary with the seasons (e.g., becoming shorter when prevailing seasonal winds become faster). All orbital frequencies, and all degrees of variations of those frequencies, are within the scope of the current disclosure.

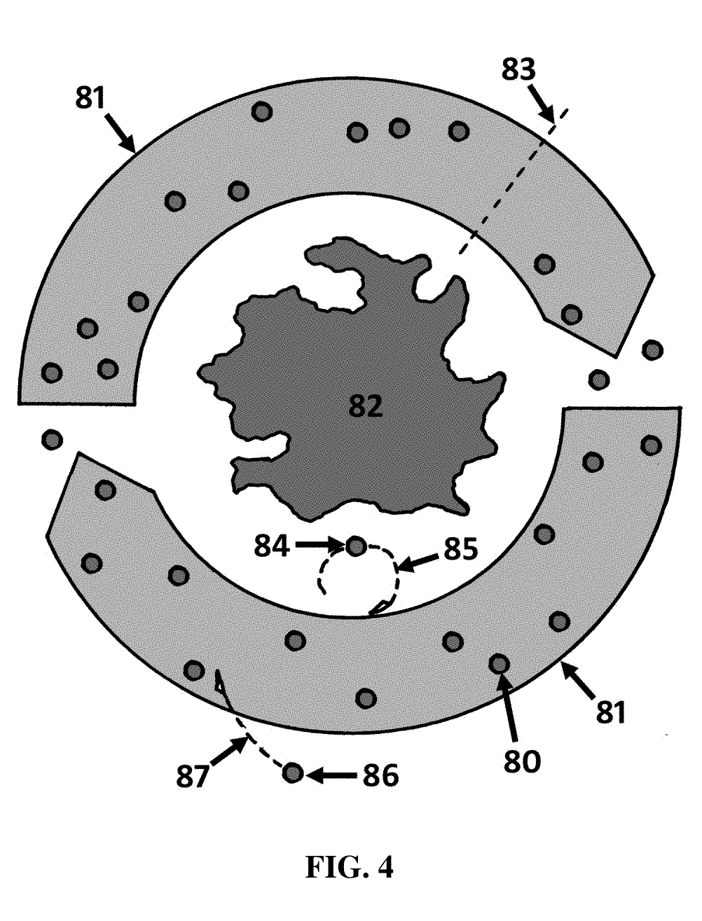

FIG. 4 shows a top-down view of an embodiment of the present disclosure which is similar to the embodiments illustrated and discussed with respect to FIGS. 1-3. A plurality of self-propelled energy harvesting devices (SPEHDs), e.g., 80, are traveling (i.e., orbiting) about a shared and/or common cyclical course 81 adjacent to the surface of a body of water. The orbital path followed by the embodiment's SPEHDs is adjacent to, and circles, a body of land 82, and is conformal, and/or follows, a current, waves, and/or winds, of similar extent and direction which also tends to orbit the land mass.

The embodiment's SPEHDs tend to revolve around the orbital's closed loop, course, and/or pathway, and/or the repeating pattern of SPEHD motion, at an approximately regular, repeating, and regular frequency of once per 7 weeks. Each revolution may be arbitrarily evaluated or demarcated with respect to any arbitrary radial delimiter, e.g., 83, from which the orbital journey of each SPEHD may be regarded as having its nominal start and completion. In colloquial terms, if the orbital's closed loop is viewed as an athletics track, a full “lap” may be understood to have its start and finish at any location around the track.

An embodiment's SPEHDs may deliberately deviate from the embodiment's nominal orbital path (e.g., in order to avoid floating debris, another ship, one or more marine mammals, etc.), or they may be driven from that nominal orbital path through the influence of external environmental forces (wind, currents, waves, tsunamis, etc.). The pace, rate, and/or speed, of one or more of an embodiment's SPEHDs may be slowed so as to delay their departure from an area within the nominal orbital path with particularly favorable wind and/or wave conditions. The pace, rate, and/or speed, of one or more of an embodiment's SPEHDs may be increased so as to advance their arrival to an area within the nominal orbital path that has, or is forecast to soon have, particularly favorable wind and/or wave conditions. The pace, rate, and/or speed, of one or more of an embodiment's SPEHDs may be increased or decreased so as to reduce the likelihood that those SPEHDs will be present within an area within the nominal orbital path that has, or is forecast to soon have, particularly dangerous and/or excessively energetic wind and/or wave conditions.

One 84 of the SPEHDs of the embodiment illustrated in FIG. 4, has fallen out of the current 81 on which the other SPEHDs drift and uses its self-propulsive capabilities (which can include simply increasing a windage area of the SPEHD, e.g. by raising flaps, when winds are blowing toward the desired direction of travel) to follow a course 85 that will return it to the nominal orbital path. As a result of its diversion, SPEHD 84 will assume a new relative position among the SPEHDs orbiting land mass 82, and it will likely take longer to complete the affected revolution than will its undiverted peers.

A newly fabricated SPEHD 86 is being added to the embodiment illustrated in FIG. 4. It has extracted energy from the environment, and used some or all of that energy to propel itself from its point of deployment (not shown) along a course 87 that will cause it to join its new embodiment-specific peers.

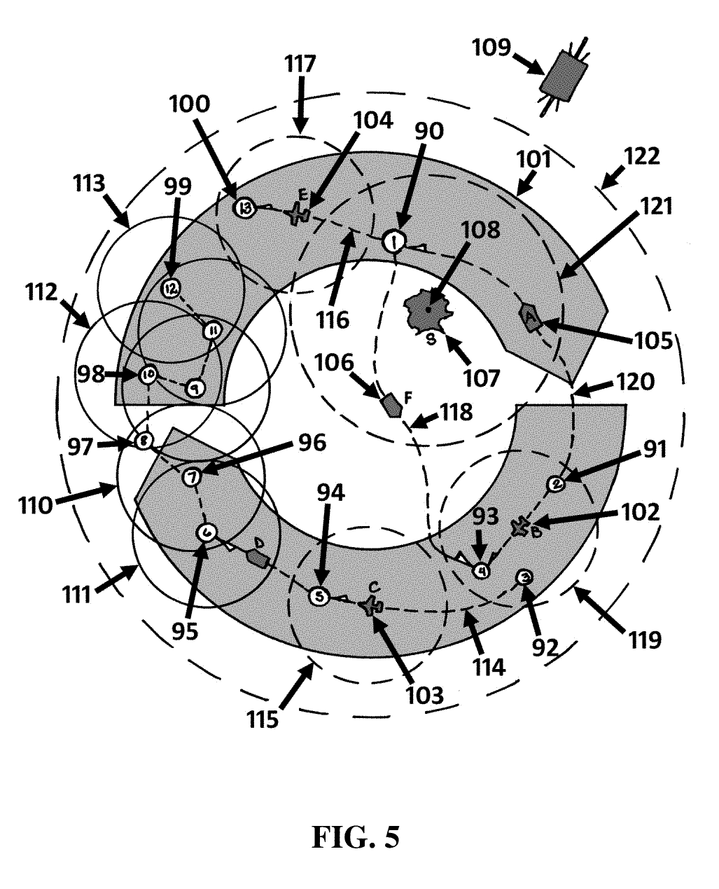

FIG. 5 shows a top-down view of an embodiment of the present disclosure which is similar to the embodiment illustrated and discussed with respect to FIG. 4. A plurality of self-propelled energy harvesting devices (SPEHDs), e.g., 90-100, are traveling (i.e., orbiting) about a shared and/or common cyclical course 101 adjacent to the surface of a body of water. The orbital path followed by the embodiment's SPEHDs is conformal, and/or follows, a current, waves, and/or winds, of similar extent and direction.

Most, if not all, of the embodiment's SPEHDs are capable of communicating with one another by means of onboard, and/or integrated, radio communications equipment. Most, if not all, of the embodiment's SPEHDs are capable of communicating with aerial drones, e.g., 102-104, and/or water-borne (surface boats, and/or underwater vessels) drones, e.g., 105-106. Most, if not all, of the embodiment's SPEHDs are capable of communicating with a land-based 107 communications station 108 (e.g., via radio, including via a satellite relay). And, most, if not all, of the embodiment's SPEHDs are capable of communicating with a satellite 109. By means of complementary types of communications, and overlapping type-specific and environmentally-specific ranges, messages, data, commands, and/or other types of signals, are passed to and from SPEHDs, and/or between SPEHDs and shore-based communications stations, e.g., 108, networks, and/or computers.

SPEHD “7” 96 is able to exchange data with any other SPEHDs within range 110 of its radio, which in the illustration of FIG. 5 includes SPEHDs “6” 95 and “8” 97. In turn, SPEHD “8” 97 is within range 112 of SPEHD “10” 98, which is also within range 112 of SPEHD “9.” Similarly, SPEHD “11” is within range of SPEHD “9.” And, SPEHD “11” is within range 113 of SPEHD “12” 99. Thus, SPEHDs “6” 95 through “12” 99 form an interconnected virtual (e.g., radio-linked) communications and/or data network through which data and messages can be exchanged through peer-to-peer daisy-chained relaying of that data and those messages among the constituent SPEHDs.

Both SPEHDs “2” 91 and “4” 93 are within range 119 of aerial drone “B” 102, and aerial drone “B” is thereby able to relay data to and between those SPEHDs, as well as being able to convey data to, and/or retrieve data from, either SPEHD. Aerial drone “B” 102 took off from SPEHD “2” 91 where it recharged, and is following a flight path that approximately follows the orbital course and direction being followed by the embodiment's SPEHDs, and which will take it to SPEHD “4” 93 where it will land and recharge, before taking off and traveling along another path and carrying data from SPEHD “4” 93 to one or more other SPEHDs, and/or before providing a communications link between two or more other SPEHDs.

Aerial drone “C” 103 has taken off from SPEHD “3” 92 where it recharged, and is following flight path 114, that approximately follows the orbital course and direction being followed by the embodiment's SPEHDs, on its way to SPEHD “5” 94 where it will land and recharge. While drone “C” was within range of SPEHD “3” 92 it was able to exchange data with that device, and, as soon as it came within range 115 of SPEHD “5” 94 it became able to exchange data with that SPEHD.

Aerial drone “E” 104 has taken off from SPEHD “1” 90 where it recharged, and is following flight path 116, that approximately follows the orbital course being followed by the embodiment's SPEHDs, but in the opposite direction, on its way to SPEHD “13” 100 where it will land and recharge. While drone “E” was within range of SPEHD “1” 90 it was able to exchange data with that device, and, as soon as it came within range 117 of SPEHD “13” 100 it became able to exchange data with that SPEHD.

Water-borne drone “D” is traveling from SPEHD “5” 94 where it recharged to SPEHD “6” 95 where it will recharge again. It is traveling a course that approximately follows the orbital course and direction being followed by the embodiment's SPEHDs. It is also capable of carrying data from SPEHD “5” to SPEHD “6” and of updating that data while within range of the SPEHD from which it travels, and of transmitting that data as soon as it is within range of the SPEHD to which it travels, and/or whenever it is within range of any other SPEHDs that it passes along its route as it travels.

Water-borne drone “F” 106 is traveling from SPEHD “1” 90 where it recharged, along course 118, which cuts across the center of the orbital course being followed by the embodiment's SPEHDs, to SPEHD “4” 93 where it will recharge again. It is also capable of exchanging data with any SPEHD that is, even if briefly, within range of its radio, and/or whenever the respective radios of drone “F” and a passing SPEHD are within range of one another. Drone “F” is capable of storing that data and sharing it with any other SPEHDs that are, even if briefly, within range of its radio.

Water-borne drone “A” is traveling from SPEHD “2” 91 where it recharged, along a course 120 that approximately follows the orbital course being followed by the embodiment's SPEHDs, but in the opposite direction, to SPEHD “1” 90 where it will recharge again. It is also capable of carrying data from SPEHD “2” 91 to SPEHD “1” 90, as well as facilitating the exchange of data between other SPEHDs, by storing and relaying data obtained from each, and sharing it with other SPEHDs when they come within range of its communications nodes, channels, and/or radio(s).

Because this embodiment of the present disclosure, like other embodiments, utilizes a patch-work of overlapping communications channels, the data is timestamped to allow each SPEHD to utilize the most recent data, and to benefit from the analysis of the change in data over time.

The illustrated embodiment takes advantage of an adjacent island 107 by placing on it a centralized communications, coordination, and control station 108 from which it can exchange data with the embodiment's SPEHDs, e.g., SPEHD “1” 90, as they pass within range 121 of its communications equipment. The illustrated embodiment also utilizes a satellite or satellite network 109 that is able to exchange data with most, if not all, of the embodiment's SPEHDs since most, if not all, of the embodiment's orbit falls within its range.

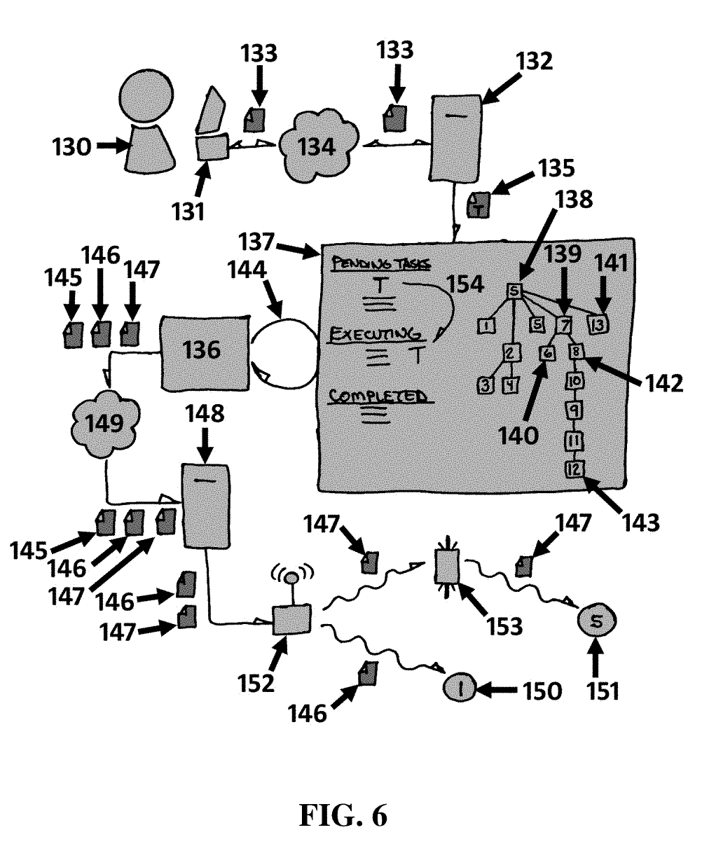

FIG. 6 illustrates a simplified representative flow chart that describes in approximate terms one of many processes by which an embodiment of the present disclosure might be used to execute a customer-specified, arbitrary computational task. A company, corporation, and/or organization, uses an embodiment of the present disclosure, or pays the owner/operator of that embodiment, to provide “computation as a service” for which its customers pay a fee.

A customer 130 of the company uses a proprietary computational node 131 to interact with a company server 132 by exchanging data, files, and/or messages 133 through a data network 134 (e.g., the Internet). Server 132 sends a program or formatted block of data (e.g., HTML) 133 to the customer's computer 131 which renders a user interface within a browser running on the customer's computer. The customer interacts with that user interface so as to formulate a structured data set 133 that is transmitted to the server 132, and which may contain data including, but not limited to: the program to be executed on behalf of the customer (or an identifier or URL through which the program to be executed on behalf of the customer may be found and obtained by the server), the data (if any) which will initialize the program, the number of times the program is to be executed, the maximum amount of time which the customer is willing to wait for the results (e.g., the “deadline”), the “resolution” of the analysis and/or the results (e.g., how many vertices to use in a finite-element analysis of a structure), the format of the result data (e.g., JPEG for a result comprising images), etc.

The server 132 packages the “task specification (T)” 135 which it transmits to a “task manager” 136/137. The task manager 136 maintains a database (and/or other data structure) that may include, but is not limited to: which tasks are “completed,” which tasks are currently “executing,” and which tasks are currently “pending tasks” (i.e., tasks waiting to be executed, e.g. stored in a queue data structure).

The task manager 136 also maintains an updated graph 138 which specifies which SPEHDs are within communications range of a particular communications node (e.g., of a land-based station “S”). In the illustration of FIG. 6, ground station “S” is currently able to communicate with SPEHDs “1,” “2,” “5,” “7” 139, and “13” 141.

The link between each pair of communications nodes may also specify attributes of the channel by and/or through which those two nodes are connected, which may include, but are not limited to: the characteristic latency of the channel, the bandwidth (e.g., bits per second) of the channel, the cost of the channel (e.g., satellites tend to be more expensive channels than radio), etc.

In the illustrated task manager's 137 SPEHD configuration graph 138 of FIG. 6, the exchange of data between the shore-based station “S” 138 and SPEHD “6” 140 is accomplished through the intermediary communications node provided by SPEHD “7” 139. The exchange of data between shore-based station “S” 138 and SPEHD “8” 142 is achieve by and/or through intermediary SPEHD “7” 139. And, the exchange of data between shore-based station “S” 138 and SPEHD “12” 143 is achieved by and/or through five intermediary SPEHDs, e.g., SPEHD “8” 142. In addition to the possibility of daisy-chaining the transmission of data from the shore-based station “S” 138 to many, if not all, of the embodiment's SPEHDs, likely at a relatively modest cost, it is possible for the shore-based station “S” 138 to exchange data with any SPEHD via a satellite-mediated exchange of data, likely at a significantly higher cost.

The task manager's 136 database 137 and/or graph also maintains an updated record of which computational capabilities, components, elements, circuits, and/or modules are possessed by, and/or incorporated within, each of the embodiment's SPEHDs, as well as which of each SPEHD's computational components, elements, circuits, and/or modules, are currently executing tasks (and therefore unavailable to process new or “pending” tasks), and their estimated times of task completion.

Periodically, e.g., every 10 milliseconds, the task manager 136 checks 144 for new tasks, e.g., 135, and adds them to the queue of “pending tasks,” as well as determining which “executing” tasks have completed, updating the availability of SPEHD-specific computational modules, and updating the available inter-SPEHD communications pathways, at the same time.

Upon receiving a new task, e.g., task “T” 135, and periodically thereafter, task manager 136 checks to see if the computational capabilities required to execute the task are available among those SPEHDs within communications range of the shore-based station “S” 138. It may also weigh the “urgency” of the task (as a result of which it may elect to wait for more capable computational capabilities to become available, and/or wait for those SPEHDs with reduced communications latencies to come in range of the shore-based station and/or an SPEHD linked, directly or indirectly, with the shore-based station), and/or whether or not a “premium price” was paid for the task's completion. When a suitable SPEHD, or combination of SPEHDs, are found (e.g., that possess suitable and available computational capabilities), then the task is partitioned into inter-related component tasks that may be executed with at least some degree of independence and the results of which may be combined (e.g., “map-reduced”) when the component results are ready.

With respect to task “T,” task manager 136 formulates and sends to the shore-based station three task specifications: 1) one 145 to be executed by computational equipment at the shore-based facility; 2) one 146 to be executed by SPEHD “1;” and one 147 to be executed by SPEHD “5.” The task manager 136 transmits these three task specifications 145-147 to a computing node 148 through a network 149, and/or communications channel, that may include LAN cables, fiber optic cables, phone lines, radio channels, satellites, etc.

The receiving computer 148 at the ground station forwards task 146 to SPEHD “1” 150 via radio transmitter 152 (i.e., SPEHD “1” is within range of the shore-based station's radio transmitter, so it is used to transmit task 146 to that SPEHD).

The receiving computer 148 at the ground station forwards task 147 to satellite 153, which forwards that task to SPEHD “5” 151 (i.e., SPEHD “5” is not within range of the shore-based station's radio transmitter, so a satellite is used to relay that task to SPEHD “5”, and its link to the shore-based station “S” 138 in the task manager's 137 SPEHD configuration graph 138 indicates that the communications link is via satellite and has a higher cost and a reduced bandwidth).

After receiving tasks 146 and 147, SPEHDs “1” and “5,” respectively, load them onto the computational resource(s) specified in the respective task descriptions and execute those tasks.

Tasks may be transmitted to, and/or relayed by, intermediate drones, SPEHDs, and/or other communication channels and/or nodes as circumstances permit.

After transmitting tasks 145-147, task manager 136 updates 154 the task lists within its database 137 to show that task “T” is now “executing.”

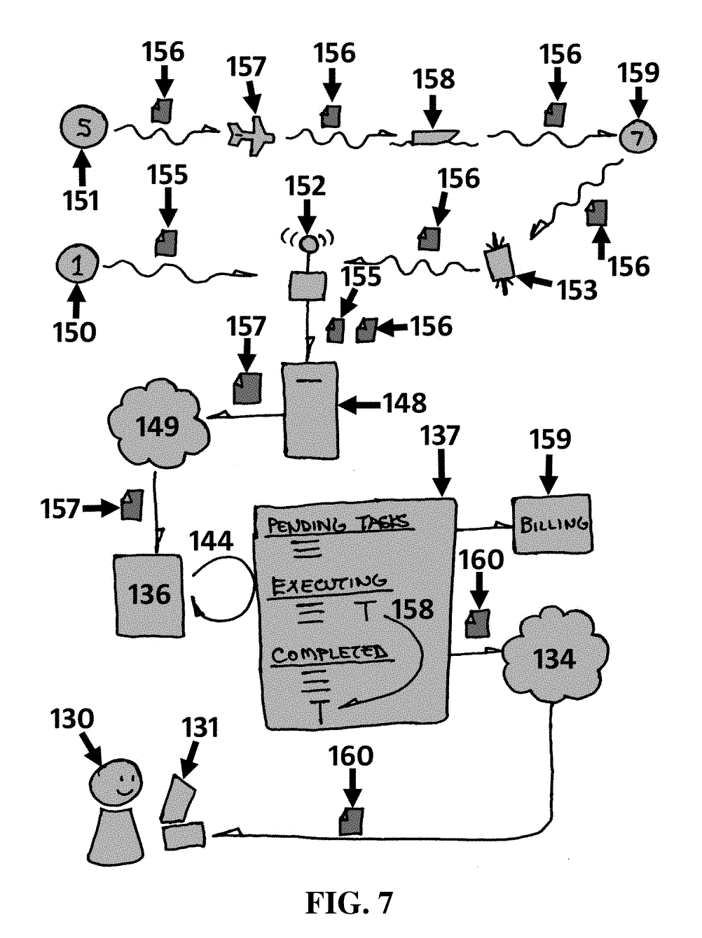

FIG. 7 illustrates a continuation of the same simplified representative flow chart that is illustrated and discussed in relation to FIG. 6.

SPEHDs “1” 150 and “5” 151 complete the execution of their respective portions of the task “T” described in relation to FIG. 6.

SPEHD “1” transmits the result 155 of its sub-task to the radio receiver 152 of the shore-based station 148. SPEHD “5” transmits the result 156 of its sub-task to an aerial drone 157 that is close enough to be within range. That drone 157 stores the result 156 until it passes within range of a surface boat drone 158 after which it transmits the result 156 to that water-borne drone 158. The water-borne drone 158 stores the result 156 until it passes within range of another SPEHD, SPEHD “7” 159 at which time it transmits the result 156 to SPEHD “7” which immediately transmits it to a satellite 153 which forwards it 156 to the radio receiver 152 of the ground station 148. (SPEHD “5” 151 was unable to transmit the result 156 directly to satellite 153 as it lacked the needed transmitter. However, SPEHD “7” did possess a satellite transmitter and was therefore able to transmit the result 156 to the satellite 153.)

Radio receiver 152 transmits the sub-task results 155 and 156 to a computing node 148 of the ground station which then uses its own task specification (i.e., task 145) to guide its merging and/or processing of the sub-task results 155 and 156 so as to produce a final, comprehensive task result 157, which it transmits to task manager 136, via a network 149 (e.g., the Internet).

When task manager 136 executes 144 an update of its task lists and associated graphs 137, it moves 158 task “T” from the “executing” list to the “completed” list. At the same time it updates its SPEHD nodes to show that the computational resources used to complete the task are once again available to contribute to the execution of one or more new tasks.

Task manager 136/137 evaluates the task result 157 to determine the resources consumed, which might include, but are not limited to: the amount of energy (e.g., kWh) consumed during the execution of the task, the amount of data transmitted by satellite, and, the numbers, types, capabilities, etc., of the computational resources used onboard the SPEHDs involved in completing the task. Based on its determination and/or evaluation of the resources consumed, task manager 136 formulates a cost that will be charged to the customer 130 and sends it to a “billing” module 159. And, (perhaps after receiving payment from the customer) the task manager transmits via a network 134 (e.g., the Internet) the subset 160 of the task results that contain the data requested by the customer 130 (e.g., omitting resource consumption data) to the customer's computing node 131.

Although not shown, or discussed, the task processing process and infrastructure specified in FIGS. 6 and 7 include the systems, subsystems, modules, capabilities, functionalities, etc., that will be obvious to those skilled in the art. For example, in the event that an SPEHD fails to complete the execution of a subtask (e.g., because it runs out of available energy and must shut down some or all of the computational resources involved in its execution), a computing node at the ground station may notify the task manager, which may then either allocate the computational resources of one or more other SPEHDs to complete (perhaps cooperatively) the uncompleted subtask, or it may cancel the execution of the task entirely and move it back to the “pending tasks” list and attempt its re-execution at a later time.

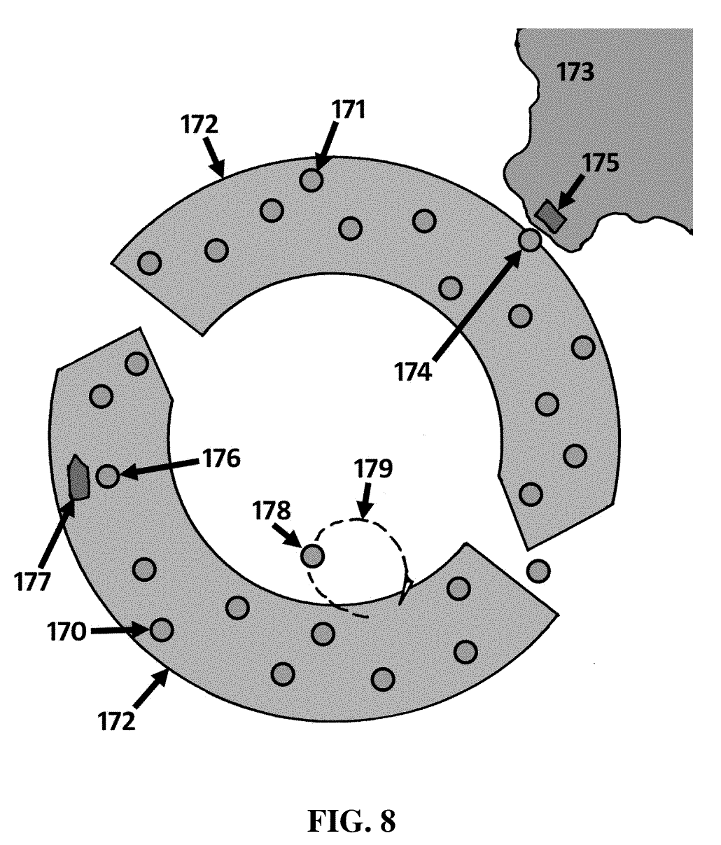

FIG. 8 shows a top-down view of an embodiment of the present disclosure which is similar to the embodiment illustrated and discussed with respect to FIGS. 4 and 5. A plurality of self-propelled energy harvesting devices (SPEHDs), e.g., 170 and 171, are traveling (i.e., orbiting) about a shared and/or common cyclical course 172 adjacent to the surface of a body of water and passing close to a portion of land 173. The orbital path followed by the embodiment's SPEHDs is conformal, and/or follows, one or more currents that, at least in aggregate, are, at least in part, of similar extent and direction.

This embodiment's SPEHDs use a portion of the energy that they extract from wind and waves in order to generate a chemical (e.g., hydrogen or sodium hydroxide) which each respective SPEHD stores within tanks incorporated within it (or some other part of its interior). SPEHD 174 has filled its chemical storage tanks and has used its self-propulsive capabilities to approach and position itself adjacent to an onshore offloading facility 175 to which it transfers at least a portion of its stored chemicals, after which it uses its self-propulsive capabilities to rejoin its fellow SPEHDs in orbit around the current-driven orbital path that they share, and about which they are dispersed.

Like SPEHD 174, SPEHD 176 has filled its chemical storage tanks to a point at which it, or a coordinating station, e.g., on land at facility 175, has decided to offload it on to a tanker ship 177, after which (even during which) it continues to generate chemicals using the energy that it harvests from the wind and/or waves passing through and/or over the orbital path 172.

An SPEHD 178 has deliberately used its self-propulsive capabilities to move out of the nominal orbital path 172 and execute a local circular path 179 so as to change its position along the orbital path 172, e.g., to “park it”, so as to facilitate an orderly offloading of SPEHDs by ship 177 or facility 175. In some embodiments similar to the one shown in this figure, facility 175 may be not located on land, but instead may be a floating facility, e.g. a self-propelled platform similar to an oil platform.

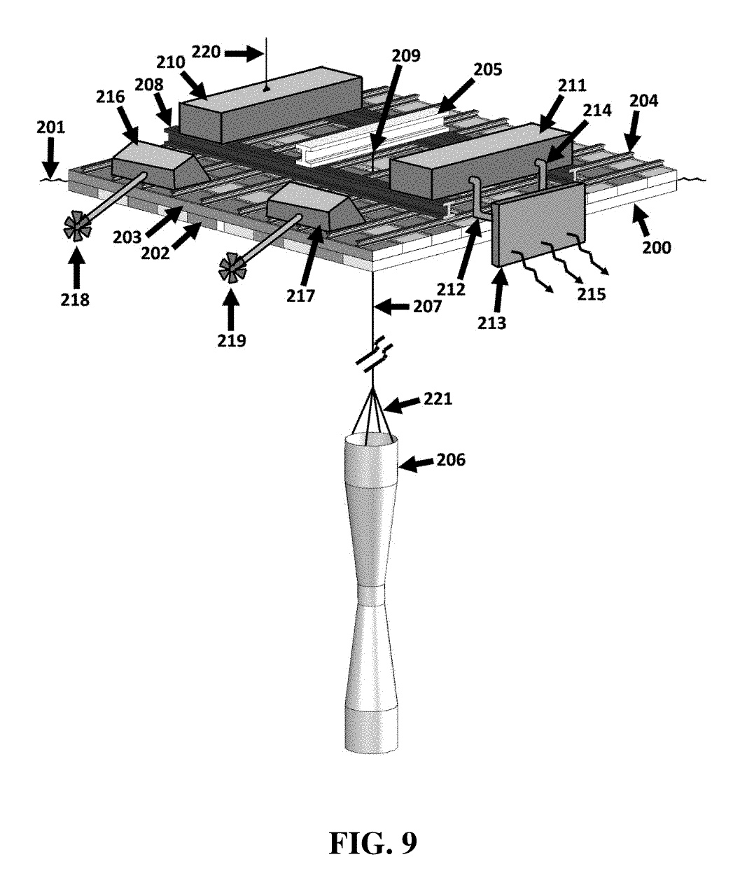

FIG. 9 shows a perspective view of one type of self-propelled energy harvesting device (an “SPEHD”) which an embodiment of the current disclosure might include. The illustrated SPEHD extracts energy from the heave of waves, and propels itself by means of a pair of electrically driven propellers. Through the application of differential thrusts, the two propellers allow the SPEHD to change its angular orientation and its speed.

A buoy 200, and/or buoyant platform, floats adjacent to the surface 201 of a body of water. The buoyant platform is composed, and/or comprised, of buoyant “slats,” e.g. 202 and 203. The slats, e.g. 203, of the upper layer are affixed to an underlying lower layer of slats, e.g. 202. The slats of the upper and lower layers are approximately orthogonal to one another.

Mounted on, and/or affixed to, an upper surface of the upper layer of slats, e.g. 203, are “load distribution struts,” e.g. 204. These approximately rigid struts help to distribute downward forces imparted to strut 205, e.g. by the flexible connector and/or cable which connects that strut to submerged Venturi tube 206, across the upper surface of the buoyant platform 203. They also help to collect and concentrate upward, e.g. buoyant, forces imparted to lower surfaces of the buoyant platform, e.g. 202, to facilitate their non-destructive transmission to strut 205, and to the cable 207 to which it is attached.

Additional orthogonal layers of struts overly the bottom layer of struts, e.g. 204. Fewer, but larger and stronger struts, e.g. 208, are affixed to the bottom layer of struts, e.g. 204. A single upper-most strut 205 is affixed to the intermediate layer of struts, e.g. 208. Downward forces imparted to strut 205, by cable 207 attached to strut 205 at 209, are distributed down and across the underlying layers of struts, on to, and through, the orthogonal layers of buoyant struts, e.g. 202 and 203. In this way, the broad, diffuse buoyant forces applied to the buoyant platform by the body of water on which it floats, can be focused so as to counter the downward force applied to strut 205 at connector 209.

A generator (not visible) located within the Venturi tube 206, generates electrical power in response to the up-and-down heave-driven vertical motions of the buoyant platform 200. The generated electrical power is communicated and/or transmitted to the buoyant platform through an electrical cable affixed to, and/or combined with, cable 207.

Mounted atop the intermediate layer of struts, e.g. 208, are two “computing chambers” 210 and 211. Inside these computing chambers are mounted, and/or affixed, computing circuits, computers, and/or computing nodes, and related electronic accessories (e.g. routers, switches, energy storage devices, etc.). Fluid based heat exchangers, e.g. 212, 213, 214, circulate water, and/or other heat absorbing fluids and/or gases, by means of pipes, e.g. 212 and 214, through each computing chamber carrying heat generated within each computing chamber, through the operation of at least some of the computing nodes therein, to a radiator 213 where at least a portion of that heat is transferred 215, communicated, radiated, and/or imparted, to the water 201 on which the embodiment floats, warming that water in the process.

Mounted atop the bottom-most layer of struts, e.g. 204, are two propeller-driven propulsion assemblies 216 and 217, units, and/or mechanisms. Using a portion of the electrical power generated by the generator in the Venturi tube 206, motors within propulsion assemblies 216 and 217, turn propellers 218 and 219. Through the controlled variation of, and/or the creation of a differential, thrust generated by propellers 218 and 219, the buoyant platform and the embodiment, may be propelled in any direction, and “driven” to a specific location (e.g. to specific geospatial coordinates) on the surface of the body of water.

SPEHD 200 is able to communicate with other SPEHDs, ground station radios, and/or satellites by means of a transmitter/receiver within computing chamber 210 and utilizing antenna 220.

Venturi tube 206 is connected to cable 207 by means of a plurality of cables 221.

Wave energy harvesting device 200 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating self-propelled wind and/or wave energy harvesting devices are included within the scope of the present disclosure.

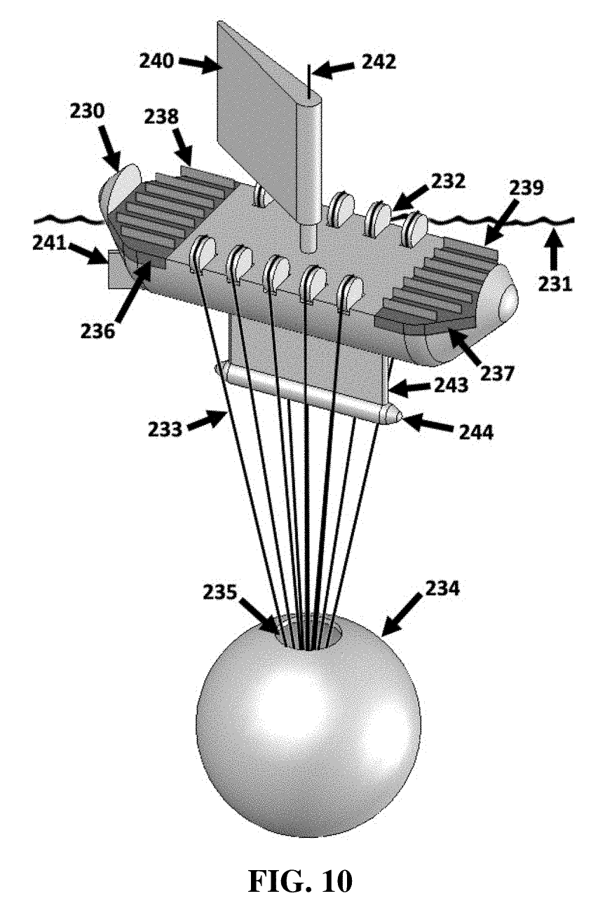

FIG. 10 shows a perspective view of one type of self-propelled energy harvesting device (an “SPEHD”) which an embodiment of the current disclosure might include. The illustrated SPEHD extracts energy from the heave of waves, and propels itself by means of a rigid sail. Through the control of the orientation of the sail and rudder, the SPEHD is able to adjust its angular orientation and its speed.

A buoy 230, flotation module, floating platform, vessel, raft, and/or buoyant object, floats adjacent to the surface 231 of a body of water. Attached to, mounted on, and/or incorporated within, the buoy 230 is a plurality of power take-offs (PTOs), e.g. 232, and/or electrical power-generation assemblies. PTO-specific cables, e.g. 233, chains, ropes, linkages, and/or flexible connectors, connect each respective PTO to the approximate center of a submerged inertial mass 234. The cables pass through a hole 235 and/or aperture in a top surface of the inertial mass 234. When the buoy moves up and down due to the heave action of waves, submerged inertial mass 234 resists this motion by a tension in PTO-specific cables e.g. 233, turning rotating wheels and/or gears of the PTOs e.g. 232, generating electricity by rotating generators attached thereto.

Mounted on and/or in, attached and/or affixed to, and/or incorporated within, the buoy 230 are two “computing chambers and/or modules” 236 and 237. These are sealed, waterproof chambers inside of which are mounted and/or affixed computing circuits, computing nodes, and/or computing resources, networks, energy storage and/or buffering devices, and/or other electronic components. The computing circuits within the two computing chambers and/or modules 236 and 237 are energized directly and/or indirectly by electrical power generated by the embodiment's PTOs in response to wave action. Thermally-conductive fins, e.g. 238 and 239, are affixed to top surfaces of the computing chambers 236 and 237. These fins expedite, promote, accelerate, and/or facilitate, the transfer of heat, generated by computers within the computing chambers, to the air above and/or around the embodiment.

The illustrated embodiment 230 contains and/or incorporates a keel 243, with a weighted end 244, that enhances and/or promotes the stability of the device. The energy harvesting device 230 also incorporates a rigid sail 240 that is able to impart thrust to the node when driven by wind. The amount of thrust being adjustable and/or able to be optimized through the rotation of the sail to an optimal angle with respect to the wind direction and the orientation of the keel 243. A rudder 241 allows the device's control system (e.g. one or more computers that control the behavior of the node) to steer the device when it is moved in response to wind passing over its rigid sail 240.

An antenna 242 mounted on, and/or affixed to, the top of the rigid sail 240 allows the device to send and receive electronic, and/or electromagnetic, transmissions, preferably encrypted. In some versions of the illustrated device, this antenna exchanges digital data with a satellite through which the device's computers can exchange data, programs, instructions, status information, and/or other digital values, with a remote computer and/or server. In some versions of the illustrated device, this antenna 242 exchanges digital data with other similar energy harvesting devices, e.g. allowing them to be joined and/or connected within a virtual computing network that includes and/or extends to at least a portion of the computers on the so-linked devices.

Wave energy harvesting device 230 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

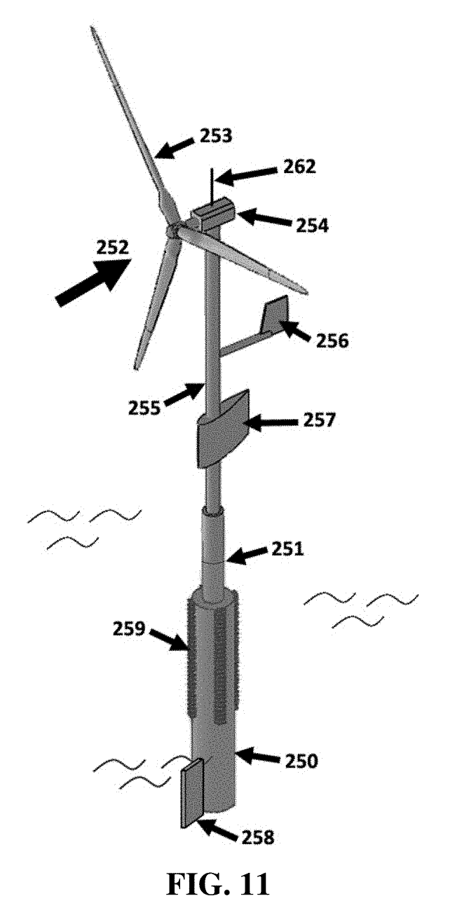

FIG. 11 shows a perspective view of one type of self-propelled energy harvesting device (an “SPEHD”) which an embodiment of the current disclosure might include. The illustrated SPEHD 250 extracts energy from the wind by means of a horizontal-axis wind turbine (HAWT) 253, and propels itself by means of the drag of the wind turbine combined with the wind-driven forces generated by a rigid sail 257. Through the control of the orientation of the sail and a rudder 258, the SPEHD is able to adjust its angular orientation and its speed.

A “spar buoy” 250 floats adjacent to the surface 251 of a body of water over which wind 252 passes. Wind 252 drives and turns the blades 253 of a wind turbine rotatably connected to a generator (not visible) within a nacelle 254. Nacelle 254 is fixedly attached to pole 255 which is able to rotate relative to spar buoy 250. Guide vane 256 causes pole 255 to rotate so as to keep the turbine “pointed into” the wind, i.e., to keep the rotational axis of the blades 253 parallel to the prevailing wind 252. The blades 253 may be feathered by rotating each blade about its longitudinal axis so as to change its angle of attack with respect to the direction of the wind 252.

Rigid sail 257 is rotatably connected to pole 255 and its angular orientation with respect to spar buoy 250 can be controlled independently of the angular orientation of pole 255 and turbine 253/254. A rudder 258 allows the course of the propelled SPEHD to be steered and/or directed angularly.

Submerged thermal conduction fins 259 about the outer wall of the spar buoy 250 permit heat generated by computational equipment mounted about the inside of the spar buoy 250 to be transferred into the ambient ocean water, thereby cooling that equipment passively.

An antenna 262 mounted atop the wind turbine nacelle 254 permits the computing devices within the spar buoy to 250 to exchange data with other energy harvesting devices, land-based stations, ships, planes, air and water drones, and satellites. Radio communications equipment within the spar buoy 250, that transmits and receives electromagnetic signals via antenna 262, downloads computational tasks and data from a remote source, executes those tasks on, with, and/or within, its computers, and uploads computational results to a, possibly the same, remote source.

Wave energy harvesting device 250 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

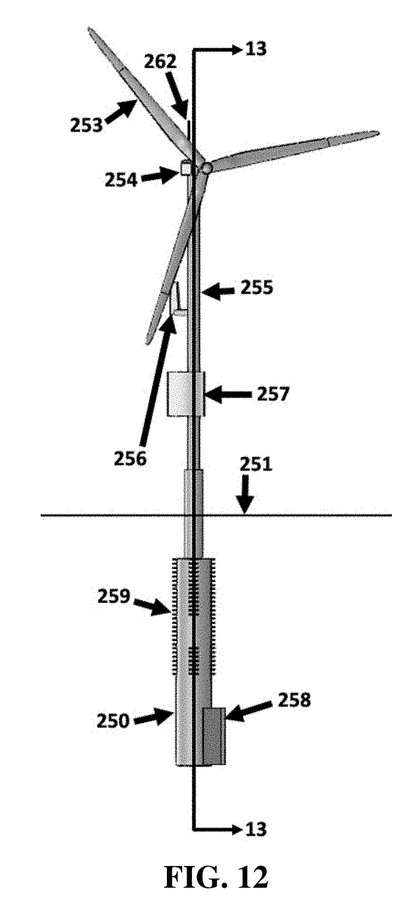

FIG. 12 shows a perspective side view of the same type of self-propelled energy harvesting device illustrated and discussed in relation to FIG. 11.

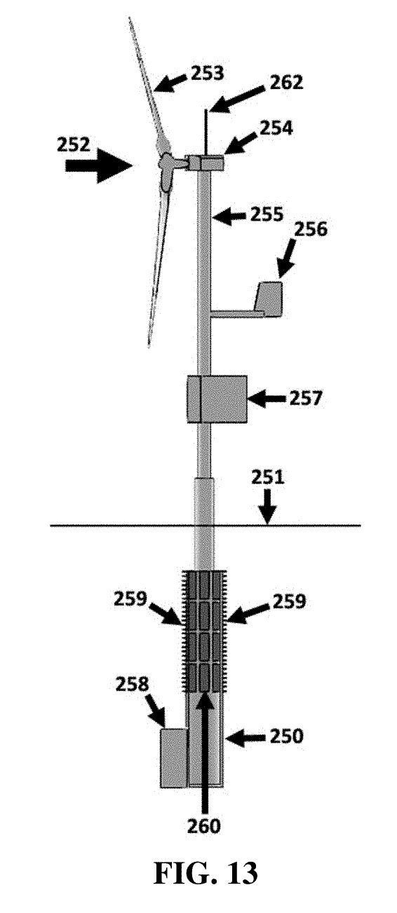

FIG. 13 shows a side sectional view of the same type of self-propelled energy harvesting device illustrated and discussed in relation to FIGS. 11 and 12, wherein the vertical section plane is specified in FIG. 12 and the section is taken across line 13-13. Computational modules, e.g., 260, may be seen inside, and mounted against the interior wall of the hollow spar buoy 250. Thermal cooling fins 259 help to dissipate heat generated by the computational circuits into the surrounding water 251, thereby passively cooling those circuits and avoiding the need to expend additional energy to achieve that cooling. The interior of spar buoy 250 is sealed and water is excluded. The computers within the spar buoy are surrounded by air. The air within the spar buoy's interior helps to transmit some of the heat generated by the electronic components therein to the walls of the spar buoy that are cooled by the water 251 outside the spar buoy.

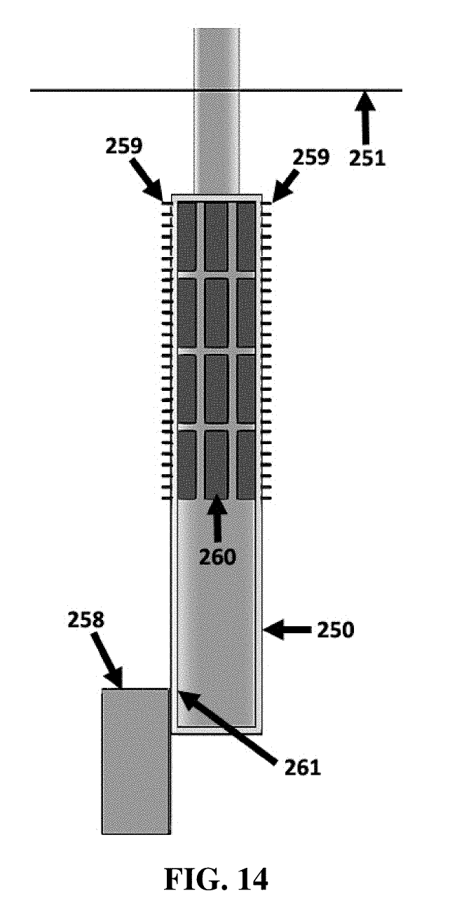

FIG. 14 shows a close-up of the same side sectional view illustrated and discussed in relation to FIG. 13. Computational modules, e.g., 260, may be seen inside, and mounted against the interior wall 261 of the hollow spar buoy 250. Thermal cooling fins 259 help to dissipate heat generated by the computational circuits into the surrounding water 251, thereby passively cooling those circuits and avoiding the need to expend additional energy to achieve that cooling.

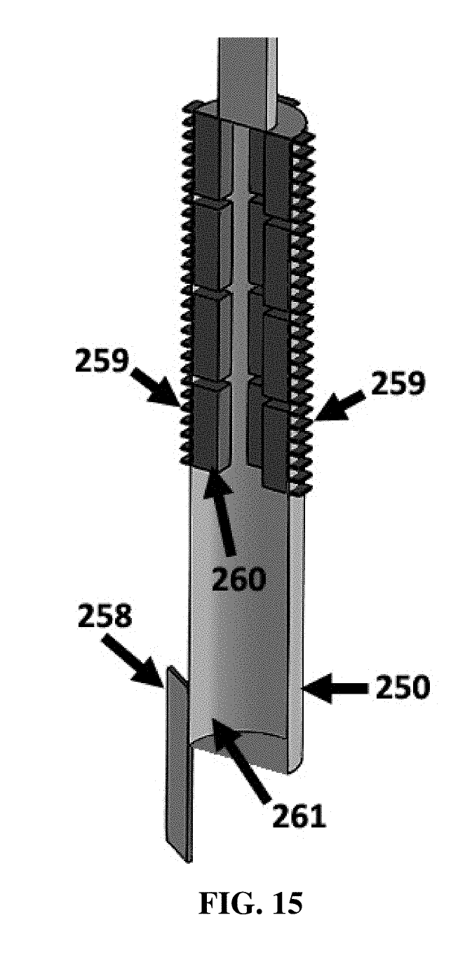

FIG. 15 shows a perspective side view of the same close-up sectional view illustrated and discussed in relation to FIG. 14.

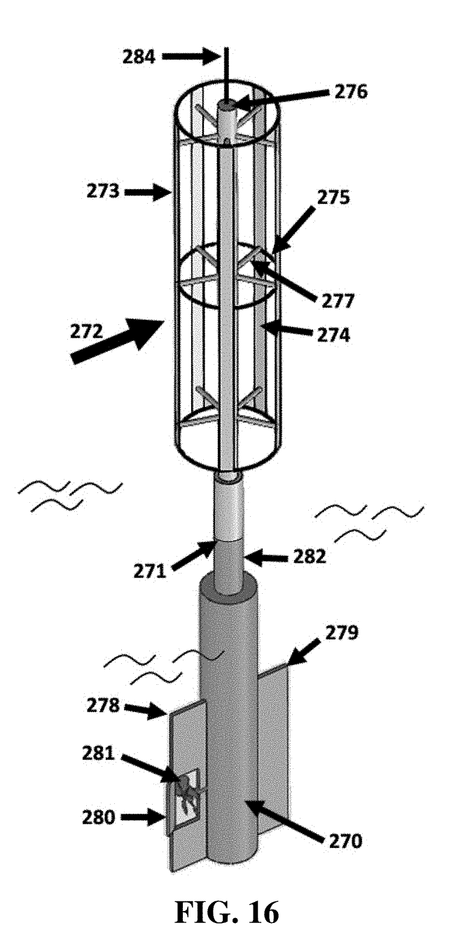

FIG. 16 shows a perspective view of a type of self-propelled energy harvesting device (an “SPEHD”) which an embodiment of the current disclosure might include. The illustrated SPEHD 270 extracts energy from the wind by means of a vertical-axis wind turbine (VAWT) 273, and propels itself by means of a propeller 281 driven by an electrical motor (inside the spar buoy). Through the control of the orientation of a rudder 280 and the rate at which the propeller rotates, the SPEHD is able to adjust and/or control its angular orientation and its speed, and thereby steer a course in a desired direction to arrive at a desired geospatial location.

A “spar buoy” 270 floats adjacent to the surface 271 of a body of water over which wind 272 passes. Wind 272 drives and turns a wind turbine 273 rotatably connected to a generator inside the spar buoy 270. The blades, e.g., 274, of the wind turbine are fixedly attached to rings, e.g., 275, that are fixedly attached to a central shaft 276 by spokes, e.g., 277.

A pair of opposing vanes 278 and 279 act as a keel and help to direct the forward motion of the device. Movably attached to one of the vanes 278 is a rudder 280 which helps to guide the angular orientation of the device when thrust is generated by the propeller 281, and/or by the drag created by the wind turbine 273 as it obstructs the wind 272.

The portion 282 of the spar buoy 270 in contact with the surface 271 of the water (i.e., where the buoy's waterline is found) is of a smaller diameter than the lower portion 270 of the buoy so that the responsivity of the buoy to heave wave motion is reduced.

Inside the hollow interior of the spar buoy 270 are a plurality of computing devices, memory devices, energy-storage and/or buffering devices, radio transceivers, and other electronic circuits. These electronic devices and circuits are energized by electrical power generated by the wind turbine 273 and its rotatably connected generator (not visible). At least a portion of the heat generated by those electronic circuits is dissipated to the water outside the spar buoy 270. An antenna 284 mounted atop of the wind turbine's shaft 276 (but which does not itself rotate with the wind turbine or its shaft) permits the device to exchange data, signals, and/or information, with other energy harvesting devices, with ships, planes, drones, shore-based stations, and with satellites. Computational tasks and data downloaded via antenna 284 are processed on the device's computers and the computational results are returned via the same antenna 284.

Wave energy harvesting device 270 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

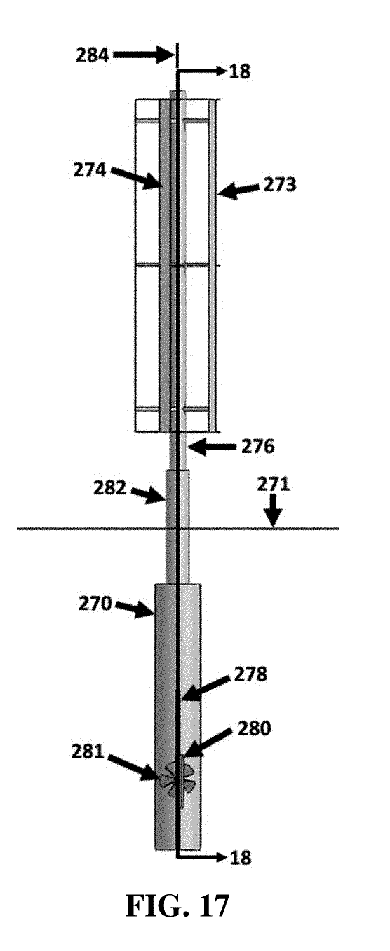

FIG. 17 shows a side view of the same type of self-propelled energy harvesting device illustrated and discussed in relation to FIG. 16.

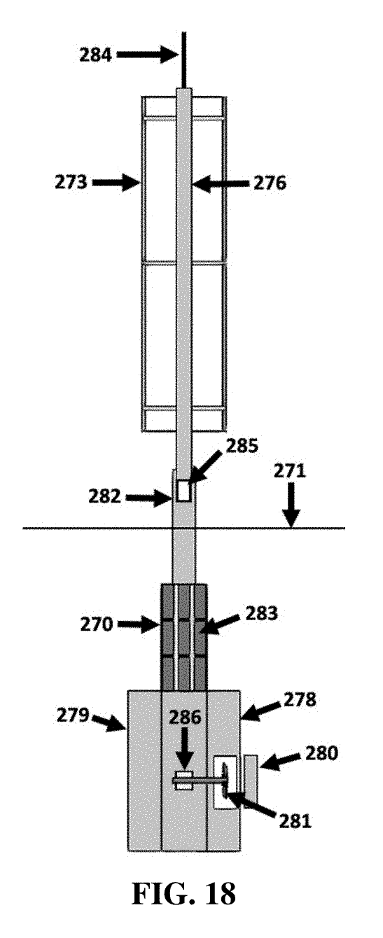

FIG. 18 shows a side sectional view of the same type of self-propelled energy harvesting device illustrated and discussed in relation to FIGS. 16 and 17, wherein the vertical section plane is specified in FIG. 17 and the section is taken across line 18-18.

Mounted against the interior wall of the hollow spar buoy 270 is a plurality of computational modules 283 and/or nodes. Heat generated by those computational modules 283 is conductively and passively transferred to the outside water 271, at least in part conductively through the walls of spar buoy 270.

Rotations of wind turbine 273 and its shaft 276 cause generator 285 to generate electrical power, at least a portion of which is used to energize the computers 283 within the spar buoy 270.

Motor 286 consumes a portion of the electrical power generated by generator 285, and turns propeller 281, thereby generating thrust that propels the device through the water 271. The rate of propeller rotation, if any, and the orientation of the rudder 280, are controlled by a device-specific control system located within the spar buoy 270 along with the computers therein.

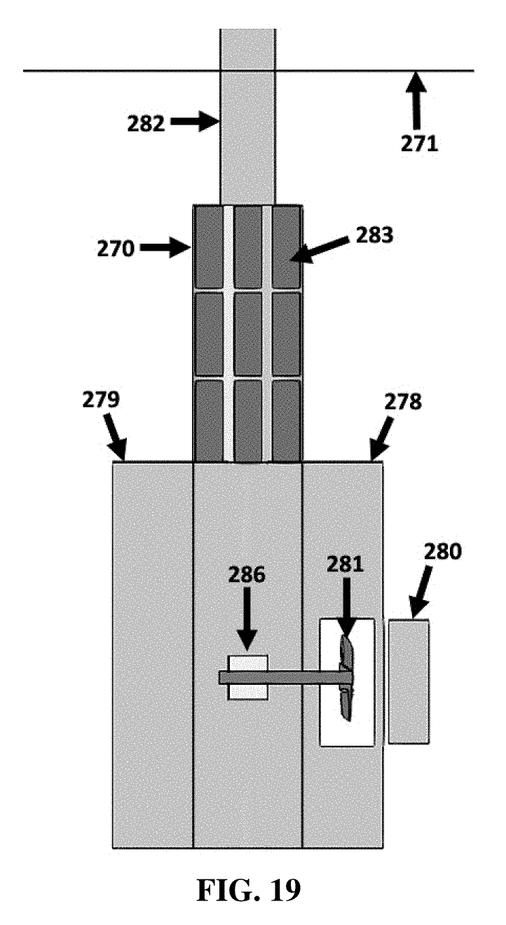

FIG. 19 shows a close-up of the same side sectional view illustrated and discussed in relation to FIG. 18.

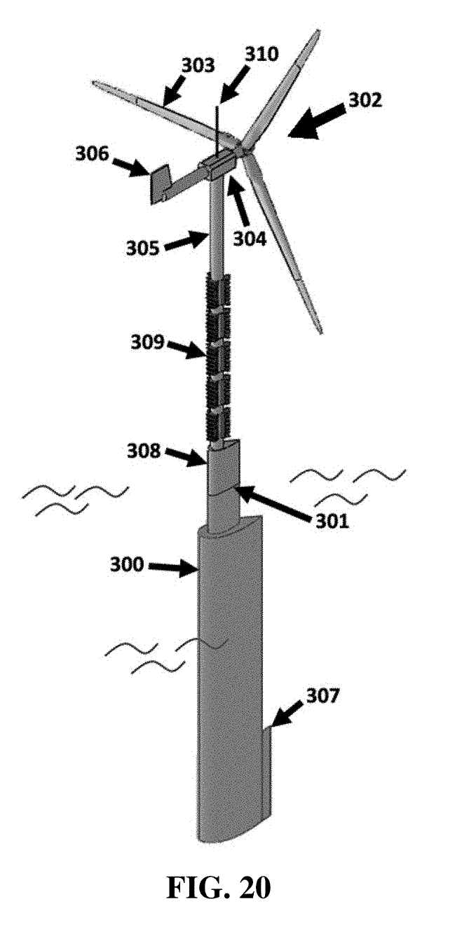

FIG. 20 shows a perspective view of a type of self-propelled energy harvesting device (an “SPEHD”) which an embodiment of the current disclosure might include. The illustrated SPEHD 300 extracts energy from the wind by means of a horizontal-axis wind turbine (HAWT) 303, and is propelled by the force of the wind impacting the blades of the wind turbine, and the resulting drag forces. Through the control of the orientation of a rudder 307, the SPEHD is able to adjust and/or control its angular orientation so as to move in a desired direction and/or to or toward a desired geospatial location.

Through the control and/or adjustment of the angles of the turbine's blades with respect to the wind 302, both the amount of energy extracted from the wind by the turbine, as well as the amount of drag-induced force imparted to it (and to the device), may be adjusted and/or controlled, which in turn also allows the device's speed to be controlled, to a degree.

A “spar buoy” 300 floats adjacent to the surface 301 of a body of water over which wind 302 passes. Wind 302 drives and turns a wind turbine 303 rotatably connected to a generator (not visible) positioned within the turbine's nacelle 304 which is fixedly attached to a pole 305. Pole 305 is turned by a motor and control system positioned inside the hollow interior of the spar buoy 300.

When not aligned with, and/or parallel to, the wind direction, guide vane 306 applies a torque to pole 305. Likewise, when not parallel to the direction to which the spar buoy (and the entire device) is traveling through the water, rudder 307 applies a torque to spar buoy 300.

By adjusting the angular orientations of both the turbine's rotational axis, through angular adjustments to the rotational position of the pole 305 to which it is attached, and the rudder 307, relative to the spar buoy 300, in combination with the drag-induced forces imparted to the turbine's blades by the wind, the magnitude of which may be controlled, at least in part, through adjustments of the “angles of attack” of the turbine's blades, and through adjustments to the angular orientation of the turbine to the wind, and the aerodynamic lift forces produced by the movement of the airfoil-shaped spar buoy 300 through the water, the direction and speed of the SPEHD can, to a degree, and within limits, be controlled.

The portion 308 of the spar buoy 300 that is in contact with the surface 301 of the water, and which crosses the surface 301 of the water (and about which is the device's waterline 301) is of a smaller cross-sectional area (with respect to the horizontal plane at the surface of the water 301) than the lower portion of the spar buoy 300 so that the responsivity of the buoy to heave wave motion is reduced.

Heat-dissipating vanes 309 mounted to the turbine pole 305 are used to convectively dissipate heat generated by computational circuits positioned within the hollow interior of that pole. An antenna 310 mounted atop the wind turbine's nacelle 304 allows a transceiver within the pole 305 to send and receive data, exchanging data with remote antennas connected to, and/or attached to remote objects, including, but not limited to: computers, servers, energy harvesting devices, ships, planes, satellites, air and water drones, balloon-suspended transceivers, and other objects. The data received by the device includes, but is not limited to: computational tasks and data to be executed by the computers within the device, navigational directions, forecasts of environmental conditions (including, but not limited to, wave height, wind speed, current speeds and directions, etc.), hazards observed by other SPEHDs, ships, planes, etc. (including, but not limited to, floating debris, ships, ice bergs, etc.). The data transmitted by the device, includes, but is not limited to: computational results, device geospatial position, heading, speed, observed environmental conditions ((including, but not limited to, wave height, wind speed, current speeds and directions, etc.), observed hazards (including, but not limited to, floating debris, ships, ice bergs, etc.).

Wave energy harvesting device 300 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

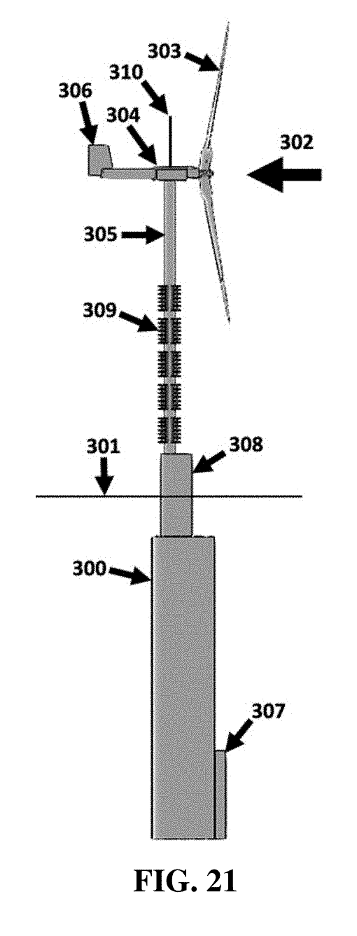

FIG. 21 shows a side view of the same type of self-propelled energy harvesting device illustrated and discussed in relation to FIG. 20.

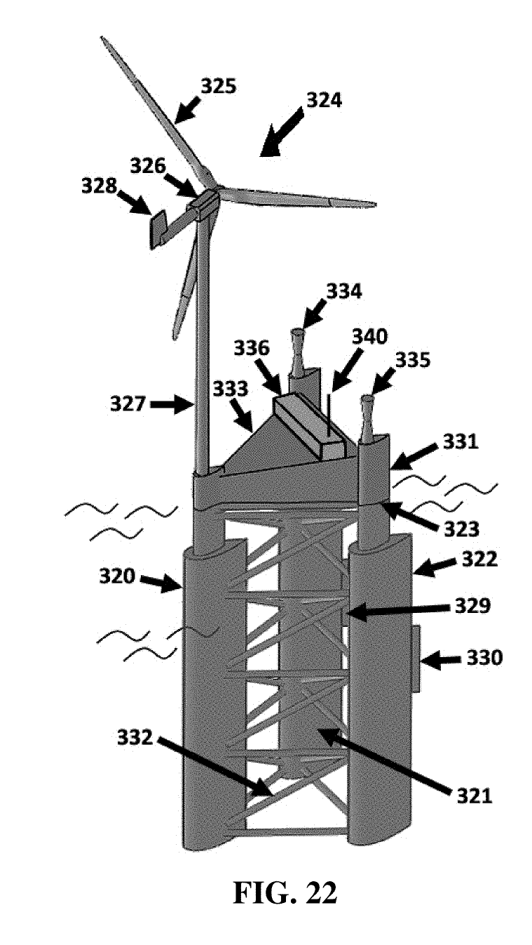

FIG. 22 shows a perspective view of a type of self-propelled energy harvesting device (an “SPEHD”) which an embodiment of the current disclosure might include. The illustrated SPEHD 320 extracts energy from the wind by means of a horizontal-axis wind turbine (HAWT) 325 rotatably mounted to one of three airfoil-shaped spar buoys 320-322, and is propelled by the force of the wind impacting the blades of the wind turbine. Through the control of the orientation of a pair of rudders 329 and 330, the SPEHD is able to adjust and/or control its angular orientation and therefore its heading, course, and/or direction of movement. Through the control of the angles of the turbine's blades about their respective longitudinal axes, both the amount of energy extracted from the wind by the turbine, as well as the amount of drag-induced force imparted to it (and to the device), may be adjusted and/or controlled, which in turn also allows the device's speed to be controlled, to a degree.

Three “spar buoys” 320-322 float adjacent to the surface 323 of a body of water over which wind 324 passes. Wind 324 drives and turns a wind turbine 325 rotatably connected to a generator inside the turbine's nacelle 326. The turbine's nacelle 326 is rotatably connected to a pole 327 about which it can rotate. However, its rotation is limited to a relatively small angular range (e.g., +/−30 degrees) and/or angular deviation outside the vertical plane passing through the center of pole 327 and equally centered between spar buoys 321 and 322, i.e., the plane about which the device has the greatest bilateral symmetry. This causes the wind-induced drag forces on the turbine to pull the device forward allowing the device's airfoil-shaped spar buoys to have minimal drag and the rudders 329 and 330 to be able to steer the device.

The portion, e.g., 331, of each spar buoy, e.g., 322, that is in contact with the surface 323 of the water and/or that crosses the surface 323 of the water (about which is the device's waterline 323) is of a smaller cross-sectional area (with respect to the horizontal plane at the surface of the water 323) than the lower portion of each spar buoy, e.g., 322, so that the responsivity of each spar buoy to heave wave motion is reduced.

The three spar buoys 320-322 are rigidly connected together by a truss structure, e.g., 332.

Between the upper portions, e.g., 331, of the three spar buoys 320-322 is an air-filled shroud 333 that extends beneath the level of the water 323, and creates an “oscillating water column” (OWC) within. Venturi-shaped nozzles 334 and 335 amplify the speed of the air exiting and entering the OWC in response to the changes in water height created by heave wave motion. Turbines positioned in the narrowest portion (i.e., the throats) of nozzles 334 and 335 extract energy from the air flowing through them causing rotatably connected generators (not visible) to produce electrical power, a portion of which is used to energize computational circuits, hardware, electronics, systems, and/or modules, positioned within a computer enclosure 336 attached to an upper surface of the OWC shroud 333. Heat generated by the computational circuits within module 336 is dissipated conductively through the walls of the enclosure 336 and thereafter convectively into the air outside the enclosure.

Inside computer enclosure 336 is also a radio transmitter and receiver (i.e., a transceiver) that transmits and receives encoded electromagnetic signals via antenna 340. Among the data received by device 320 are computational tasks and associated data which the device executes using energy provided by the device's wind and wave energy harvesting systems. Among the data transmitted by device 320 are the results of completed computational tasks.

Wave energy harvesting device 320 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

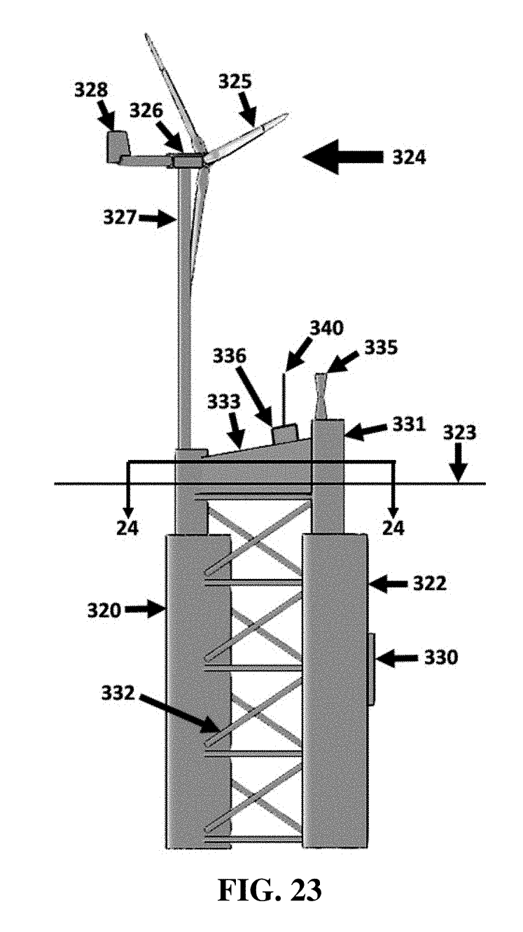

FIG. 23 shows a side view of the same type of self-propelled energy harvesting device illustrated and discussed in relation to FIG. 22.

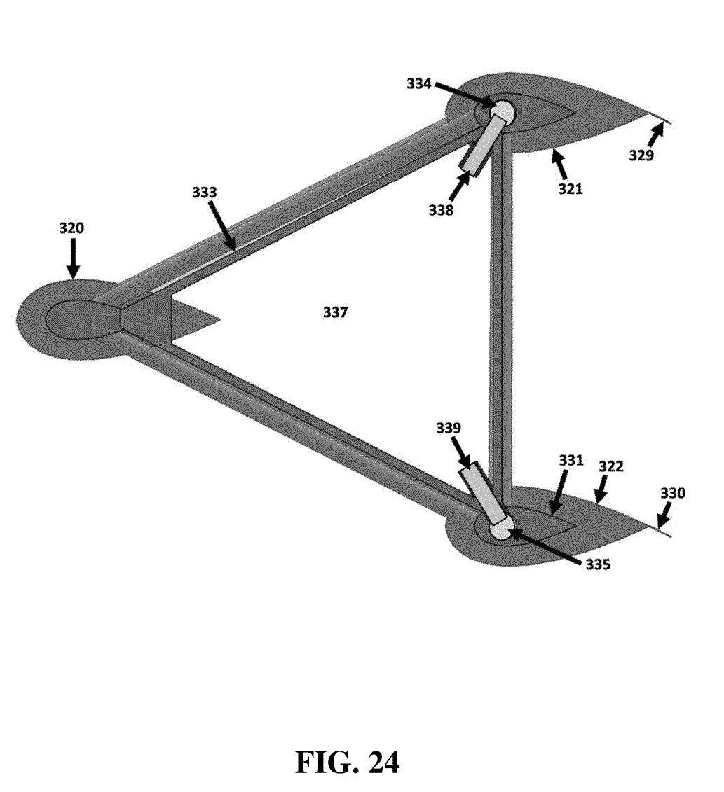

FIG. 24 shows a top-down sectional view of the same type of self-propelled energy harvesting device (an “SPEHD”) illustrated and discussed in relation to FIGS. 22 and 23, wherein the horizontal section plane is specified in FIG. 23 and the section is taken across line 24-24.

OWC shroud 333 is a hollow 337 air-filled chamber in which the rising and falling of waves outside the shroud, alternately compress and depressurize the air inside the chamber 337 causing at least a portion of that air to flow through tubes 338 and 339 into the connected Venturi-shaped nozzles (i.e., 334 and 335 in FIG. 22) where they drive turbines positioned inside the nozzle throats (positioned above the section plane and outside the section view).

Rudders 329 and 330 help to steer the SPEHD when drag-induced forces are imparted to the wind turbine by the wind obstructed by it, thereby pulling the node forward in the water.

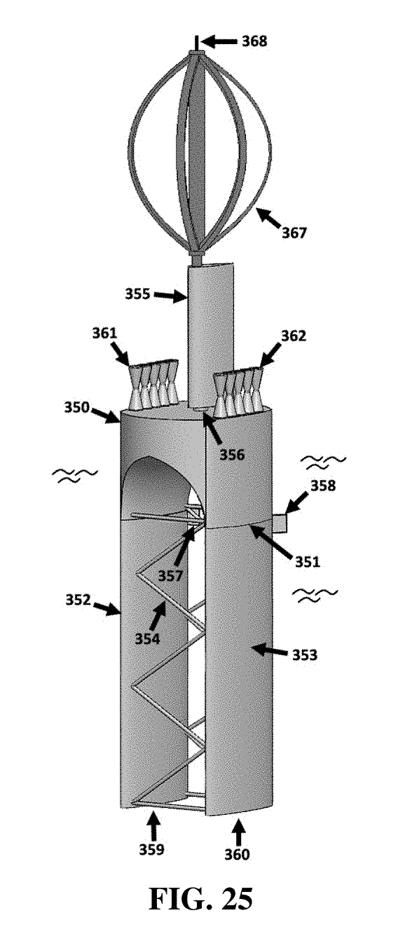

FIG. 25 shows a perspective view of a type of self-propelled energy harvesting device (an “SPEHD”) which an embodiment of the current disclosure might include. The illustrated SPEHD 350 extracts energy from the heave of waves by means of two arrays 361 and 362 of oscillating water columns (OWCs) embedded within opposing and parallel airfoil shaped keels 352 and 353. A rigid sail 355 rotatably connected to the top of the device provides wind-driven propulsion, and a rudder 357 and 358 moveably connected to each keel 352 and 353, respectively, permits the device to be steered. Rotating about a shaft passing through the hollow shaft 356 to which the rigid sail 355 is attached, is a wind turbine 367 that is rotatably connected to a generator (not visible) positioned within the rigid sail.

SPEHD 350 floats adjacent to the surface 351 of a body of water over which waves pass. Opposing pairs of airfoil-shaped keels 352 and 353 support a platform 350 at an upper portion of the device and typically positioned above the water line 351. The keels are supported by a crossing assemblage of truss struts, e.g., 354.

A rigid sail 355 is attached to a shaft 356 which is rotated by a mechanism within the upper portion 350 of the device. Rudders 357 and 358 allow the thrust imparted to the device by the rigid sail to be controlled and used to direct the motion of the device to desired angular orientations and/or toward or to specific geospatial coordinates.

Within each keel 352 and 353 are five OWC tubes whose lower mouths open to the sea at the bottoms 359 and 360 of their respective keels 352 and 353. And, the respective upper mouths 361 and 362 of which are constricted forming Venturi nozzles in the throats of which are turbines and rotatably-connected generators.

As a wave approaches, the pressure that would raise the level of water in each OWC tube increases. However, due to the significant length of each tube, and the significant volume of water in each, the increase in the force pushing the water in each tube upwards results in only a slow acceleration of that water. However, just as the inertia of the water in the OWC tubes delays its rising, by the time the wave has passed, and the device has begun to descend in concert with the falling water level outside the device, the inertia of the water in the tube now delays the reversal of the water's rise, and the water continues rising, albeit while decelerating, after the wave passes and the device descends. The continued rise of the level of the water in the OWC tubes, coupled with the descent of the nozzles through which the compressed air must exit the tubes, causes the air at the top of each tube to be highly compressed, and causes the flow of compressed air out of each Venturi nozzle, and through each nozzle turbine, to be relatively fast.

Each OWC tube behaves in a manner, and by physics, similar to those that characterize “water hammers” and “hydraulic rams.”

One-way valves (e.g., check valves) allow air to freely enter each OWC when the pressure in each tube falls to become less than the pressure of the atmospheric air outside each respective tube. However, when the pressure of the air in each OWC tube exceeds that of the outside atmospheric pressure, then the pressurized air is forced to exit through a respective Venturi nozzle and an intra-throat turbine, thereby generating electrical power in the process.

A portion of the electrical power generated by the generators energized by the turbines inside the OWC Venturi nozzles is used to energize and/or power computational circuits positioned within an enclosed computer chamber in the upper portion 350 of the device. An antenna 368 attached to the top of the wind turbine 367 allows the computers within the device to exchange data with suitably-equipped remote computers, networks, stations, and/or electronic devices. The device is able to download from a remote computer, network, station, and/or electronic device, computational tasks and data and execute those tasks on its computers, thereafter returning the computational results to a, possible same, remote computer, network, station, and/or electronic device.

Wave and wind energy harvesting device 350 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

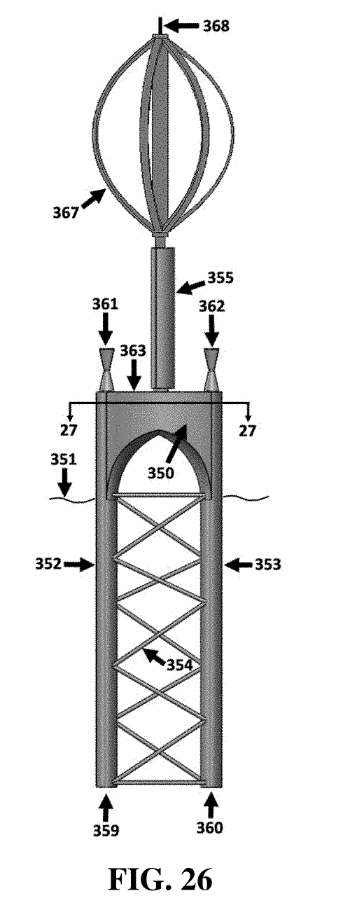

FIG. 26 shows a front view of the same type of self-propelled energy harvesting device (an “SPEHD”) illustrated and discussed in relation to FIG. 25. Rigid sail 355 is rotatably connected to an upper surface 363 of the SPEHD. Computational nodes are positioned within the upper portion 350 of the node and are powered, at least in part, by electrical power generated by the turbines positioned within the throats of the Venturi nozzles, e.g., 361 and 362, atop the OWC tubes.

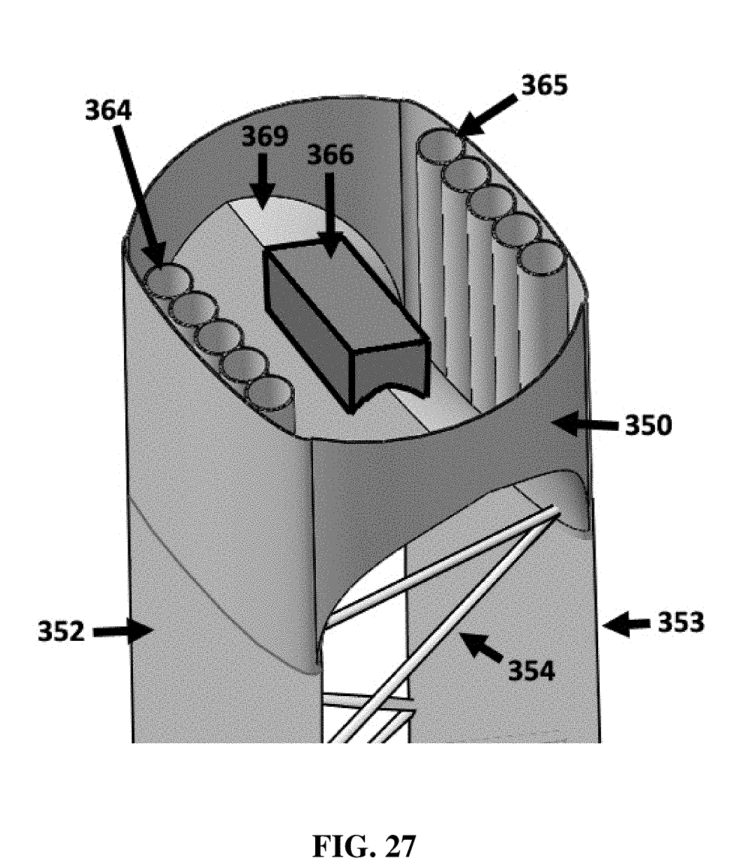

FIG. 27 shows a top-down sectional view of the same type of self-propelled energy harvesting device (an “SPEHD”) illustrated and discussed in relation to FIGS. 25 and 26, wherein the horizontal section plane is specified in FIG. 26 and the section is taken across line 27-27.

Each keel 352 and 353 contains five OWC tubes, e.g., 364 and 365, upper ends of which are constricted (above and outside of the sectional view) so as to form Venturi nozzles.

Inside the upper portion 350 of the device is an enclosed computer chamber 366 containing, potentially among other items, computational equipment, memory devices, a radio transceiver, and an energy-storage and/or buffering device. The enclosed computer chamber 366 is conductively cooled through the lower wall 369 of the interior of the upper portion 350 of the device.

In an embodiment similar to the one illustrated and discussed in relation to FIGS. 25-27, the enclosed computer chamber 366 generates a chemical (e.g., hydrogen) and stores at least a portion of the generated chemical inside tanks also within the hollow upper portion 350 of the device.

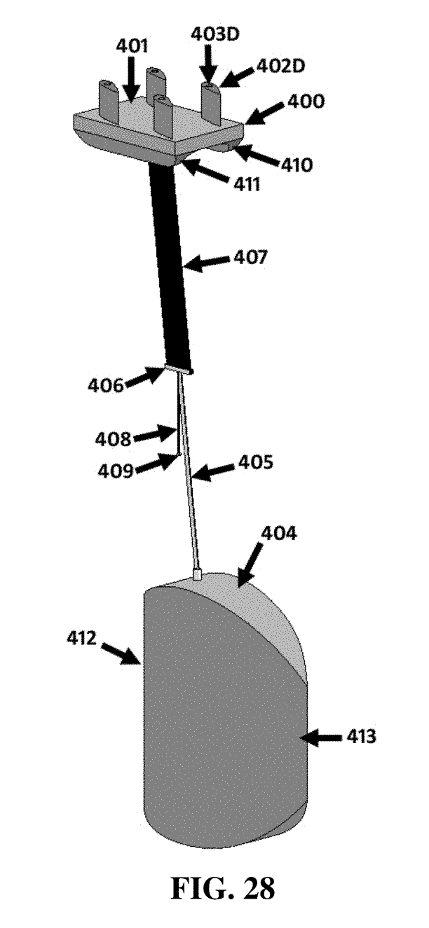

FIG. 28 shows a side perspective view of a type of self-propelled energy harvesting device (an “SPEHD”) which an embodiment of the current disclosure might include. A buoyant flotation structure, or buoy, 400-401 incorporates, includes, and/or possesses, four rigid sails, e.g., 402D, each of which rotates about a shaft, e.g., 403D.

The buoy 400 is connected to a submerged inertial mass 404 by a cable 405, a ribbon junction bar 406, and a pair of adjacent ribbon cables 407. Each ribbon cable passes over and around an array of direction rectifying pulleys (not visible). The alignment of each array of direction rectifying pulleys is facilitated, promoted, and/or coerced, through the pulling of a “direction rectifying pulley array” (DRPA) cable 408, to the end of which is attached a weight 409.

The bottom of buoy 400 is contoured so as to create opposing parallel hulls 410 and 411 that serve as keels to promote the steering of the device under the influence of the rigid sails.

The submerged inertial mass 404 has an airfoil shape, with a relatively blunt leading edge 412 and a relatively narrow trailing edge 413.

In a similar embodiment, at least one of the embodiment's energy harvesting devices is equipped with a single rigid sail. In another similar embodiment, at least one of the embodiment's energy harvesting devices is equipped with two and three rigid sails each. The scope of the present disclosure includes embodiments, in which the embodiment's energy harvesting devices has any number of rigid sails. It also includes embodiment's comprised, at least in part, of devices with any other manner of self-propulsion, including, but not limited to: ducted fans, propellers, parachute sails, etc.

In a similar embodiment, at least one of the embodiment's energy harvesting devices incorporates an inertial mass that is a water-filled vessel or enclosure. In another embodiment, at least one of the embodiment's energy harvesting devices incorporates an inertial mass that is rigid and comprised of one or more materials with an average density that is negative.

Wave energy harvesting device 400 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

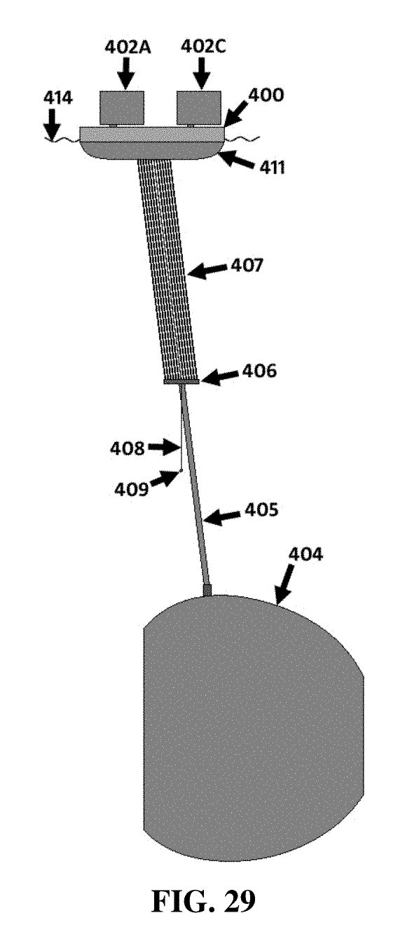

FIG. 29 shows a side view of the same type of self-propelled energy harvesting device illustrated in FIG. 28. The buoy 400 floats adjacent to a surface 414 of a body of water over which waves travel and winds blow.

Rotatably connected to an upper surface of buoy 400 are four rigid sails, two 402A and 402C of which are visible in the illustration.

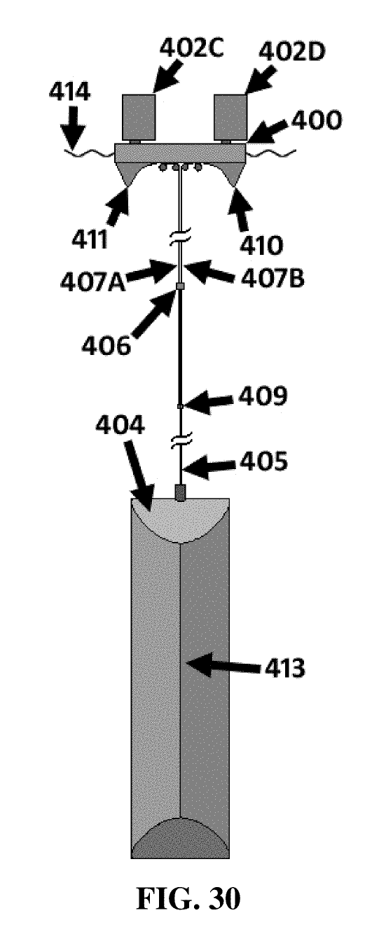

FIG. 30 shows a back view of the same type of self-propelled energy harvesting device (an “SPEHD”) illustrated in FIGS. 28 and 29. The buoy 400 floats adjacent to a surface 414 of a body of water over which waves travel. Two rigid sails 402C and 402D are rotatably connected to an upper surface or portion of the buoy 400. Left and right downward-projecting hulls 411 and 410 serve as keels. An upper end of left and right parallel and adjacent ribbon cables 407A and 407B are rotatably connected to the buoy 400 (connected around, by, and/or to pulleys), while a lower end of each ribbon cable is attached to a common ribbon junction bar 406. The ribbon junction bar 406 is also connected to a submerged inertial mass 404 via a shared cable 405. The shape of the inertial mass is that of a vertically-oriented airfoil and/or wing with the most tapered, and/or back, portion 413 of the airfoil at the back of the inertial mass such that forward motion of the embodiment is facilitated.

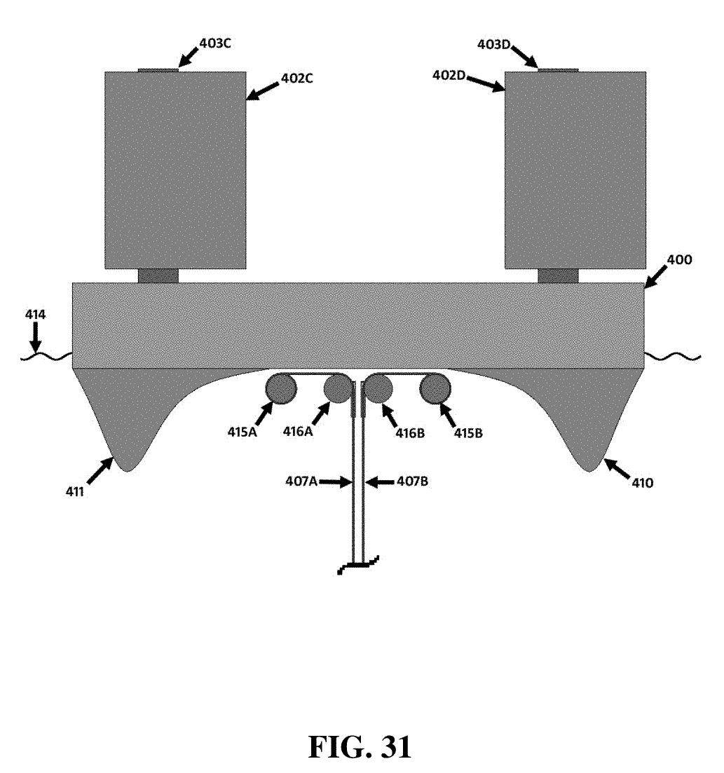

FIG. 31 shows an expanded view of the buoy portion of the same back view of the self-propelled energy harvesting device (an “SPEHD”) illustrated in FIGS. 28-30. The buoy 400 floats adjacent to a surface 414 of a body of water over which waves travel. Two rigid sails 402C and 402D are rotatably connected to an upper surface or portion of the buoy 400 by means of their respective shafts 403C and 403D about which they rotate. Left and right downward-projecting hulls 411 and 410 serve as keels.

An upper end each of left and right parallel and adjacent ribbon cables 407A and 407B are attached to spirally-grooved roller pulleys 415A and 415B respectively. After winding about the groove(s) of respective roller pulleys, 415A and 415B, each strand of each ribbon cable 407A and 407B passes on to, over, and around, a respective direction rectifying pulley within a respective array 416A and 416B of such direction rectifying pulleys after which it descends, and is attached to, a shared ribbon junction bar (not visible).

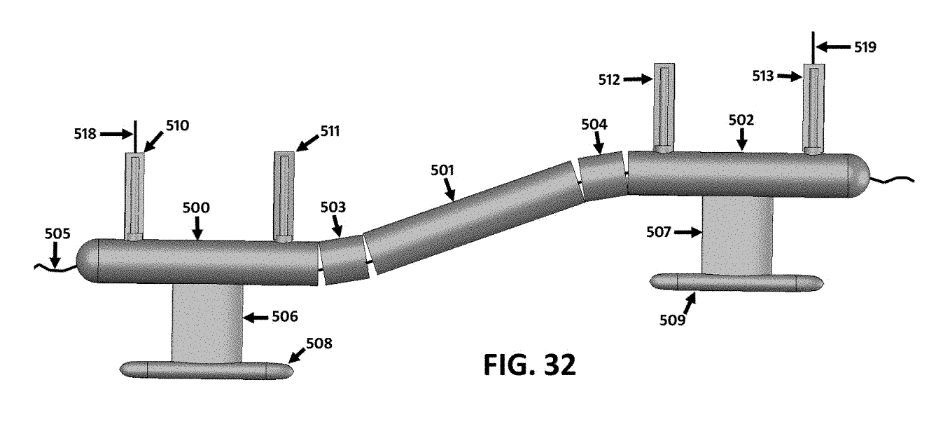

FIG. 32 shows a perspective view of a type of self-propelled energy harvesting device (an “SPEHD”) of which an embodiment of the current disclosure might be, at least in part, comprised.

The illustrated SPEHD is comprised of hinged tubular sections 500-504, three 500-502 of which are relatively long and contain computational equipment and circuits, and two 503-504 of which contain power take-offs that utilize and/or incorporate hydraulic rams that convert the flexing between the adjacent tubular sections into a pressurized hydraulic fluid, which then flows through at least one hydraulic generator (not visible), thereby generating electrical power. End segments 500 and 502 incorporate keels 506 and 507, respectively, each of which is connected to respective weights 508 and 509.

The computational equipment and circuits, and energy storage and/or buffering devices, are enclosed within each relatively long tube segment 500-502. The computers, energy storage devices, and other electronic circuits, inside each long tube segment 500-502 are energized by, and/or consume, at least a portion of the electrical power generated by the hydraulic power takeoffs within each relatively short tube segment 503-504, and by the flexing of the joints between the long and short tube segments. Attached to the top of rigid vertical panels (sails) 510 and 513 are respective antennas 518 and 519 which allow the computers within the device 500 to exchange data with remote and/or outside computers, networks, stations, and/or antennas, e.g., with data exchanged via satellites.

Atop the two end segments 500 and 502 are rigid vertical panels 510-513 that are rotatably connected to their respective tubular segments 500 and 502. By varying the angles of the panels with respect to the direction of the prevailing wind, lateral and forward thrusts may be applied to each respective segment. The application of dissimilar thrust vectors to each end segment allows the entire to move forward as well as to execute turns.

This wave energy harvesting device is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

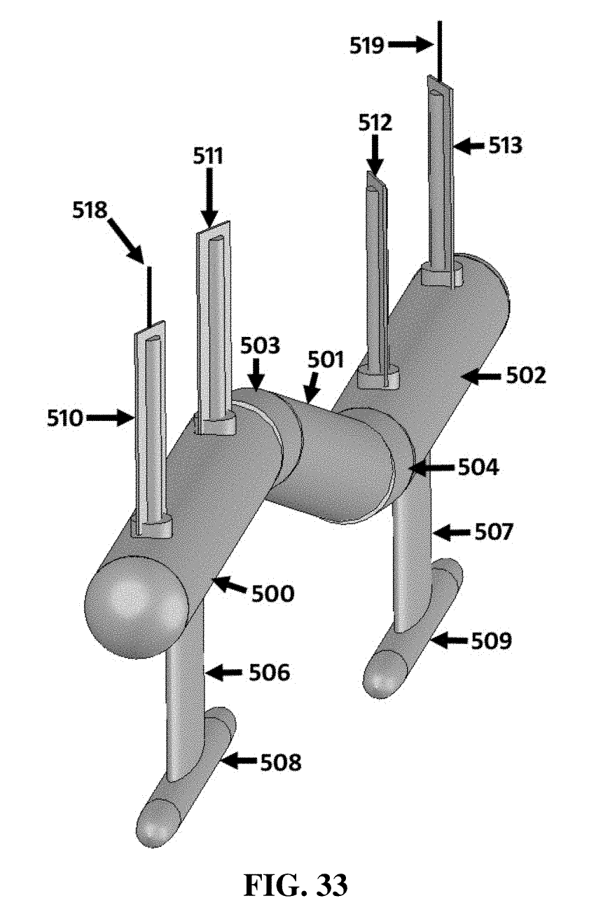

FIG. 33 shows a front perspective view of the same type of self-propelled energy harvesting device illustrated in FIG. 32.

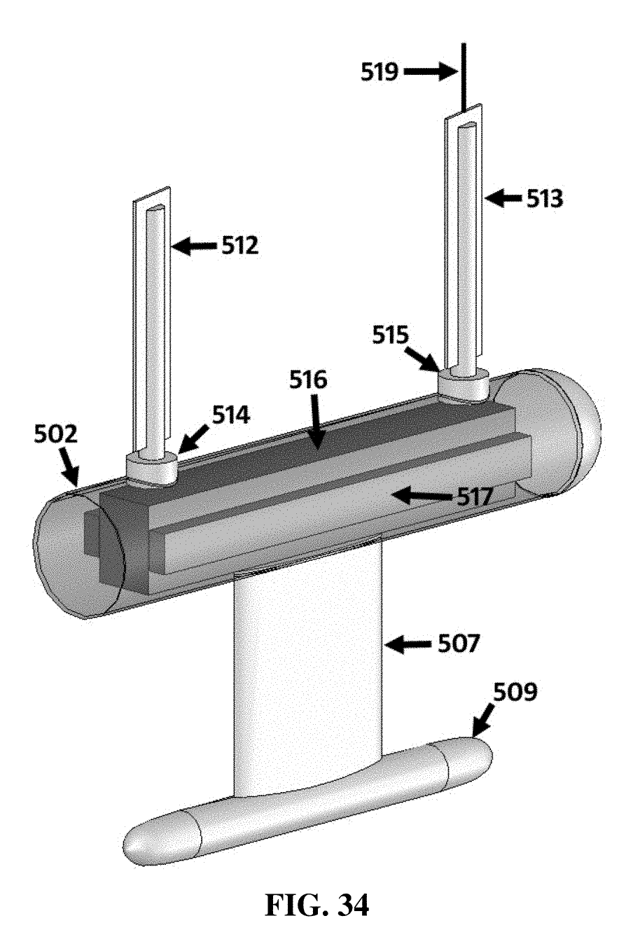

FIG. 34 shows a side perspective view of one of the long tubular sections 502 characterizing the same type of self-propelled energy harvesting device illustrated in FIGS. 32 and 33. The outer cylindrical wall of the tubular section is semi-transparent to reveal the components positioned inside of the tube.

Tubular section 502 contains energy-storage modules, e.g. 517, units, and/or assemblies, as well as arrays, e.g. 516, racks, and/or assemblies, of computing nodes, computing circuits, computers, and/or computational equipment and/or resources.

At least a portion of the electrical power generated in response to wave action on the device is stored in energy-storage modules, e.g. 517, units, and/or assemblies, positioned within the tubular section 502 and which may include, but is not limited to: batteries, capacitors, and/or chemical fuel (e.g. hydrogen) generators and storage mechanisms.

The arrays 516, racks, and/or assemblies, of computing nodes, computing circuits, computers, and/or computational equipment and/or resources mounted and/or positioned within tubular section 502 are energized, at least in part, by at least a portion of the electrical power generated by the PTOs in the shorter tubular sections (503 and 504 in FIGS. 32 and 33).

In some embodiments, the space within the tubular section 502 in which the computers are affixed and operate is filled with air with respect to at least some of the devices of which the embodiments are comprised. In other embodiments, the space is filled with a heat-conductive fluid, and/or a phase-change material with respect to at least some of the devices of which the embodiments are comprised. The heat transferred from the computers, as they consume electrical power, to the air or liquid surrounding them, is thereafter transferred to the thermally-conductive walls, and/or a portion thereof, which transfers it to the water on which the device floats. This process of heat transfer efficiently, convectively, and passively, cools the computers.

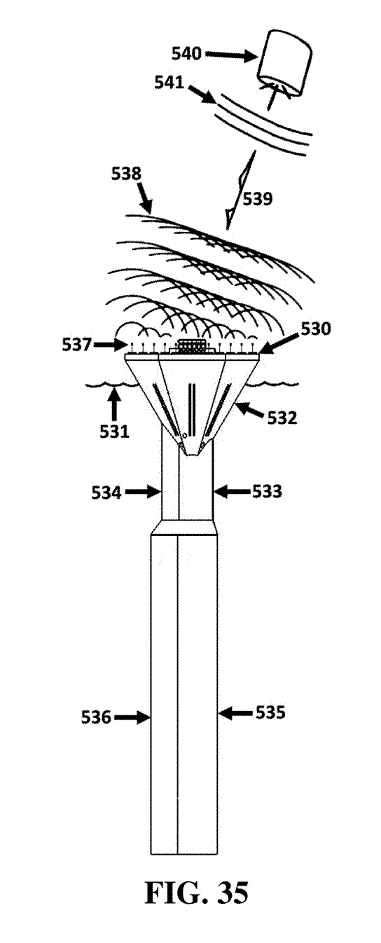

FIG. 35 shows a side view of a type of self-propelled energy harvesting device (an “SPEHD”) which an embodiment of the current disclosure might include.

The buoyant device 530 floats adjacent to an upper surface 531 of a body of water over which waves tend to pass. An upper portion 532 of the device constitutes a buoy and displaces water at the surface 531 of the body of water (as well as below the surface). Integrated within, and depending from, the buoy 532 is a tubular structure 533 through and/or in which water flows up and down approximately along a longitudinal axis of the tube 533. Extending from a “back” side of the tube is an angular extension 534 and/or appendage which has the effect of imparting to the tubular structure 533/534 an approximately airfoil shape with respect to movements in a “forward” direction (e.g., to the right in the illustration).

At a distance below the buoy 532, a secondary wall 535/536 is added to, and surrounds, the inner wall of tubular structure 533/534 which extends within and/or through that outer secondary wall 535/536. In the gap or hollow between the inner and outer walls of tube 535/536 are struts and stringers which create a truss within the annular void giving added strength to the lower portion 535/536 of the tube. Also within the gap between the inner and outer walls of tube 535/536 is buoyant material having a density that is less than the density of the water in which the embodiment floats.

Attached and/or connected to an upper surface 530 of the device are a plurality of antennas 537, e.g., driven dipole antennas, comprising a “phased array antenna,” from which phase-adjusted electromagnetic waves 538 and/or signals may be transmitted. Through an appropriate selection of relative phases of the signals emanating from each antenna within the phased array, the direction 539 of the beam 538 may be controlled, changed, and/or adjusted, so as to direct the beam to a receiver, e.g., satellite 540. Through an appropriate selection of relative phases of the signals received through each antenna within the phased array, the direction 539 of a beam 541 received, e.g., from satellite 540, may be limited, confined, controlled, changed, and/or adjusted, so as to substantially eliminate all transmissions except those emanating from a targeted transmitter, e.g., satellite 540.

Within the device 530, are computers and other computational devices and supporting devices (not visible) that allow the device to receive from a remote source, e.g., from a satellite 540, computational tasks and data which it then processes with a portion of its onboard computing resources, and a portion of the results of which it subsequently transmits to a remote source, e.g., to a satellite 540. The embodiment energizes at least a portion of its computers and other computational devices and supporting devices with at least a portion of the electrical power that it generates in response to wave action.

Wave energy harvesting device 530 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

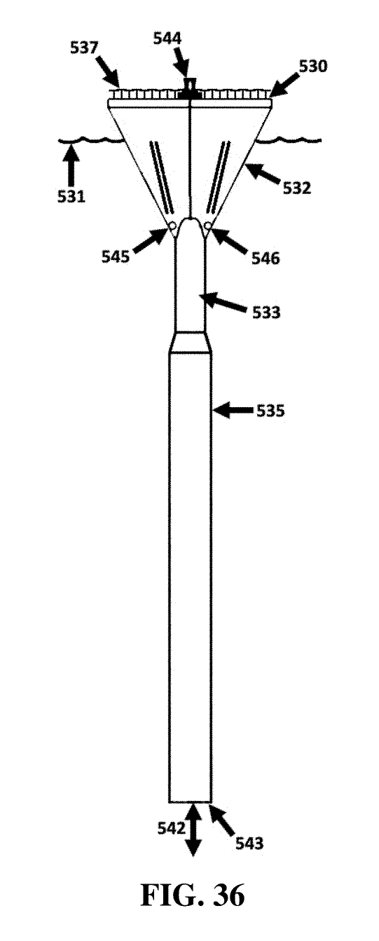

FIG. 36 shows a front view of the same device illustrated in FIG. 35 which an embodiment of the current disclosure might include.

As the device 530 moves up and down in response to passing waves, water within the tube 533 is caused to rise and fall, typically out of phase with the vertical motions of the waves and the embodiment. Water 542 moves in and out of the open bottom 543 of the tube.

An array 544 of constricted tubes, i.e., ducted exhaust channels, are present on, and embedded within, the upper wall of the buoy 530. Through these exhaust channels, air within the tube, and pressurized by the out-of-phase collision of the downward moving device, and the upward moving water within the tube 533, is vented to the atmosphere outside the device through respective turbines positioned within the exhaust channels, which energize operationally connected generators thereby generating electrical power.

Within a bottom portion of the buoy 530 are two forward/backward horizontal thrusters 545 and 546 positioned within cylindrical cavities characterized by approximately horizontal longitudinal axes. When the thrusters spin their respective propellers in one direction they generate thrust that drives the device in a forward direction (out of the page toward the reader). When the thrusters spin their respective propellers in the opposite direction they generate thrust that drives the device in a backward direction (into the page). Through the generation of thrusts of differing magnitudes and/or directions the device is able to generate a torque about its vertical longitudinal axis and rotate about that vertical axis. And, through the generation of approximately equal thrusts in an appropriate direction the device is able to move forward (i.e., out of the page and toward the reader).

The leading edges of the upper 533 and lower 535 portions of the submerged tube are approximately elliptical in horizontal cross-section and smooth, permitting the device to move forward with minimal drag.

Phased array 537 is seen from a perspective normal to the perspective of FIG. 35. Each dipole antenna, e.g., 537, in the array extends laterally from an approximately central vertical post or strut.

A portion of the electrical power generated by the device in response to wave action is used to power computers for the purposes of processing computational tasks received by satellite (or another transmission source), energizing the thrusters 545 and 546, energizing the transmitter(s) and receiver(s) through which data, processing tasks, signals, instructions, etc. are received from remote transmitters, and through which data, computational results, status updates, etc., are transmitted to remote receivers.

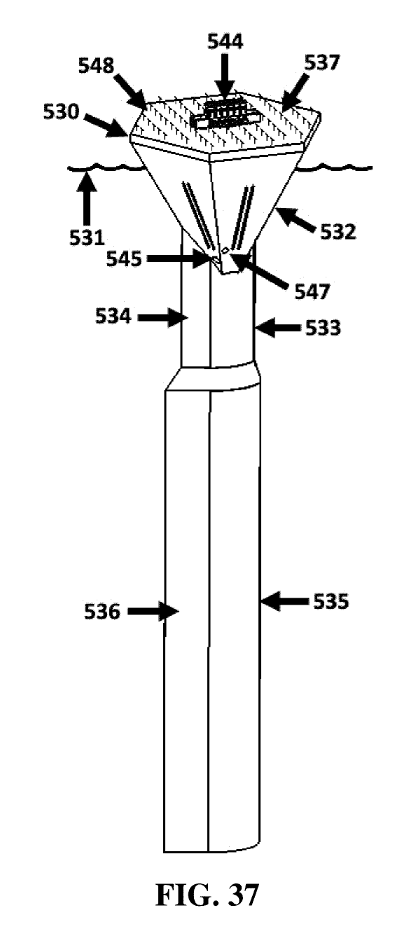

FIG. 37 shows a side perspective view of the same device illustrated in FIGS. 35 and 36 which an embodiment of the current disclosure might include.

An array 544 of constricted tubes, i.e., ducted exhaust channels, are present on, and embedded within, the upper wall of the buoy 530. Through these exhaust channels, air within the tube, and pressurized by the out-of-phase collision of the downward moving embodiment, and the upward moving water within the tube 533/534, is vented to the atmosphere outside the embodiment through respective turbines positioned within the exhaust channels, which energize operationally connected generators thereby generating electrical power.

In addition to the two forward/backward horizontal thrusters, e.g., 545, illustrated and discussed in relation to FIGS. 35 and 36, the device also has a side-to-side horizontal thruster 547 that generates thrust along an axis approximately normal to the axes of the thrust generated by thrusters 545 and 546 (see FIG. 36).

Attached to an upper deck 548 of the buoy of the embodiment 530 are rows of antennas, e.g., 537, that form a phased array antenna in which signals driving each individual antenna, e.g., 537, are adjusted by phase so as to direct the resulting beam. Similarly, the phase of the signals received by each antenna are adjusted so as to narrow or constrict the direction from which signals may be received.

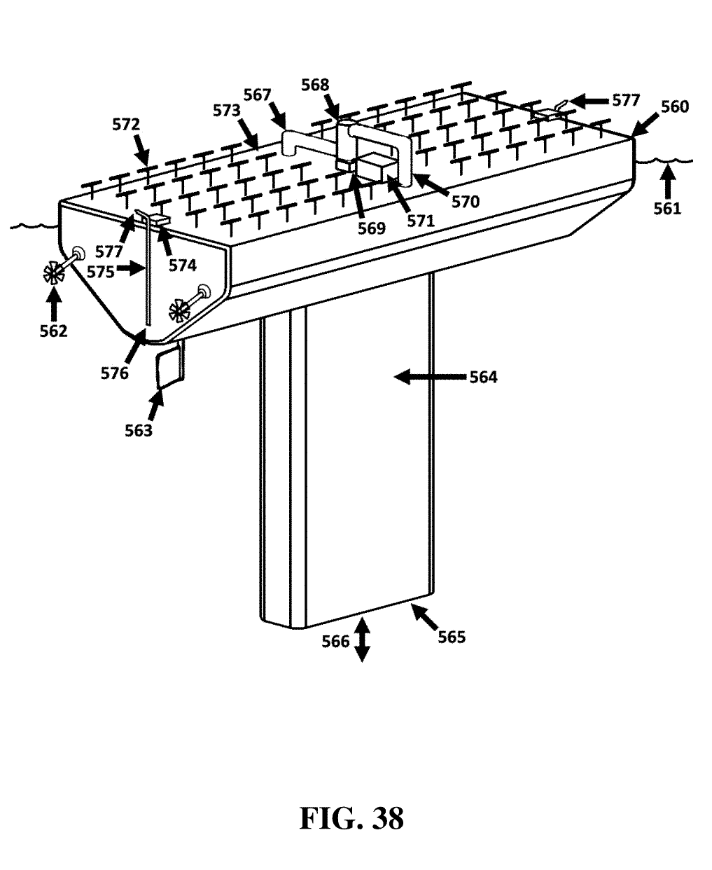

FIG. 38 shows a side perspective view of a type of self-propelled energy harvesting device (an “SPEHD”) which an embodiment of the current disclosure might include.

A buoyant structure 560, buoy, float, barge, boat, ship, and/or buoyant platform, floats adjacent to an upper surface 561 of a body of water. The buoy 560 has a “v-shaped” hull, a pair of propellers, e.g., 562, and a rudder 563, facilitating the self-propelled movement of the embodiment through the water 561 (e.g., in directions approximately opposite the propeller-generated thrust).

An open-bottomed water tube 564 is incorporated within the embodiment 560 near the center of buoy 560 (with respect to a horizontal plane and cross-section) and has a vertical longitudinal axis that is approximately coaxial with a vertical longitudinal axis of the device. Because the bottom 565 of the water tube 564 is open to the water below, water 566 tends to move into, and out of, the water tube. As water oscillates vertically and/or longitudinally within the water tube 564, especially in response to wave motion, a pocket of air (not visible) trapped near the top of the water tube is cyclically compressed and decompressed.

When the air pocket is compressed, a one-way valve (not visible) allows a portion of the compressed air to flow into a high-pressure accumulator (not visible) within the buoy 560 after which it flows through a tube 567 into a tubular channel 568 within which a turbine (not visible) extracts energy from the flowing air and causes a generator 569 to generate electrical power. After passing through the turbine within the tubular channel 568, the air flows through a tube 570 into a low-pressure accumulator (not visible) within the buoy 560.

When the air pocket is decompressed, a one-way valve (not visible) allows a portion of the depressurized air within the low-pressure accumulator to flow into the air pocket. After which the air pocket will again be compressed and pressurized, and air will again be forced into the high-pressure accumulator. And the cycle will repeat, with the air within the embodiment tending to cyclically move from the air pocket, through the turbine, and back to the air pocket again and again . . . .

A portion of the electrical power generated by the device in response to wave action is used to power, and/or is consumed by, one or more computers, computational circuits, and/or electronic circuits, housed within a chamber 571, compartment, enclosure, housing, module, and/or case. Heat generated by the one or more circuits within chamber 571 is passively and/or conductively dissipated to the air outside the device through a wall of the chamber 571.

Computational tasks and data are received by the device from a remote antenna and/or broadcast (e.g., via satellite transmission). The incident electromagnetic transmissions are received by means of a phased array of antennas, e.g., 572, positioned on, attached and/or connected to, an upper deck 573, and/or surface, of the embodiment 560. A portion of the results of completed and/or processed computational tasks and/or data are transmitted by the device 560 to a remote antenna (e.g., to a satellite) by means of the same phased array of antennas, e.g., 572.

A portion of the electrical power generated by the device in response to wave action is used to power, and/or is consumed by, a pair of pumps, e.g., 574, that pump water through a pair of respective tubes, e.g., 575. The pumps, e.g., 574, draw water into each pump's respective tube, e.g., 575, through an opening, e.g., 576, at the bottom of each tube from the body of water 561 on which the embodiment floats. The water within each tube, e.g., 575, is then sprayed out of a nozzle 577 at an upper end of each tube, e.g., 575. The resulting aerosolized water may rise into the atmosphere and promote cloud formation, thereby tending to reflect incident sunlight back into space, and potentially reducing the temperature of the Earth in the process.

Wave energy harvesting device 560 is an arbitrary example of the kind of free-floating, self-propelled, energy harvesting device of which an embodiment of the present disclosure may be comprised. It in no way limits the types of energy harvesting devices that are included within the scope of the present disclosure. And, all types of free-floating wind and/or wave energy harvesting devices are included within the scope of the present disclosure.

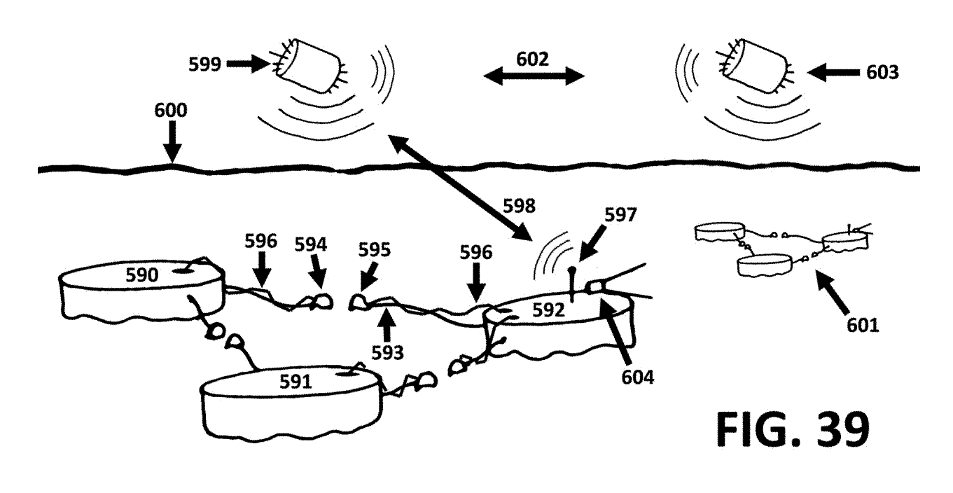

FIG. 39 shows a perspective view of a type of self-propelled energy harvesting device (an “SPEHD”) which an embodiment of the current disclosure might include.

Each device, e.g., 590, is flexibly coupled to two other devices, e.g., 591 and 592, but is otherwise free-floating (at the surface 600 of a body of water) and self-propelled, thereby comprising a self-propelled triad of devices.

Each device is both physically tethered, e.g., 593, and directly (e.g., by electrical power and/or network data cables) or indirectly (e.g., by radio, Wi-Fi, modulated light, etc.) interconnected, to every other device in the triad. The devices are physically interconnected by means of “elastic” mooring connectors and/or cables, e.g., in which a weight is suspended by and between a pair of floats, e.g., 594 and 595. Each suspended weight creating a restoring force pulling together its respective floats when they are separated. In other words, the separation of a weight's connected floats generates, and the weight stores, gravitational potential energy that both resists the separation of the floats (and the connected devices), and tends to pull the separated floats back together when the separating force wanes and/or dissipates.

Devices 590 and 592, as well as devices 591 and 592, are interconnected electrically and/or are able to share data, by means of electrical cables, e.g. 596, that are connected to, and/or supported by, their respective mooring cables. (Note that the electrical cables in the illustrated triad configuration follow and/or are attached to the mooring tethers, e.g., 593, and a portion of each cable is therefore submerged so as to follow the mooring tether down to, and back from, the submerged weight suspended between each pair of adjacent mooring floats, e.g., between 594 and 595.)

These electrical cables, e.g., 596, comprise, create, and/or constitute, an electrical grid within and/or across the farm. In various embodiments, these electrical cables include, but are not limited to: fiber-optic cables, LAN cables, Ethernet cables, and electrical power cables. Devices that share, and/or are interconnected with respect to, electrical power are able to share and/or distribute electrical power generated by their respective generators in response to wave action. Such electrically interconnected devices are also able to share electrical energy stored within batteries, capacitors, springs, components, features, circuits, devices, processes, and/or chemical fuel (e.g. hydrogen) generators and storage mechanisms.

At least some of the devices, e.g., 592, contain and/or incorporate computing devices, computing circuits, computers, and/or computational resources, that enable them to execute programs, e.g. arbitrary programs provided by a remote source and/or server, sometimes executed relative to specific bodies and/or collections of data.

Because of their interconnection by electrical and/or data-transmission cables, the devices 590-592 may operate within a shared computing network, and therefore and/or thereby may share data, parallelize programs, shard parameter ranges, etc.

At least some of the devices, e.g., 592, has an antenna 597, and uses it to exchange data 598 via radio transmissions with a satellite 599 and/or with other relatively nearby devices, e.g., with triad 601 drifting about the same embodiment-specific course, pathway, and/or orbit, and/or drifting within the same currents within the body of water 600, the same wind patterns and/or wave patterns. Satellites that exchange data with a device, e.g., 592, and/or with an interconnected triad, e.g., 590-592, may also exchange 602 at least portions of the same data with other satellites, e.g., 601, and/or with ships, planes, drones, shore-based stations, etc. Devices, e.g., 592, may also exchange data directly with ships, planes, drones, shore-based stations, etc.

Such triads of coupled and/or interconnected devices permit those devices to pool and/or share their electrical power. And it allows them to link their respective computing systems in a direct, hard-wired local-area network (LAN) and/or other data-sharing network. It also allows them to interconnect their respective energy storage devices, thereby providing more robust energy buffering. Such interconnected devices can share specialized equipment rather than duplicating it and the associated capital cost. For example, the triad of 590-592 shares a single antenna 597, and may share other electronic systems as well.

Triad 590-592 incorporates a camera 604 the field of view of which includes, at least to an approximate degree, the surface of the water 600 in the direction toward which the triad drifts. When a potential obstruction is identified within the camera's field of view, the device 592 transmits, e.g., via satellite 599, to the embodiment's command and control system (e.g., at a shore-based station), a message that includes, but is not limited to, the time of the sighting, the angular displacement of the obstruction with respect to the direction in which the triad is drifting and/or with respect to the longitudinal axis of the respective embodiment's orbital course (which, when combined with additional sightings from other embodiment devices will allow the geospatial location of the obstruction to be estimated and/or calculated), and its approximate direction and rate of travel.

Each device 590-592 of the triad illustrated in FIG. 39 harvests energy from the waves, contains computing devices, and executes computational tasks transmitted to it from remote sources, e.g., via satellite 599. With respect to a similar triad, of which an embodiment of the current disclosure might be, at least in part, comprised, only one device, e.g., 592, contains computing devices and executes computational tasks transmitted to it from remote sources, and only two devices, e.g., 590 and 591, harvest energy from passing waves.

Wave energy harvesting triad 590-592 is an arbitrary example of the kind of free-floating, self-propelled, energy harvesting and computational device configuration of which an embodiment of the present disclosure may be comprised. The example illustrated in FIG. 39 in no way limits, with respect to the scope of the present disclosure, the types of energy harvesting devices that are included within such tethered and/or interconnected groups of devices, the degree or manner of specialization within such groups of devices, the number of devices within, and/or the size of, such groups of devices, the manner and/or applications with which such groups of devices consume at least a portion of the electrical energy that they produce and/or harvest.

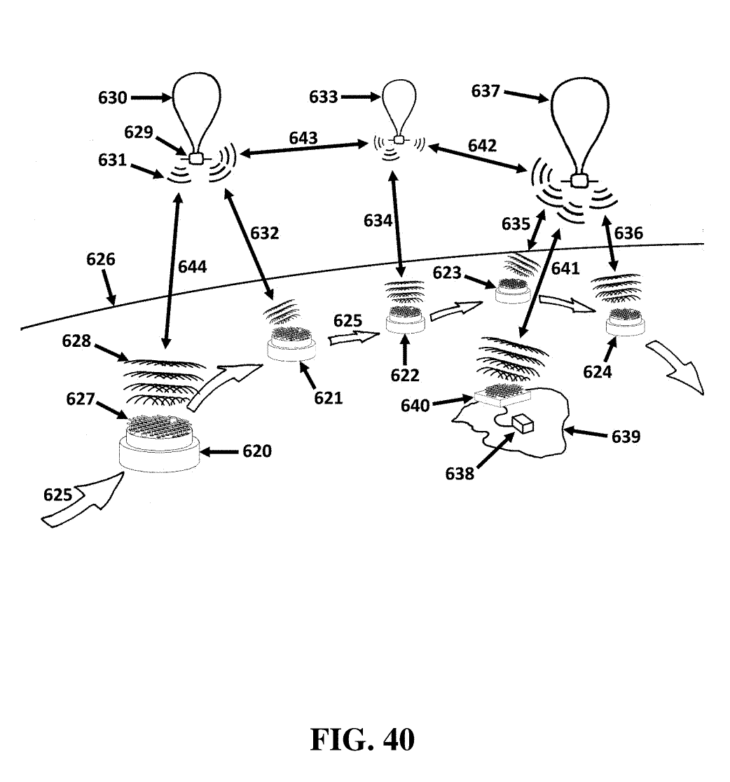

FIG. 40 shows a perspective view of an embodiment of the current disclosure.

An embodiment's plurality of wave energy harvesting devices, e.g., 620-624, are drifting about the embodiment's characteristic orbital course 625 across the surface 626 of a body of water. Each energy harvesting device, e.g., 620, has a phased array, e.g., 627, that transmits 628 data to an antenna on a transceiver 629 suspended by a balloon 630. The device's phased array 627 also receives data transmitted 631 to it by the balloon-suspended transceiver 629.

Balloon-suspended transceiver 629 also exchanges 632 data with device 621 via its phased array.

Another balloon 633, and its respective suspended transceiver, exchanges 634 data with device 622, via that device's phased array. Devices 623 and 624 exchange 635 and 636, respectively, data with the transceiver suspended by balloon 637.

Ground station 638 is positioned on a land mass 639 within the nominal orbital course 625 traveled, at least to an approximate degree, by the embodiment's energy-harvesting devices. Among other messages, signals, navigational directions and information, and other data, ground station 638 transmits, via its ground-based phased array antenna 640, to the energy harvesting devices computational tasks and related data to be executed within their respective computers. Among other messages, signals, navigational updates, observations of obstructions (if any), environmental data, and other data, ground station 638 receives via its ground-based phased array antenna 640, from the energy harvesting devices computational results.

Each energy-harvesting and computational device within this illustrative embodiment receives data from ground station 638, and transmits data to ground station 638, via balloon-transceiver-mediated exchanges of data. For example, ground station 638 transmits 641, via its phased array antenna 640, to the transceiver suspended from balloon 637 a computational task and related data to be performed by energy-harvesting and computational device 620. The transceiver suspended by balloon 637 transmits 642 to the transceiver suspended by balloon 633 the same computational task and related data. The transceiver suspended by balloon 633 transmits 643 to the transceiver 629 suspended by balloon 630 the same computational task and related data. And, finally, the transceiver 629 suspended by balloon 630 transmits 644 to the energy-harvesting and computational device 620. After executing and/or completing the assigned computational task, energy-harvesting and computational device 620 transmits 628/644 the computational results to transceiver 629 suspended by balloon 630, which transmits 643 those computational results to the transceiver suspended by balloon 633, which transmits 642 those computational results to the transceiver suspended by balloon 637, which transmits 641 those computational results to the ground station.

The balloon-transceivers tend to circulate, at least to an approximate degree, about the embodiment's orbital course either in the same direction as that followed by the energy harvesting devices, or in the opposite direction. The course and/or pathway followed and/or traveled by the balloons is controlled, at least to a degree, by changes in balloon altitude specified by the ground station and/or determined autonomously by the balloon-specific control systems (e.g., embedded within the same compartment and/or circuit as the balloon-specific transceivers), e.g., in response to weather and/or wind data obtained from remote services and/or from LIDAR, radar, and/or other sensor data gathered by the energy harvesting devices.

Furthermore, in a manner similar to that described in the introduction, the SPEHDs e.g., 620-624 of this embodiment are also functioning as a distributed radio telescope. At regular intervals and/or upon commands received via satellite and/or balloon communication, each of the the SPEHDs e.g., 620-624 simultaneously records radio signals received via its individual phased array antenna from outer space and stores a record of this information in computer files along with at least one time stamp of the time of that record and at least one location datom reflecting that SPEHD's individual geospatial position (and, optionally its individual orientation). Subsequently, each SPEHD transmits this digitally recorded signal to a shore location using the wireless transfer bus (e.g. via satellite) and the signals are computationally processed so as to generate a composite radio telescope image of a region of outer space. Accordingly, the individual phased arrays of the individual SPEHDs are made to form, according to this disclosure, a composite phased array radio telescope occupying potentially a very large region of the earth's surface and being able to resolve celestial bodies such as black holes with much greater fidelity than distributed radio telescopes of the prior art.

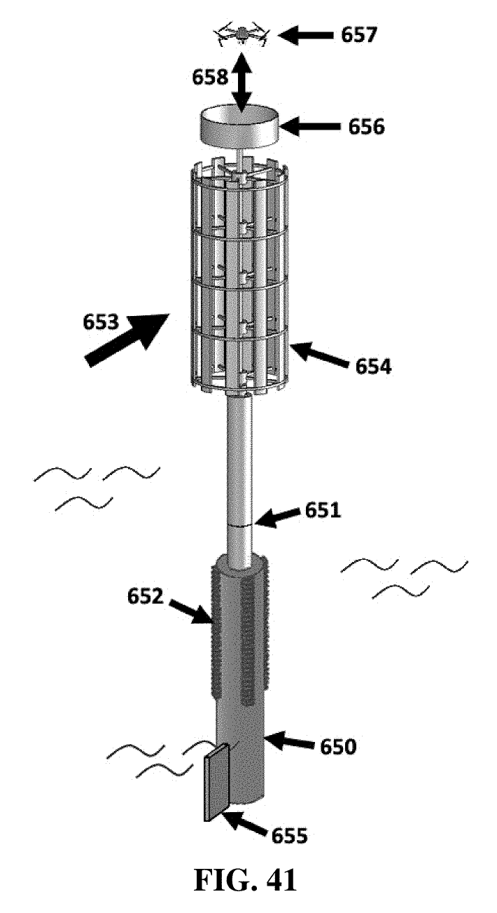

FIG. 41 shows a perspective view of a type of self-propelled wind energy harvesting device (an “SPEHD”) which an embodiment of the current disclosure might include.

The wind SPEHD illustrated in FIG. 41 is similar to the one illustrated and discussed in relation to FIGS. 11-15 except that the wind turbine is a vertical axis wind turbine instead of the horizontal axis wind turbine incorporated within the device illustrated in FIGS. 11-15.

Wind energy harvesting device 650 is a spar buoy that floats adjacent to the surface 651 of the body of water on which the device floats. Computers positioned within the hollow submerged portion of the spar buoy 650 are cooled via conduction of the heat through the submerged walls of the spar buoy and heat conducting fins, e.g., 652.

Propulsion is provided by a drag force imparted to the device as thrust when wind 653 encounters, and is obstructed by, wind turbine 654. A rudder 655 helps to steer the device through the water in response to the drag thrust imparted to it.

A “bird's nest” 656 mounted atop the shaft about which the wind turbine 654 rotates, provides a sheltered location into which unmanned aerial drones, e.g., 657, may land, and from which they may take off again. While resting in, and interfacing with, the bird's nest 656, the drone, e.g., 657, has wireless access to energy, and is able to exchange data with the computers within the device 650. Through device 650, a drone like 657 may offload data retrieved from other energy harvesting devices within the embodiment, and may retrieve new data to distribute to one or more energy harvesting devices after it resumes its journey about and/or over the orbital path of the embodiment. A similar device, provides a physical interface to, and into, which a drone may connect in order to obtain energy (e.g., compressed hydrogen) and in order to connect to, and/or join, the data network within the device.

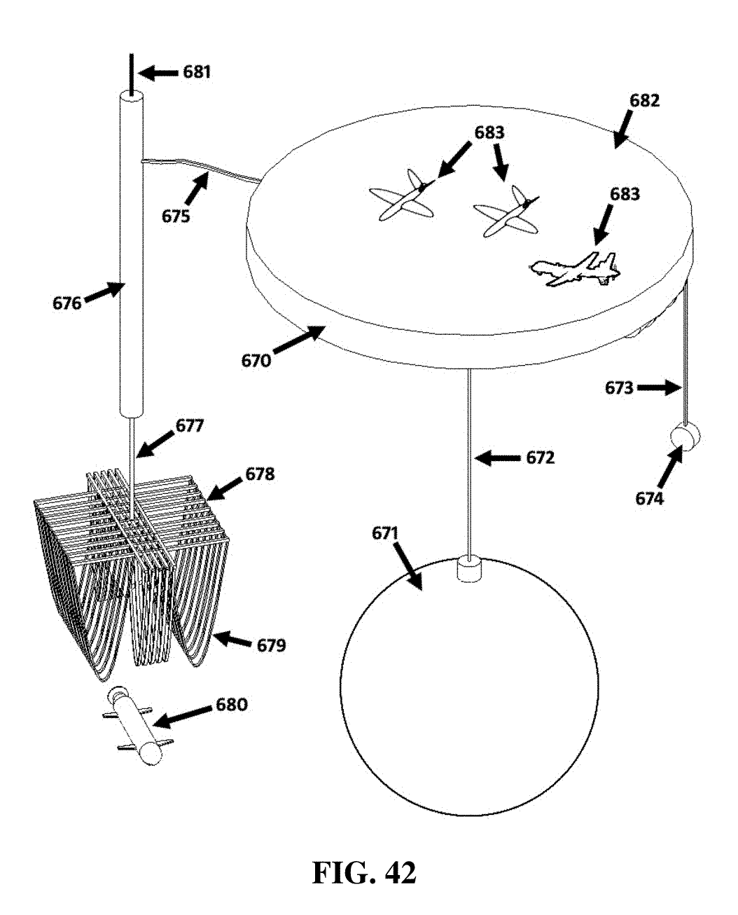

FIG. 42 shows a perspective view of a type of self-propelled wind energy harvesting device which an embodiment of the current disclosure might include.

Buoy and/or flotation module 670 floats adjacent to the surface of a body of water over which waves pass. Suspended from buoy 670 is an inertial mass 671. Inertial mass 671 is suspended from, and/or connected to, buoy 670 by cable 672. The other end of that cable 673 descends to a restoring weight 674 to which it is connected.

A portion of the energy generated by the embodiment in response to wave motion, as well as any data gathered by the embodiment through inputs from sensors mounted on, and/or connected to, the embodiment, and/or from data fed to it from satellites, aircraft, aerial drones, underwater vessels, underwater drones, and/or other sources of data and information, may be transmitted through umbilical cable 675 into, and/or through, spar buoy 676, and thereafter through umbilical cable 677 into an interface positioned and/or incorporated within a “docking port” structure 678/679 from which are suspended cables (e.g., chains), e.g., 679, that define a volume into which an underwater vessel 680 may rise and communicate with the energy and/or data interface therein, thereby receiving some or all of such energy and/or data therein, and transmitting to the computers within the device data therethrough. When coupled with the interface within docking port 678/679 the underwater vessel 680 may also transmit to the buoy data and/or other resources which may then be consumed (e.g., by computers) on board the embodiment and/or transmitted, e.g., via antenna 681, to satellites, aircraft, aerial drones, underwater vessels, underwater drones, and/or other consumers of data, information, and/or other resources.

A similar embodiment supports the exchange of energy and/or data with manned submarines, e.g., via submerged long-wavelength antenna and radio transceiver(s). Another similar embodiment supports the exchange of energy and/or data with unmanned and/or automated underwater vessels.

A similar embodiment supports the transmission of energy to underwater vessels, which includes, but is not limited to, hydrogen (e.g., for use in fuel cells).

Device 670 provides a broad upper surface on to which unmanned aerial drones, e.g., fixed wing as well as helicopters and airships, may land and receive energy, and exchange data.

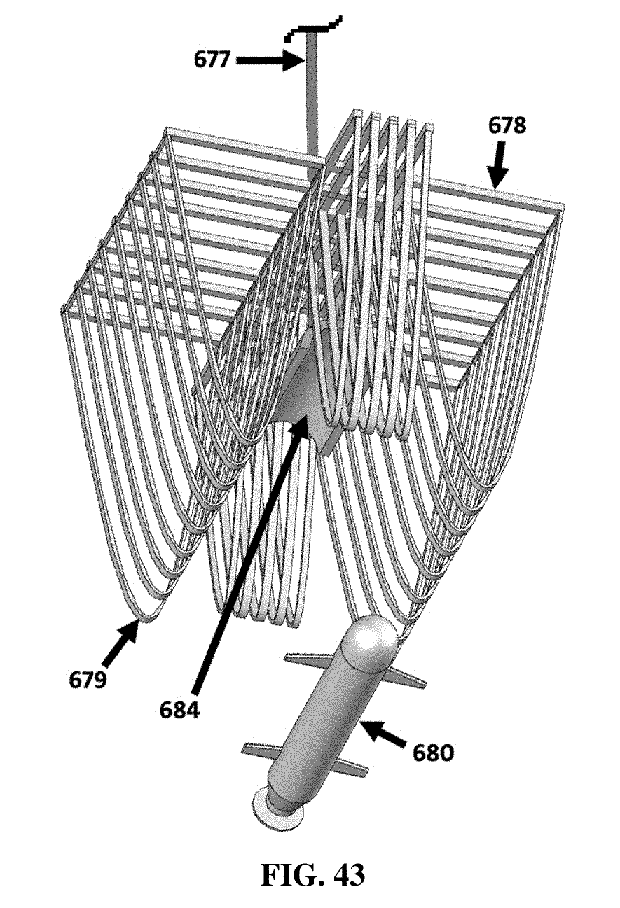

FIG. 43 shows a close-up bottom-up perspective view of the “docking port” structure 678 of the same device that is illustrated and discussed in relation to FIG. 42. Note underwater-vessel interface 680 positioned within the “docking port” created by structure 678 and the cables 679 suspended therefrom. After rising within that docking port, an underwater vessel 680 is able to receive energy and/or exchange data with the embodiment via a wireless energy and data conducting interface 684. A similar device has a docking port and conducting interface 684 that provides a physical interface into which a submerged vessel connects and through which it receives energy, e.g., compressed hydrogen, and exchanges data.

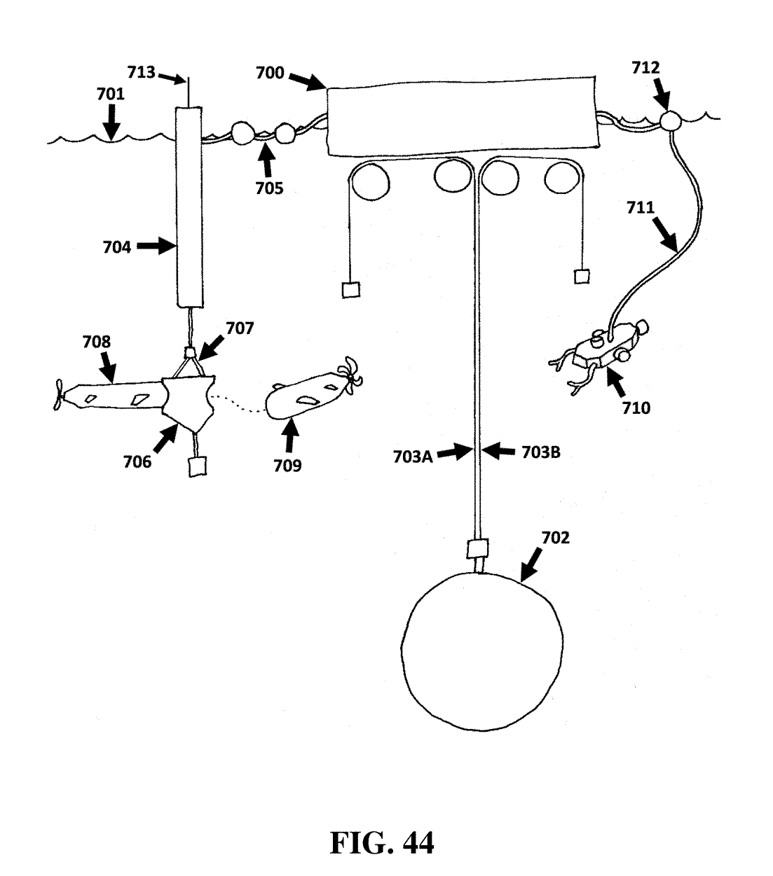

FIG. 44 shows a side view of a type of self-propelled wave energy harvesting device which an embodiment of the current disclosure might include. The device illustrated in FIG. 44 generates electrical power in response to passing waves by a mechanism similar to the mechanism employed by the device illustrated in FIGS. 28-31

A buoy 700 floats adjacent to a surface 701 of a body of water over which waves pass.

Buoy 700 is connected to a submerged inertial mass 702 by a set of cables, e.g., 703A and 703B. Connected to the buoy 700 is a separate spar buoy 704, that is connected to buoy 700 by an umbilical cable 705 (i.e., a cable which may include a plurality of tubes, wires, and mooring cables). Spar buoy 704 is connected to a docking port 706 by umbilical and mooring cables, e.g., 707. Underwater vehicles (manned or unmanned), e.g., 708 and 709, may connect to, or interface with, docking port 706 and therethrough receive energy and data from buoy 700 and share data with the computers within buoy 700.

Also connected to buoy 700 is an unmanned underwater drone 710, which is connected to buoy 700 by an umbilical cable 711, whose weight is partially supported by float 712. Drone 710 may perform useful tasks, such as cleaning, inspecting, maintaining, and/or repairing, the embodiment's inertial mass 702, its cables, e.g., 703, its directional rectifying pulleys, its roller pulleys, its buoy 700, etc. It may also perform useful tasks on other devices, such as underwater vehicles, e.g., 708 and 709, including, but not limited to: cleaning, inspecting, maintaining, and/or repairing, those other devices.

Data that the device receives from underwater drones upon their docking may be transmitted to a remote source, e.g., to a satellite and thereafter to a ship or shore-based station, via antenna 713. Data, including, but not limited to, navigational courses, weather forecasts, data packets to courier to other devices, to ships, to submarines, etc., may be downloaded from a remote source via antenna 713 and transmitted to underwater drones upon their docking.

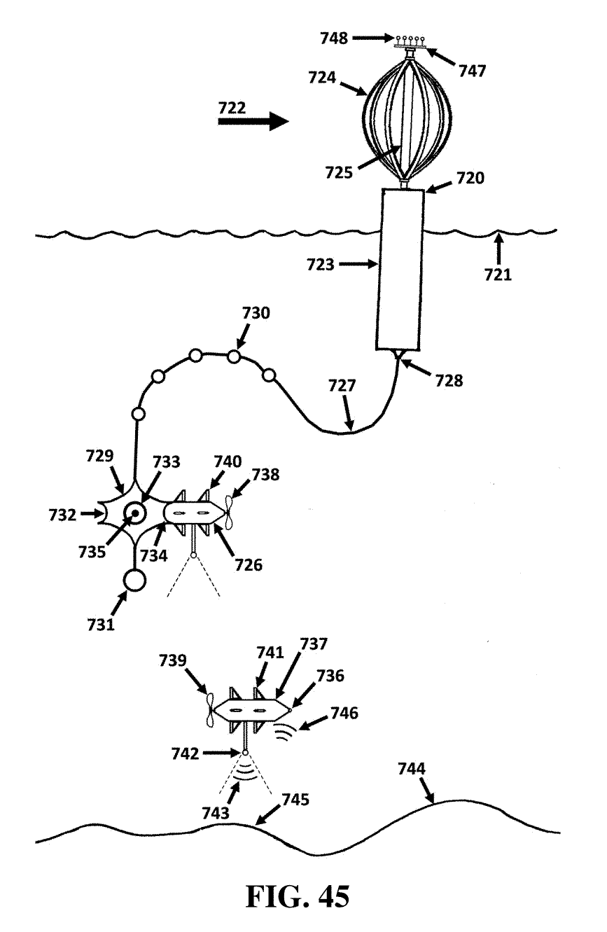

FIG. 45 shows a side view of a type of self-propelled wind energy harvesting device which an embodiment of the current disclosure might include.

The device 720 floats adjacent to an upper surface 721 of a body of water over which pass waves and winds 722. The embodiment includes a buoyant, and/or buoy, portion 723 and a wind turbine 724 rotatably connected to an upper portion of the buoy 723. Wind turbine 724 rotates about a wind turbine shaft 725 in response to the passage therethrough of wind 722, and its rotations energize a rotatably-connected generator (not shown) thereby generating electrical power. A portion of the generated electrical power is used to energize electronic devices (not shown) including, but not limited to: computers, routers, radio transceivers, an embodiment-specific control system, etc. A portion of the generated electrical power is used to energize autonomous underwater vehicles (AUV), e.g., 726.

A tether 727, cable, conduit, and/or circuit, connects the buoy 723 at 728 to a submerged, and approximately neutrally buoyant AUV hub 729, and is supported, at least in part, by a plurality of floats, e.g., 730. Tether 727 transmits electrical power to the AUV hub 729 which is shared with AUVs when those AUVs, e.g., 726, couple and/or dock with the AUV hub. Tether 727 also transmits data between the embodiment's computing devices and/or control system (not shown) and docked AUVs.

AUV hub 729 is connected to a weight 731 that promotes the stability of its orientation. AUV hub 729 contains a number, e.g., 4, docking ports, e.g., 732-734, each of which contains acoustic, visual, and magnetic signals and/or guides, e.g., a speaker and microphone 735 that emits a click of a specific frequency in response to a click of generated by the speaker 736 of an AUV, e.g., 737. The clicks exchanged between the AUV hub 729 and the various AUVs that it supports, e.g., 726, are simulations of clicks generated by whales and/or other marine cetaceans.

Each AUV working with, and/or complementary to, the illustrated device 720 is propelled by a propeller, e.g., 738 and 739 on AUVs 726 and 737, respectively. The orientation and direction of each AUV working with, and/or complementary to, the illustrated device 720 is controlled by a plurality of fins, e.g., 740 and 741 on AUVs 726 and 737, respectively. Each AUV working with, and/or complementary to, the illustrated device 720 contains a camera, light, and acoustic generator (speaker), e.g., 742 on AUV 737. Each AUV's acoustic generator is able to generate a simulated whale click (or other sound), e.g., 743, that can be directed to reflect 746 off the seafloor 744, e.g., at 745, or another surface, and thereafter be received, heard, and/or detected, by the respective AUV's microphone 736 (736 is a microphone and speaker). By determining the time required for the generated acoustic signal 743 to be reflected 746 and subsequently detected by microphone 736, the AUV can determine the approximate distance between the AUV's speaker 736 and the portion of the seafloor, e.g., 745, that gave rise to the reflection 746. When combined with measurement of the depth-related water pressure of the AUV, the depth of the seafloor, e.g., at 745, may be determined, at least to an approximate degree, thereby permitting a mapping of the terrain, depth elevations, etc. of those portions of the seafloor so surveyed.

Analysis of the reflected AUV acoustic signal may also signify information about the composition and/or density of the material at the reflecting surface(s). The AUV's camera and light 742 can potentially produce images of the seafloor, and/or other objects of interest, e.g., of the same portion of the seafloor 745 depth-ranged by the AUV's acoustic generator and microphone.

Atop the wind turbine shaft 725 is a platform 747 on which is attached a phased array antenna 748 that may be used to exchange encoded radio signals with other devices, objects, and/or antennas, including, but not limited to: satellites, planes, ships, balloon-suspended transceivers, and/or terrestrial transceivers, computers, and/or networks.

The scope of the present disclosure includes embodiments incorporating devices similar to the one illustrated in FIG. 45 that extract energy from wind, waves, solar radiation, thermal differences, salinity differences, pressure differences, and/or any other source of energy accessible and/or available to a floating, drifting, and/or self-propelled embodiment. The scope of the present disclosure includes embodiments incorporating devices similar to the one illustrated in FIG. 45 that utilize any type of energy production mechanism, machine, device, technology, design, and/or apparatus. The scope of the present disclosure includes embodiments incorporating devices similar to the one illustrated in FIG. 45 that provide energy to, and/or exchange data with, any type of fully or partially submerged autonomous, semi-autonomous, and/or remote-controlled, vessel, vehicle, device, mechanism, and/or craft, including, but not limited to: autonomous underwater vehicles (AUVs), remotely-operated vehicles (ROVs), and/or autonomous surface vessels (e.g., that tend to float adjacent to the surface 721 of a body of water. The scope of the present disclosure includes embodiments incorporating devices similar to the one illustrated in FIG. 45 that provide energy to, and/or exchange data with, subordinate vessels (e.g., AUVs) that are self-propelled and untethered to the rest (e.g., to the buoy 723) of the device, as well as those that are continuously tethered to the device (e.g., to the buoy 723).

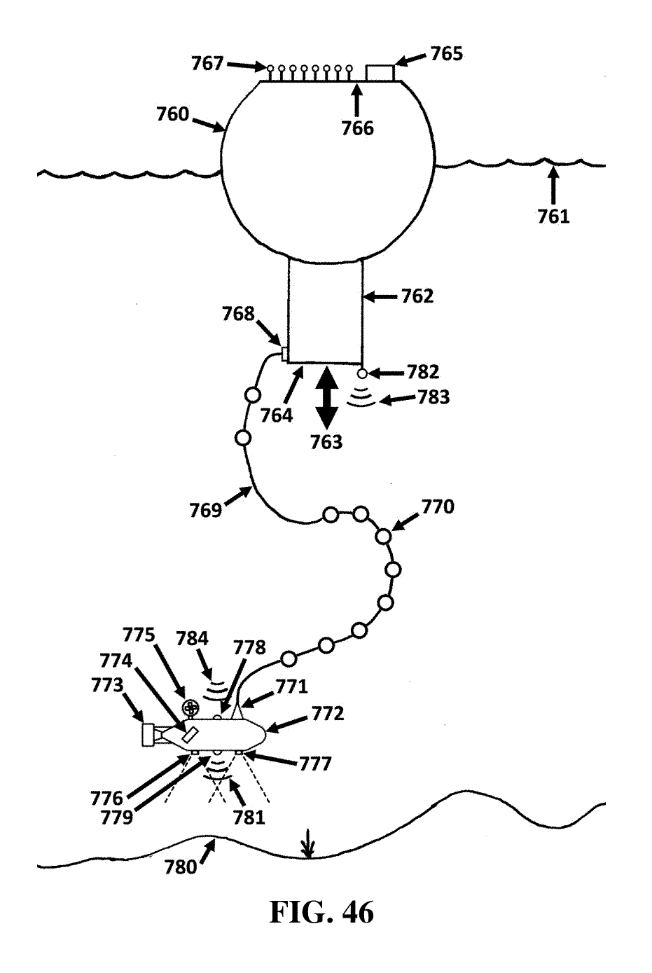

FIG. 46 shows a side view of a type of self-propelled wave energy harvesting device which an embodiment of the current disclosure might include.

The device 760 floats adjacent to the surface 761 of a body of water over which waves pass. The device includes a buoyant, and/or buoy, portion 760, and a hollow cylindrical portion 762. In response to wave-induced vertical oscillations of the device, water tends to move 763 in and out of the tube through the tube's lower mouth 764. A power take off (PTO) inside the buoy 760 and/or tube 762 converts at least a portion of the oscillating water within the tube into mechanical and/or electrical power. The device illustrated in FIG. 46 uses a piston within the tube to drive a hydraulic PTO. A device similar to the one illustrated in FIG. 46 uses a magnetohydrodynamic PTO to generate electrical power directly from seawater moving up and down within the tube 762. Other devices similar to the one illustrated in FIG. 46 use different mechanisms, methods, and PTOs in order to extract electrical power from the water moving up and down within the tube 762, and all embodiments incorporating such devices are included within the scope of the present disclosure.

At least a portion of the electrical power generated by the device, and/or extracted by the device from the device's ambient environment, is used to energize electronic circuits positioned, stored, and/or protected within, a computer enclosure 765 attached to an upper surface 766 of the device's buoy 760. The electronic circuits within the computer enclosure 765 include, but are not limited to: computers, routers, memory modules, encryption and decryption circuits, a device-specific control system, radio transmission and receiving circuits, and navigation circuits. Also affixed to an upper surface 766 of the device's buoy 760 is a phased array antenna 767 that facilitates the exchange of encoded radio transmissions between the device and antennas connected to, and/or controlled by, other objects, including, but not limited to: satellites, ships, planes, balloon-suspended transceivers, and/or terrestrial computers and networks.

Attached to a lower portion of the device, e.g., to a lower portion of the device's tube 762, at 768, is a tether 769, cable, conduit, tube, and/or multi-stranded wire, that is, at least in part, supported and/or suspended within the body of water 761 by a plurality of floats, e.g., 770, that offset the positive wet and/or specific weight of the tether and tend to impart to the tether an approximately neutral buoyancy.

Directly connected to a lower end of the tether 769, at connector 771, is a remotely-operated vehicle (ROV) 772. The device's ROV 772 is propelled by four propeller-thrusters, three 773-775 are visible in the illustration of FIG. 46. All but the backmost thruster 773 are able to rotate about the rod that rotatably connects them to the body 772 of the ROV, thereby allowing the ROV to turn and maneuver. Note that the orientations of thrusters 774 and 775 are different with respect to a longitudinal axis of the ROV.

The device's ROV 772 has two cameras 776 and 777 with overlapping fields of view allowing stereoscopic analysis of the images taken which may then permit, at least partial, 3D models to be constructed of the objects and/or surfaces so imaged. The device's ROV 772 also has an upper 778 and a lower 779 acoustic sensors, each capable of generating, and receiving and/or detecting, sounds (e.g., simulated whale clicks). These acoustic sensors provide the ROV 772 with the ability to detect distances to other objects and/or surfaces.

The device's ROV, among other uses, may provide sufficient information and/or data to permit the device to map the depths of the seafloor 780, and/or its surface contours. The lower acoustic sensor 779 on the device's ROV 772 can generate a sound 781 and thereafter detect its reflected echo, thereby allowing the ROV 772 to gauge the distance between that sensor and the seafloor 780 beneath the ROV, allowing that distance to be calculated, at least to an approximate degree. The ROV also incorporates a pressure and/or depth sensor that allows it to determine its depth, at least to an approximate degree. By combining these two distances, i.e., the distance between the ROV's lower acoustic sensor 779 and the seafloor 780, and the depth of the ROV, and the distance between the surface 761 of the body of water on which the device floats and the seafloor 780 can be calculated, at least to an approximate degree, thereby permitting, as the device moves across the surface 761 of the body of water and the seafloor below, the mapping of the elevations and/or depths of the seafloor.

A tube-mounted acoustic sensor 782, attached to the device's tube 762, is capable of generating sounds 783 that can reach 784 the ROV 772 and be detected by its upper acoustic sensor, e.g., 778. Since the device's control system (not shown) knows the time at which the sound was emitted, as well as the time at which it was received by the ROV, the device can calculate, at least to an approximate degree, an “acoustic distance” between the device's tube-mounted acoustic sensor 782 and the ROV's 778 upper acoustic sensor.

The device possesses stereoscopic cameras, and other sensors, mounted to an upper portion of the buoy 760 that allow it to calculate the height of its own waterline, and/or the draft or depth of its tube 762. Subtracting this tube depth from the ROV depth determined by the ROV's pressure and/or depth sensor (not shown) permits the device to determine the “tube-relative depth” of the ROV relative to the bottom of its tube 762 and/or the tube-mounted acoustic sensor 782 mounted thereto.

If the value of the tube-relative depth equals the acoustic distance, then the ROV must be, at least to an approximate degree, directly beneath the tube 762. However, if the value of the tube-relative depth is greater than the acoustic distance, then the ROV's position must be within a horizontal plane (i.e., within a plane parallel to the resting surface 761 of the body of water on which the device floats, wherein the plane is at a depth equal to the tube-relative depth), and on a circle centered about a projection of a vertical axis passing through the tube-mounted acoustic sensor 782. Thus, the position of the ROV must be, at least to an approximate degree, on such a circular path. In other words, the acoustic depth of the ROV 772 is the distance of a hypotenuse of a right triangle the vertical side of which has a length of the tube-relative depth. This enables the device's control system (not shown) to make adjustments to the ROV's position (e.g., through commands to the ROV 772 causing the ROV to execute specific thrust vectors relative to its own longitudinal axis and/or geometry) and thereafter note the corresponding changes in the diameter of the circular path on which the ROV must be positioned. Through trial and error, and/or in combination with data from accelerometers on the buoy 760 and on the ROV 772, GPS receiver(s) on the buoy 760 and/or within its computer enclosure 765, differential times at which ambient underwater noises are detected by the tube-mounted acoustic sensor 782 and one or both of the ROV's acoustic sensors 778 and 779, and/or other position-sensing instruments, mechanisms, devices, and/or sensors, the device's control system can steer its ROV with thrusts of magnitudes and orientations that cause the ROV to follow the movement of the device's buoy 760 across the surface 761 of the body of water on which the device floats (regardless of whether that movement is passive, i.e., drifting, or directed, e.g., via self-propulsion) and/or to stay beneath the device's tube 762, at least to an approximate degree.

While the device illustrated in FIG. 46 includes a single tether-connected ROV 772, the scope of the present disclosure includes embodiments that incorporate devices with any number of such tethered ROVs, and/or with any number of untethered ROVs. While the device's ROV illustrated in FIG. 46 includes and utilizes cameras and acoustic sensors, the scope of the present disclosure includes embodiments that incorporate devices with ROVs incorporating any kind, type, and/or number of sensors.

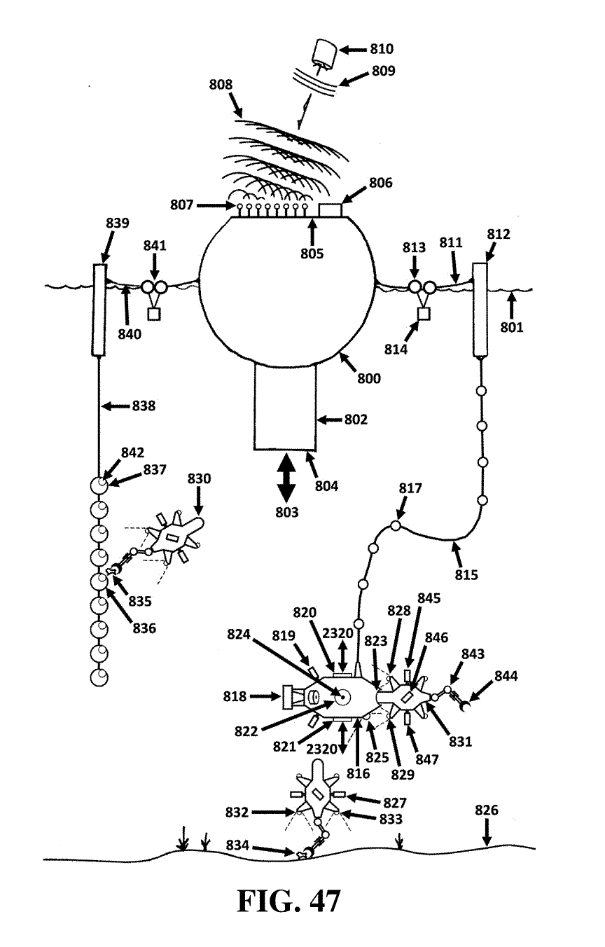

FIG. 47 shows a side view of a type of self-propelled wave energy harvesting device of which an embodiment of the current disclosure might be, at least in part, comprised.

The embodiment 800 floats adjacent to an upper surface 801 of a body of water over which waves pass. The embodiment contains a buoyant, and/or buoy, portion 800 and a depending tubular portion 802. As waves cause the device 800 to move up and down, water within the tube 802 moves up and down as well, causing water to move 803 in and out of the tube 802 through the tube's lower mouth 804. A power take off (PTO) within the device's buoy and/or tube converts a portion of the energy inherent in the movements of water within the device's tube 802 into electrical power. The device illustrated in FIG. 47 uses a piston within the tube to drive a hydraulic PTO. An device similar to the one illustrated in FIG. 47 uses a magnetohydrodynamic PTO to generate electrical power directly from seawater moving up and down within the tube 802. Other devices similar to the one illustrated in FIG. 47 use different mechanisms, methods, and PTOs in order to extract electrical power from the water moving up and down within the tube 802, and embodiments incorporating any and all such devices are included within the scope of the present disclosure.

Attached to an upper surface 805 of the device 800 is a computing enclosure 806 that contains electronic circuits, including, but not limited to: computers, routers, an device-specific control system, navigational devices and circuits, memory circuits, and radio transmission and reception circuits. Also attached to an upper surface 805 of the device 800 is a phased array antenna 807 that allows the device and/or the radio transceiver(s) therein, to transmit 808 and receive 809 encoded electromagnetic (e.g., radio) signals. The device 800 is able to exchange encoded radio signals with other devices, including, but not limited to: other devices, satellites, e.g., 810, balloon-suspended transceivers, ships, planes, and terrestrial radio stations, antennas, computers, networks, and/or transceivers.

Connected by cable, chain, linkages, rope, and/or another flexible connector 811, is a spar buoy 812. Discordant motions between the buoy 800 and the spar buoy 812 are smoothed, buffered, and/or absorbed, by an elastic mooring device 813, comprised of a pair of floats, e.g., 813, beneath which is suspended between the floats a weight 814. Separations of buoy 800 and the spar buoy 812 cause the floats, e.g., 813 to separate, which, in turn, causes the suspended weight 814 to be raised, thereby storing potential energy. The stored potential energy pulls back together the buoy 800 and the spar buoy 812 when the, presumably wave-driven, forces separating the buoys is sufficiently diminished.

Cable 811 transmits power and data between computers in computing enclosure 806 and spar buoy 812, and cable 815 in turn transmits at least a portion of that power and data between spar buoy 812 and an autonomous-underwater-vehicle (AUV) hub 816. Thus, power and data are exchanged between buoy 800 and/or the electronic circuits within computing enclosure 806 and the AUV hub 816. A plurality of floats, e.g., 817, help to support the weight of the cable and allow it to achieve approximate neutral buoyancy.

The AUV hub 816 has a number of thrusters, including a fixed horizontal-thrust thruster 818, four circumferential thrusters, e.g., 819, that are arrayed about the long horizontal axis of the AUV hub 816, and are able to be rotated about the rods that rotatably-connect them to the hub. The AUV hub 816 also includes a single thruster that ejects water vertically through one of an upper 820 or lower 821 mouth (while pulling water through the opposing mouth).

The AUV hub 816 has three docking ports, e.g., 822 and 823, positioned circumferentially about a horizontal plane passing through the center of the AUV hub. At the center back wall of each docking port is a light and acoustic sensor, e.g., 824, that provides guidance information and/or signals to the AUVs that dock therein.

The AUV hub includes a camera and light 825 that can provide images of the seafloor 826 and/or AUVs, e.g., 827.

Each AUV, e.g., 827, of the device 800, has four cameras, and associated lights. Two cameras and lights, e.g., 828 and 829, are mounted on back-facing struts, and tend to provide useful information to an AUV when it attempts to insert its back end, e.g., 830, into a docking port, e.g., 823, on the AUV hub 816. The back-facing cameras of an AUV provide it with stereoscopic images, which, in combination with the homing signals emitted by the light and acoustic sensor, e.g., 824, at the back inside of each docking port, can facilitate the insertion of an AUV, e.g., 831 into a docking port, e.g., 823.

Two cameras and lights, e.g., 832 and 833, are mounted on front-facing struts, and tend to provide useful information to an AUV when it attempts to survey, inspect, and/or gather information about the seafloor 826, objects thereon, e.g., 834, and/or other objects, creatures, and/or surfaces. The AUV 827 is attempting to pick up a geological sample 834 from the seafloor 826. After obtaining a sample, e.g., 834, from the environment, an AUV 830 and/or the device's central control system (e.g., positioned within the device's computing enclosure 806), may elect to store that sample 835 for later examination by a human, and/or within a ship- or shore-based laboratory, by placing it within a receptacle, e.g., 836, and logging the time and geospatial location at which the sample was obtained, along with any photos taken by the AUV's cameras, e.g., 832 and 833, of the sample prior to and/or after its retrieval, and the identifier of the receptacle in which the sample was stored.

A set of sample receptacles, e.g., 837, are suspended by a cable 838 that depends from a spar buoy 839 that is flexibly connected to the buoy 800 by a cable 840, wherein said cable includes an elastic mooring device 841 to more flexibly connect the buoy 800 and spar buoy 839 when the positions of both are buffeted by passing waves. Each sample receptacle, e.g., 837, contains an aperture, e.g., 842, through which an AUV may place a sample therein.

Each AUV, e.g., 831, contains an articulating arm, e.g., 843, rigid segments of which rotate about rotating joints so as to allow the orientation and position of a grasping claw and/or gripper, e.g., 844, to be adjusted through a range of such orientations and positions. Each AUV, e.g., 831, also contains four thrusters, e.g., 845-847, the thrusts of which may be adjusted through the rotation of each thruster about the longitudinal axis of the respective rod that connects each to the main body of the AUV.

After docking with a docking port, e.g., 823, on the AUV hub 816, an AUV may obtain electrical power from the buoy 800, the electronic circuits (which may include energy storage devices) inside the device's computing enclosure 806, and/or from the device's generators (not shown) and/or energy storage devices (not shown), thereby enabling it to recharge its own energy storage devices and/or mechanisms (not shown).

We claim:

1. A floating, renewable energy powered computing grid, comprising:
a plurality of wave motion-to-electrical energy converters translating together along a surface of water;
a propulsion system for translating the wave motion-to-electrical energy converters, the propulsion system at least partially driven by renewable energy;
a navigation control system controlling the propulsion system;
a plurality of computational units disposed on the wave motion-to-electrical energy converters and powered by generated electrical energy;
a wireless data transfer bus adapted to relay computational tasks to, and computational results from, respective computational units; and
an antenna configured to transmit data from the computational units to the wireless data transfer bus.

2. The floating, renewable energy powered computing grid of claim 1, further comprising a computational task scheduler configured to manage computational tasks among the computational units.

3. The floating, renewable energy powered computing grid of claim 1, further comprising a computational task dispatcher configured to send encoded computational tasks via the wireless data transfer bus to selected computational units.

4. The floating, renewable energy powered computing grid of claim 1, further comprising a plurality of location data collection sensors each disposed on one of the wave motion-to-electrical energy converters for recording a location thereof.

5. The floating, renewable energy powered computing grid of claim 1, further comprising a navigation coordination facility configured to receive location data via the wireless data transfer bus.

6. The floating, renewable energy powered computing grid of claim 5, wherein the navigation coordination facility encodes navigation control signals to the navigation control system via the wireless data transfer bus.

7. The floating, renewable energy powered computing grid of claim 6, wherein the navigation coordination facility directs the wave motion-to-electrical energy converters to follow a loop path.

8. The floating, renewable energy powered computing grid of claim 1, wherein the wireless data transfer bus includes a satellite for relaying computational tasks to the computational units.

9. The floating, renewable energy powered computing grid of claim 1, wherein the wireless data transfer bus includes a balloon-mounted radio relaying computational tasks to a computational unit.

10. The floating, renewable energy powered computing grid of claim 1, wherein the antenna includes phased array antenna units arrayed horizontally to transmit electromagnetic signals skywardly.

11. The floating, renewable energy powered computing grid of claim 1, further comprising a plurality of weather data collection sensors each mounted upon a respective wave motion-to-electrical energy converter and configured to record an environmental phenomenon.

12. The floating, renewable energy powered computing grid of claim 11, wherein the environmental phenomenon is selected from a group comprising wind speed and wave height.

13. The floating, renewable energy powered computing grid of claim 11, further comprising a weather prediction server configured to receive weather data from the weather data collection sensors.

14. The floating, renewable energy powered computing grid of claim 2, wherein the computational task scheduler is disposed on a land mass.

15. The floating, renewable energy powered computing grid of claim 1, wherein the wave motion-to-electrical energy converters are arranged in a loop.

16. The floating, renewable energy powered computing grid of claim 1, wherein the navigation control system moves the wave motion-to-electrical energy converters in an orbit around a location.

17. The floating, renewable energy powered computing grid of claim 16, wherein the location is at a body of water.

18. The floating, renewable energy powered computing grid of claim 16, wherein the location includes an island.

19. The floating, renewable energy powered computing grid of claim 16, wherein the location includes a continent.

20. The floating, renewable energy powered computing grid of claim 1, wherein the navigation control system moves the wave motion-to-electrical energy converters conformal to an ocean current.

21. The floating, renewable energy powered computing grid of claim 1, wherein the navigation control system moves the wave motion-to-electrical energy converters conformal to a prevailing wind direction.

22. The floating, renewable energy powered computing grid of claim 1, wherein the navigation control system moves the wave motion-to-electrical energy converters conformal to a prevailing ocean wave propagation direction.

23. The floating, renewable energy powered computing grid of claim 1, wherein the navigation control system moves the wave motion-to-electrical energy converters according to thrust vectoring commands calculated autonomously by the navigation control system.

24. The floating, renewable energy powered computing grid of claim 23, wherein the thrust vectoring commands control a valve to increase a flow of water from the wave motion-to-electrical energy converter.

25. A floating, self-powered, radio telescope, comprising:
a plurality of wave motion-to-electrical energy converters translating together along a surface of water;
a propulsion system for translating the wave motion-to-electrical energy converters, the propulsion system at least partially driven by renewable energy;
a navigation control system controlling the propulsion system;
a plurality of radio antennas disposed on respective wave motion-to-electrical energy converters for recording electromagnetic radiation;
a plurality of radio controllers disposed on respective wave motion-to-electrical energy converters for recording time stamps associated with electromagnetic radiation; and
a wireless data transfer bus adapted for relaying radio data files from the wave motion-to-electrical energy converters to a central signal processor.

26. The floating, self-powered, radio telescope of claim 25, further comprising a plurality of location sensors adapted to record geospatial locations at which electromagnetic radiation is recorded.

27. A method for energy-intensive calculations, comprising:
deploying a plurality of unmoored buoyant energy harvesters onto the surface of a body of water, said energy harvesters including an energy conversion system, a thrust generator, a computer assembly, and an antenna;
controlling the plurality of energy harvesters to move along a designated path;
scheduling tasks for the computer assembly and wirelessly transmit the tasks to the energy harvesters; and
wirelessly transmitting a computational results file from the energy harvester to a remote receiver.

28. The method for energy-intensive calculations of claim 27, further comprising implementing an obstacle avoidance system upon detecting an obstacle in the designated path.

29. The method for energy-intensive calculations of claim 27, further comprising implementing a hazard avoidance system upon receipt of a report of impending hazard.

30. The method for energy-intensive calculations of claim 27, further comprising generating and transmitting a report of energy generation by the energy harvesters.
